(19) United States
(12) Patent Application Publication
(10) Pub. No.: US 2011/0172912 A1
(43) Pub. Date: Jul. 14, 2011

(54) POSITION-FIXING CONTROL APPARATUS AND STORAGE MEDIUM STORING POSITION-FIXING CONTROL PROGRAM

(75) Inventors: Shigeki FUKUTA, Kawasaki (JP); Kazuo SASAKI, Kawasaki (JP); Itaru NAKAGAWA, Kawasaki (JP)

(73) Assignee: FUJITSU LIMITED, Kawasaki-shi (JP)

(21) Appl. No.: 12/987,760

(22) Filed: Jan. 10, 2011

(30) Foreign Application Priority Data
Jan. 14, 2010 (JP) 2010-6273

(51) Int. Cl. G01C 21/10; G01C 21/20

(52) U.S. Cl. 701/207

(57) ABSTRACT

A position-fixing control apparatus includes a position-fixing device fixes a position of the position-fixing control apparatus, an acquisition unit acquires a travel speed and vibration information of the position-fixing control apparatus, a first modifier modifies a measurement period of position fixing of the position-fixing device to a first period when the speed exceeds a specific speed, a second modifier modifies the measurement period of position fixing of the position-fixing device to a second period shorter than the first period when the speed is equal to or below the specific speed, a storage unit stores a vibration pattern, and a third modifier modifies the measurement period of position fixing of the position-fixing device to a third period equal to or longer than the first period when the vibration information acquired subsequent to the modification of the measurement period to the second period matches the vibration pattern.

### CROSS-REFERENCE TO RELATED APPLICATIONS

This application is based upon and claims the benefit of priority of the prior Japanese Patent Application No. 2010-006273, filed on Jan. 14, 2010, the entire contents of which are incorporated herein by reference.

### FIELD

The embodiments discussed herein are related to a position-fixing control apparatus controlling a position-fixing device, and a storage medium storing a position-fixing control program.

### BACKGROUND

As a position-fixing technique, a global positioning system (GPS) or a position-fixing device based on a terrestrial radio wave base station for cellular phones may be used for fixing the position of a target object. Techniques for reducing power consumption in the position-fixing device during travel have been proposed. For example, reference may be made to Japanese Laid-Open Patent Application No. 2000-249565, Japanese Laid-Open Patent Application No. 10-24026, Japanese Laid-Open Patent Application No. 2006-242578, Japanese Laid-Open Patent Application No. 09-290966, and Hiroshi KANASUGI, Yusuke KONISHI, and Ryousuke SHIBAGAKI “Measurement of human activities with wearable sensor and identification of activity mode,” GEOINFORMATION FORUM JAPAN 2004 STUDENT PUBLICATIONS, Vol. 6, pp. 207-210, 2004.

According to these techniques, position information of a destination is used, and a GPS sensor or the like is merely switched on and off in response to a current detected vibration pattern of the GPS sensor. Power saving responsive to a travel status from the past to the present is not carried out.

### SUMMARY

According to an aspect of an embodiment, a position-fixing control apparatus includes a position-fixing device that fixes a position of the position-fixing control apparatus, an acquisition unit that acquires a travel speed and vibration information of the position-fixing control apparatus, a first modifier that modifies a measurement period of position fixing of the position-fixing device to a first period when the speed exceeds a specific speed, a second modifier that modifies the measurement period of position fixing of the position-fixing device to a second period shorter than the first period when the speed is equal to or below the specific speed, a storage unit that stores a vibration pattern, and a third modifier that modifies the measurement period of position fixing of the position-fixing device to a third period equal to or longer than the first period when the vibration information acquired subsequent to the modification of the measurement period to the second period matches the vibration pattern.

The object and advantages of the invention will be realized and attained by at least the elements, features, and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a first example of a control system;

FIG. 2 illustrates a first hardware example of a control apparatus;

FIG. 3 illustrates a functional configuration example of the control apparatus;

FIG. 4 illustrates a first example of the record layout of a state table;

FIG. 5 illustrates a first example of the record layout of a period table;

FIG. 6 illustrates a first example of the record layout of a pattern file;

FIGS. 7A-7D are a flowchart illustrating a first example of a shift process;

FIG. 8 illustrates a hardware example of a server computer;

FIG. 9 illustrates an example of the record layout of a data file;

FIG. 10 illustrates a hardware example of a cellular phone;

FIG. 11 illustrates an example of a display image of a display of the cellular phone;

FIGS. 12A and 12B are a flowchart illustrating an example of a collection and display process of measurement results;

FIG. 13 illustrates a second example of the record layout of a state table;

FIG. 14 illustrates a second example of the table layout of a period table;

FIG. 15 illustrates a second example of the record layout of a pattern file;

FIGS. 16A-16G are a flowchart illustrating an example of a control process;

FIG. 17 illustrates an example of the record layout of a history file;

FIG. 18 illustrates a third example of the record layout of a pattern file;

FIG. 19 illustrates a third example of the record layout of a state table;

FIGS. 20A-20D are a flowchart illustrating second example of a shift process;

FIG. 21 illustrates an example of state shifting;

FIG. 22 illustrates a fourth example of the record layout of a state table;

FIGS. 23A-23E are a flowchart illustrating third example of a shift process;

FIG. 24 illustrates a fifth example of the record layout of a state table;

FIGS. 25A-25E are a flowchart illustrating fourth example of a shift process;

FIG. 26 illustrates a sixth example of the record layout of a state table;

FIGS. 27A-27F are a flowchart illustrating fifth example of a shift process;

FIG. 28 illustrates a seventh example of the record layout of a state table;

FIGS. 29A-29C are a flowchart illustrating sixth example of a shift process;

FIG. 30 illustrates a second hardware example of a control apparatus;

FIG. 31 illustrates an example of the record layout of a varying count file;

FIGS. 32A and 32B are a flowchart illustrating seventh example of a shift process; and

FIG. 33 illustrates a fourth hardware example of a control apparatus.

### DESCRIPTION OF EMBODIMENTS

### First Embodiment

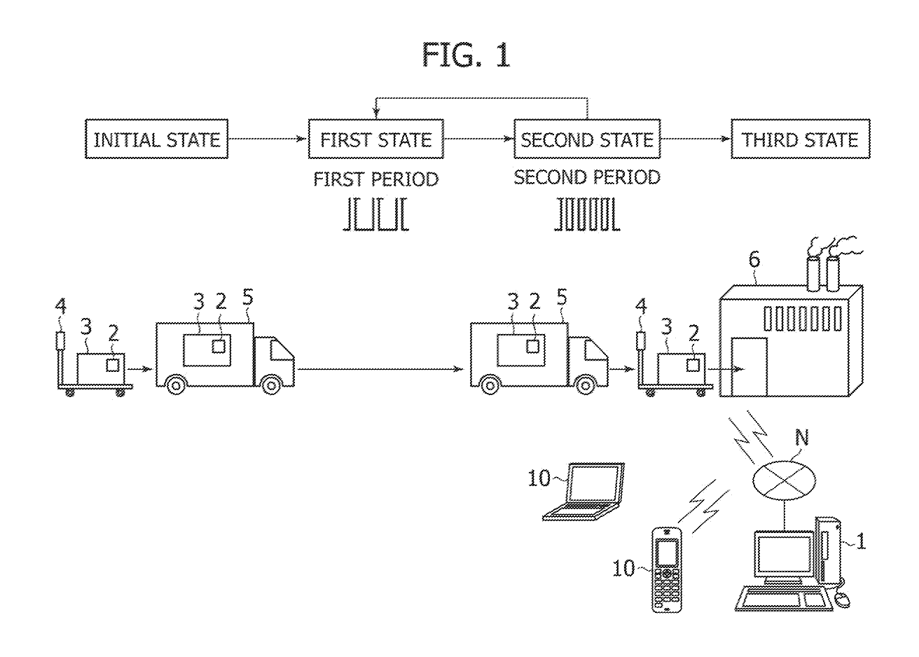

FIG. 1 illustrates first example of a control system. The control system includes central apparatus 1, control apparatus 2, terminal device 10, and target object 3. The target object 3 is a position-fixing target that may be placed in an area of a plant, an office, a store, or the like. For example, the target object 3 may be a machine tool, a server computer, a copying machine, a personal computer, an electronic apparatus, jewelry goods, or the like. According to a first embodiment, the target object 3 is a machine tool movably installed in a plant (hereinafter referred to as a machine tool 3).

Used to fix position is a global positioning system (GPS) based on GPS satellites, or a position-fixing system based on base station for a wireless local-area network (LAN), worldwide interoperability for microwave access (WiMAX), or cellular phones. The control apparatus 2 may be a cellular phone, a personal digital assistant (PDA), a computer or the like. According to the first embodiment, the control apparatus 2 is attached to the machine tool 3. The control apparatus 2 controls the position fixing of a position-fixing device (not illustrated) to be discussed later to fix the position of the machine tool 3. In one embodiment, the control apparatus 2 may be integrated internally in the machine tool 3. The control apparatus 2 transmits the position information provided by the position-fixing device to the central apparatus 1. Since the control apparatus 2 is rigidly attached to the machine tool 3, the machine tool 3 is also meant as the control apparatus 2 in the discussion that follows.

The position-fixing device and the control apparatus 2 are attached to the machine tool 3 to fix the position of the machine tool 3 without causing any difficulty on the machine tool 3 having typically a variety of shapes. To this end, the position-fixing device and the control apparatus 2 are compact and light-weight in one embodiment. A battery supplying power to the position-fixing device and the control apparatus 2 is also desirably compact. If the machine tool 3 is used as a fixed tool, power supplying to the position-fixing device and the control apparatus 2 via a wired line is possible, and eliminates the need for a compact, high-capacity, and costly battery. The position-fixing device and the control apparatus 2 mounted on the machine tool 3 receive GPS signal or radio wave of a public radio network to fix the position of the machine tool 3 with more difficulty with the machine tool 3 fixed indoors than with the machine tool 3 installed outdoors. Position fixing in a manner free from wired power supplying during travel is important in order to fix position of a target installed indoors. In one embodiment, position fixing during travel is performed on a compact, low-cost, small-capacity battery.

When the machine tool 3 is transported, the machine tool 3 is mounted on a dolly 4. The machine tool 3 is transported together with the control apparatus 2 on a transport vehicle 5 such as a truck. The transport vehicle 5 may include a wheeled vehicle such as truck, train, ship, and airplane. According to the first embodiment, the transport vehicle 5 is a truck 5. The machine tool 3 loaded on the truck 5 reaches surroundings of an installation location of the machine tool 3, such as a destination like a plant 6. The machine tool 3 is then loaded onto the dolly 4. The dolly 4 carries the machine tool 3 into the plant 6.

The control apparatus 2 fixes position using the position-fixing device. If the truck 5 exceeds a specific speed, the control apparatus 2 determines that the state of the control apparatus 2 has shifted from an initial state into a first state.

Upon determining that the control apparatus 2 has shifted into the first state, the control apparatus 2 modifies a measurement period of position fixing of the position-fixing device to a first period (once every 30 minutes, for example). Upon determining that the truck 5 runs at a speed equal to or below the specific speed, the control apparatus 2 determines that the control apparatus 2 is in a second state. Upon determining that the state of the control apparatus 2 has shifted into the second state, the control apparatus 2 modifies the measurement period of position fixing of the position-fixing device to a second period (once every minute, for example) shorter than the first period. If the control apparatus 2 determines that the control apparatus 2 rises above the specific speed again with the control apparatus 2 in the second state, the control apparatus 2 determines that the state thereof has shifted into the first state. With the state of the control apparatus 2 shifted into the first state, the control apparatus 2 modifies the measurement period of position fixing of the position-fixing device to the first period.

If the control apparatus 2 determines that acquired vibration information matches a pre-stored vibration pattern in the second state, the control apparatus 2 determines that the state thereof has shifted into a third state. In the third state, the control apparatus 2 stops supplying power to the control apparatus 2 itself or modifies the measurement period of position fixing of the position-fixing device to a third period equal to or longer than the first period. The position information of the control apparatus 2 thus obtained is transmitted to the central apparatus 1 via the Internet, or a communication network N such as a cellular phone network. The central apparatus 1 may be an externally arranged server computer or personal computer. In the discussion that follows, the central apparatus 1 is an externally arranged server computer 1.

The terminal device 10 may be a personal computer, a cellular phone, or a PDA, each accessible to the server computer 1 via the communication network N. In the discussion that follows, the terminal device 10 is a cellular phone 10. A user controlling the machine tool 3 accesses the server computer 1 using the cellular phone 10, and acquires the position information of one of the control apparatus 2 and the machine tool 3. This process is described in detail below.

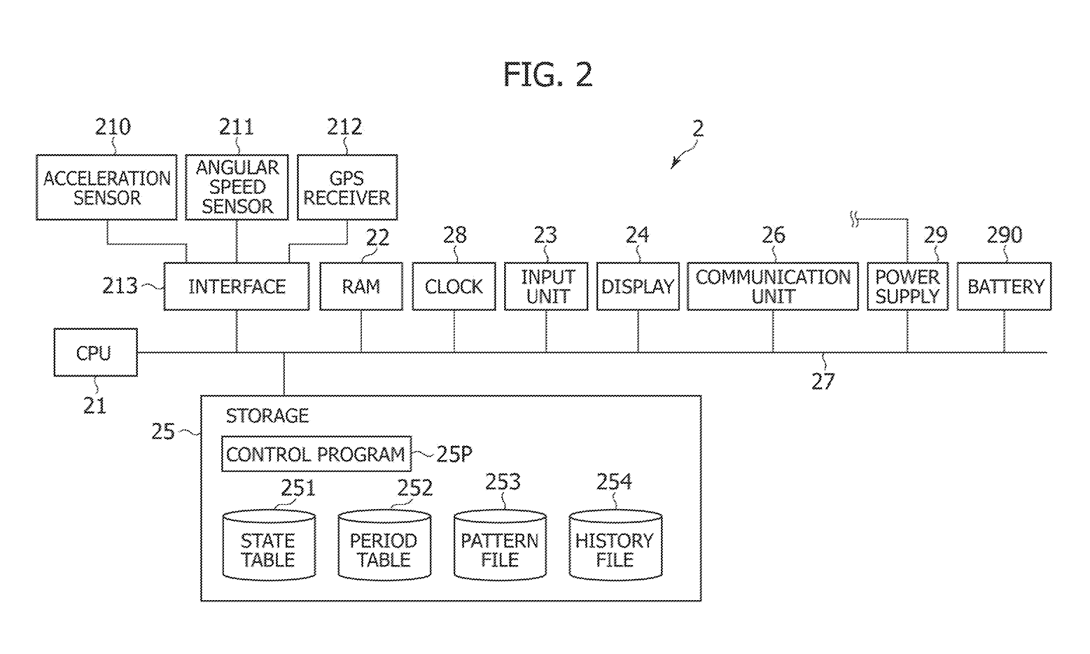

FIG. 2 illustrates a first hardware structure example of the control apparatus 2. The control apparatus 2 includes central processing apparatus (CPU) 21, random-access memory (RAM) 22, input unit 23, display 24, storage 25, communication unit 26, clock 28, interface 213, battery 290, and power supply 29. The control apparatus 2 also includes a vibration detection sensor and a position-fixing device, each connected to the interface 213. The vibration detection sensor may be an acceleration sensor, an angular speed sensor, or a combination thereof. According to the first embodiment, an acceleration sensor 210 and an angular speed sensor 211 are used.

Position fixing may be based on the GPS system, based on a wireless LAN card and a plurality of access points, or based on the cellular phone 10 and a cellular phone base station. According to the first embodiment, the GPS system is used for position fixing. The position-fixing device is a GPS receiver 212. The interface 213 may be universal serial bus (USB) ports, and connects to the acceleration sensor 210, the angular speed sensor 211, and the GPS receiver 212. The CPU 21 is connected to every hardware element via a bus 27 and the interface 213. A control program 25P stored on a storage 25 to be discussed later is executed by the CPU 21, and every function of the control apparatus 2 is thus performed.

According to the first embodiment, the acceleration sensor 210, the angular speed sensor 211, and the GPS receiver 212 are included in the control apparatus 2. The arrangement is not limited to this. Alternatively, the acceleration sensor 210, the angular speed sensor 211, and the GPS receiver 212 may be connected to the interface 213 exposed out of a casing (not illustrated) of the control apparatus 2.

The input unit 23 may be one of the input devices including a switch, a touch panel, a mouse, and an operation button. The input unit 23 outputs received operation information to the CPU 21. The display 24 may be a liquid-crystal display, an organic electroluminescence (EL) display, or the like. The display 24 displays a variety of information in response to an instruction output from the CPU 21. In one embodiment, the display 24 may be a touch panel laminated on the input unit 23. The RAM 22 may be one of a static RAM (SRAM), a dynamic RAM (DRAM), and a flash memory. The RAM 22 temporarily stores a variety of data generated in the course of execution of a variety of programs executed by the CPU 21.

The communication unit 26 may be a wireless LAN card, a cellular phone communication module, or Bluetooth (registered trademark). The communication unit 26 exchanges information with the server computer 1 or another computer (not illustrated) via the communication network N. The clock 28 outputs time and date information to the CPU 21. The power supply 29 controls power from the battery 290. With a power switch turned on in the input unit 23, the power supply 29 supplies power from the battery 290 to each of hardware elements including the CPU 21, the acceleration sensor 210, the angular speed sensor 211, and the GPS receiver 212. With the power switch turned off on the input unit 23, the power supply 29 stops supplying power from the battery 290 to each of hardware elements including the CPU 21, the acceleration sensor 210, the angular speed sensor 211, and the GPS receiver 212.

The acceleration sensor 210 may be a three-axis piezoresistance acceleration sensor or a capacitance type acceleration sensor. The acceleration sensor 210 outputs as information related to vibration the detected acceleration to the CPU 21 via the interface 213. The angular speed sensor 211 may be a fiber-optic gyroscope or a gyroscope. The angular speed sensor 211 outputs as information related to vibration an angular speed to the CPU 21 via the interface 213. In the discussion that follows, an acceleration acquired from the acceleration sensor 210 and an angular speed acquired from the angular speed sensor 211 are referred to as vibration information.

The GPS receiver 212 receives a radio wave from GPS satellites, and measures a position (latitude, longitude, and altitude), and a bearing. The GPS receiver 212 outputs the position and bearing (hereinafter referred to as position information) to the CPU 21 via the interface 213.

The storage 25 is a hard disk or a mass storage memory, and stores control program 25P, state table 251, period table 252, pattern file 253, and history file 254. According to the first embodiment, the storage 25 stores all of the control program 25P, the state table 251, the period table 252, the pattern file 253, and the history file 254. But the storage arrangement is not limited to this configuration. For example, the control program 25P, the state table 251, the period table 252, the pattern file 253, and the history file 254 may be separately stored on another storage (not illustrated). Alternatively, part of these pieces of information may be stored on a USB memory connected via the interface 213.

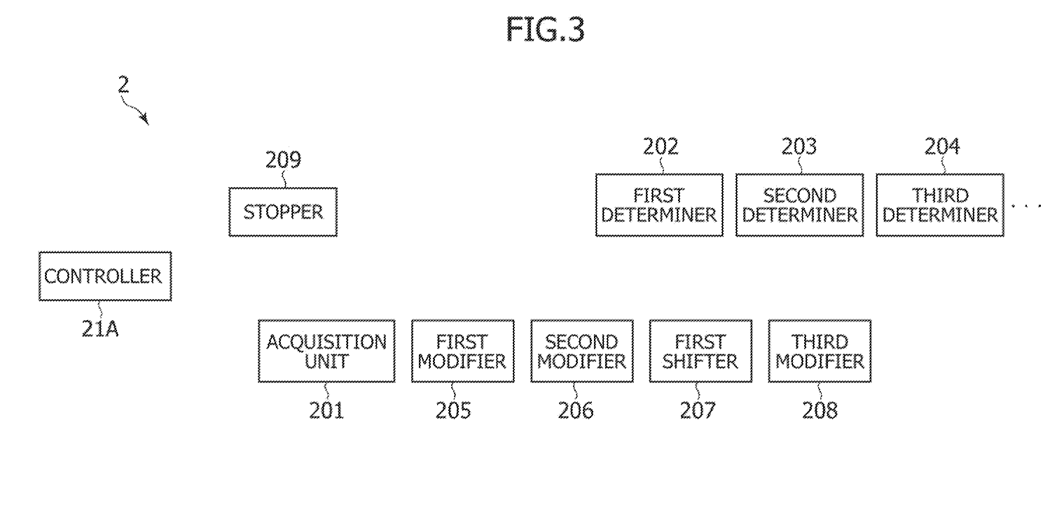

FIG. 3 illustrates a functional configuration example of the control apparatus 2 of the first embodiment. The control program 25P stored on the storage 25 is executed by the CPU 21 in the control apparatus 2. Thus executed are functions of controller 21A, acquisition unit 201, first determiner 202, second determiner 203, third determiner 204, first modifier 205, second modifier 206, first shifter 207, third modifier 208, and stopper 209. The execution of the control program 25P may be replaced with the incorporation of a circuit performing the functions of the controller 21A, the acquisition unit 201, the first determiner 202, the second determiner 203, the third determiner 204, the first modifier 205, the second modifier 206, the first shifter 207, the third modifier 208, and the stopper 209.

The controller 21A controls the function of the acquisition unit 201 and the first determiner 202.

The acquisition unit 201 calculates a speed in response to an acceleration output from the acceleration sensor 210 via the interface 213. For example, the acquisition unit 201 calculates the speed by integrating the acceleration output from the acceleration sensor 210. According to the first embodiment, the acquisition unit 201 calculates the speed based on the acceleration output from the acceleration sensor 210. The calculation method of the speed is not limited to this method. For example, the acquisition unit 201 may calculate the speed based on the measurement period of the GPS receiver 212 and a travel distance per period. Alternatively, the acquisition unit 201 may acquire the speed output from a speed detection electronic control unit (ECU) of the truck 5 via the communication unit 26 such as Bluetooth (registered trademark) or a vehicle LAN port (not illustrated) of the truck 5. The acquisition unit 201 acquires the speed, the vibration information, and the position information from the acceleration sensor 210, the angular speed sensor 211, the GPS receiver 212, the speed detection ECU (not illustrated), and the like. The acquisition unit 201 outputs thus acquired speed, vibration information, and position information to the controller 21A. The acquisition unit 201 stores the speed, vibration information, and position information in the history file 254 on the storage 25 with time and date output from the clock 28 mapped thereto.

The controller 21A outputs the speed acquired by the acquisition unit 201 to each of the first determiner 202, the second determiner 203, and the first shifter 207. The vibration information acquired by the acquisition unit 201 is output to the third determiner 204. An initial state refers to a state in which the position fixing of the position of the control apparatus 2 starts with power supplied by the power supply 29. When the machine tool 3 is to be moved, the user powers on the control apparatus 2 using the input unit 23 in the control apparatus 2 attached to the machine tool 3. The user powers on the control apparatus 2 using the input unit 23 and the power supply 29 starts supplying power. The controller 21A in the control apparatus 2 determines that the control apparatus 2 has shifted into the initial state. The controller 21A outputs to the first determiner 202 information indicating that the control apparatus 2 is in the initial state.

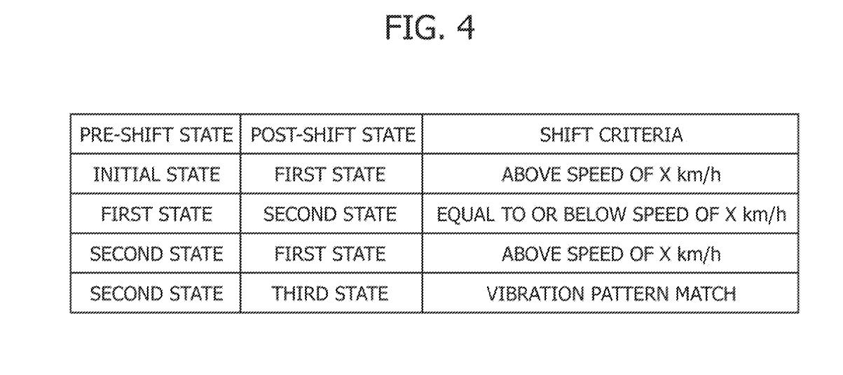

With the control apparatus 2 in the initial state, the first determiner 202 references the state table 251. If the speed acquired by the acquisition unit 201 is above a specific speed, the acquisition unit 201 determines that the state of the control apparatus 2 has shifted from the initial state into a first state. The detail of the state table 251 is described below with reference to FIG. 4.

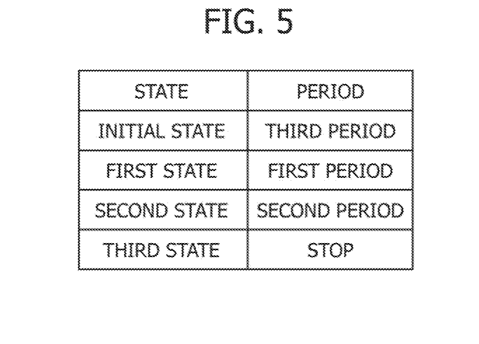

Upon determining that the control apparatus 2 has shifted from the initial state into the first state, the first determiner 202 outputs to the first modifier 205 and the second determiner 203 information indicating that the control apparatus 2 is in the first state. Upon receiving the information indicating that the control apparatus 2 is in the first state, the first modifier 205 references the period table 252 and then outputs to the GPS receiver 212 an instruction to modify the measurement period to a first period. The detail of the period table 252 is described below with reference to FIG. 5.

In response to the instruction, the GPS receiver 212 modifies the measurement period to the first period.

With the control apparatus 2 in the first state, the second determiner 203 references the state table 251. If the speed acquired by the acquisition unit 201 becomes equal to or below the specific speed, the second determiner 203 determines that the control apparatus 2 has shifted from the first state into the second state.

Upon determining that the control apparatus 2 has shifted from the first state into the second state, the second determiner 203 outputs to the second modifier 206 information indicating that the control apparatus 2 is in the second state.

Upon receiving the information indicating that the control apparatus 2 is in the second state, the second modifier 206 references the period table 252 and outputs to the GPS receiver 212 an instruction to modify the measurement period to a second period shorter than the first period. In response to the instruction, the GPS receiver 212 modifies the measurement period to the second period. The second determiner 203 outputs to the first shifter 207 and the third determiner 204 the information indicating that the control apparatus 2 is in the second state.

With the control apparatus 2 in the second state, the first shifter 207 references the state table 251. If the speed acquired by the acquisition unit 201 exceeds the specific speed, the first shifter 207 determines that the control apparatus 2 has shifted from the second state into the first state.

Upon determining that the control apparatus 2 has shifted from the second state into the first state, the first shifter 207 outputs to the first modifier 205 the information indicating that the control apparatus 2 is in the first state. In response to the information indicating that the control apparatus 2 is in the first state, the first modifier 205 references the period table 252 as described above. The first modifier 205 outputs to the GPS receiver 212 an instruction to modify the measurement period to the first period. In response to the instruction, the GPS receiver 212 modifies the measurement period to the first period.

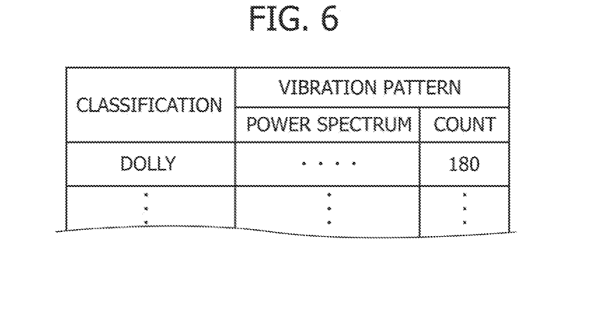

If the vibration information acquired by the acquisition unit 201 matches a vibration pattern stored in the pattern file 253 with the control apparatus 2 in the second state, the third determiner 204 determines that the control apparatus 2 has shifted from the second state to a third state. The pattern file 253 is described in detail below with reference to FIG. 6.

Upon determining that the control apparatus 2 has shifted from the second state to the third state, the third determiner 204 outputs to the stopper 209 information indicating that the control apparatus 2 is in the third state. Alternatively, upon determining that the control apparatus 2 has shifted from the second state to the third state, the third modifier 208 may output to the GPS receiver 212 an instruction to modify the measurement period to any desired period equal to or longer than the first period. In response to the instruction, the GPS receiver 212 modifies the measurement period to the period having the desired length equal to or longer than the length of the first period.

Upon receiving the information indicating that the control apparatus 2 is in the third state, the stopper 209 outputs to the power supply 29 an instruction to stop supplying power to the GPS receiver 212. In response to the instruction, the power supply 29 stops supplying power to the GPS receiver 212.

FIG. 4 illustrates a first record layout of the state table 251. The state table 251 lists the state of the control apparatus 2, and shift criteria for determining whether the control apparatus 2 has shifted into each state. The state table 251 includes a pre-shift state field, a post-shift state field, and a shift criteria field. The pre-shift state field lists states of the control apparatus 2 prior to shifting. The post-shift state field lists states of the control apparatus 2 subsequent to shifting. The shift criteria field lists criteria which are applied to a combination of the pre-shift state and the post-shift state and according to which the control apparatus 2 is determined as being shifted from the pre-shift state to the post-shift state.

For example, with the control apparatus 2 in the initial state, the machine tool 3 may be loaded on the truck 5, and the truck 5 then may start moving. The first determiner 202 references the state table 251 of FIG. 4 with the control apparatus 2 in the initial state. If the speed acquired by the acquisition unit 201 in response to the acceleration from the acceleration sensor 210 becomes a speed of X km/h with the truck 5 traveling, the first determiner 202 determines that the control apparatus 2 has shifted from the initial state to the first state. The speed X km/h may be 60 km/h, for example. The numerical values are cited in the first embodiment for exemplary purposes only.

With the control apparatus 2 in the first state, the first determiner 202 references the state table 251 of FIG. 4. If the speed acquired by the acquisition unit 201 becomes equal to or below a speed of X km/h, the first determiner 202 determines that the control apparatus 2 has shifted from the first state into the second state.

With reference to FIG. 4, the state table 251 lists two cases that are possible once the second state is taken. In one case, the first determiner 202 determines that the control apparatus 2 is shifted into the first state, and in the other case, the first determiner 202 determines that the control apparatus 2 is shifted into the third case.

With the control apparatus 2 in the second state, the first determiner 202 references the state table 251 of FIG. 4. If the speed acquired by the acquisition unit 201 rises above a speed of X km/h again, the first determiner 202 determines that the control apparatus 2 has shifted from the second state into the first state.

If the vibration information acquired by the acquisition unit 201 matches a vibration pattern stored in the pattern file 253, the third determiner 204 determines that the control apparatus 2 has shifted from the second state into the third state. The user may appropriately modify the shift criteria using the input unit 23. The controller 21A stores the input shift criteria on the state table 251.

FIG. 5 illustrates a first example of the record layout of the period table 252. The period table 252 includes a state field and a period field. The state field lists a variety of states including the initial state and the first state. The period field lists a period with which the GPS receiver 212 is to fix position. A frequency may be stored in place of the period. For example, the second period may be 1 minute, and the GPS receiver 212 outputs the position information to the CPU 21 every 1 minute. The first period may be set to be longer than the second period to reduce power consumption. For example, the first period may be 30 minutes. In the initial state, the third period longer than the first period may be set. The third period may be 6 hours, for example. In the third state, the GPS receiver 212 may be stopped from the position-fixing operation thereof or the third period may be set. According to the first embodiment, the GPS receiver 212 is stopped from the position-fixing operation thereof in the third state. The user may modify the period appropriately using the input unit 23. The CPU 21 stores on the period table 252 the input period with the state mapped thereto. The record layout of the first embodiment is discussed for exemplary purposes only. As long as the data relationship described above is maintained, the record layout is not limited to the one described above.

FIG. 6 illustrates a first example of the record layout of the pattern file 253. The pattern file 253 lists vibration patterns that serve as a criterion to determine what type of vibration the vibration information shows. The pattern file 253 includes a classification field, a power spectral filed, and a count field. The power spectral field lists a power spectrum responsive to a transport classification type of the control apparatus 2. The transport classification type includes the dolly 4, a crane, a forklift, an escalator, an elevator, and a manual transport by human.

According to the first embodiment, the power spectral field lists a power spectrum that takes place when the dolly 4 is used, for example. Frequency characteristics change depending on the transport classification type, and typical power spectra may be pre-stored in the power spectral field. The power spectrum may be obtained by fast Fourier transforming time-series acceleration data of a specific time period (1 second, for example) acquired from the acceleration sensor 210. According to the first embodiment, information listed in the power spectral field is power spectrum. Alternatively, time-series data of 5 seconds, for example, may be used in place of the power spectrum. Wavelet transform may be used in place of fast Fourier transform.

The acquisition unit 201 fast-Fourier transforms the acceleration from the acceleration sensor 210 to calculate the power spectrum. The third determiner 204 pattern-matches the power spectrum calculated by the acquisition unit 201 against a power spectrum stored on the pattern file 253. The third determiner 204 calculates a correlation value between the power spectra, and determines that the spectra match each other if the correlation value is determined to be equal to or lower than a specific value. In the pattern-matching of the third determiner 204 of the first embodiment, the power spectrum is normalized with a reference direction such as a vertical direction recognized. The pattern-matching operation may be performed on part or all of X axis, Y axis, and Z axis. The acquisition unit 201 may calculate the power spectrum responsive to a time-varied angular speed output by the angular speed sensor 211, and the third determiner 204 may perform the pattern-matching operation with that power spectrum accounted for. In this case, the pattern-matching operation on the power spectra of each of the acceleration sensor 210 and the angular speed sensor 211. For simplicity of explanation in the following discussion, only the acceleration sensor 210 is used in the pattern-matching operation. The count field lists a matched count of power spectrum per unit time. In FIG. 6, the count field lists 180 times. In the example here, the pattern-matching operation is performed every 1 second. It takes 3 minutes to complete the pattern-matching operation on the power spectra by 180 times. The classification field lists the transport type with the power spectrum and the count mapped thereto. According to the first embodiment, the classification field lists “dolly” indicating the transport by the dolly 4.

The user may modify the power spectrum, the count, and the classification using the input unit 23. The input power spectrum, count, and classification are stored on the pattern file 253. The time equivalent to the count (3 minutes, for example) may be stored in place of the count. Since an error might be involved, the third determiner 204 calculates a sampling count (216) by multiplying the count (180) by a specific coefficient (1.2, for example), and determines that the vibration pattern matching has been successful if a successful pattern matching count is higher than the sampling count stored.

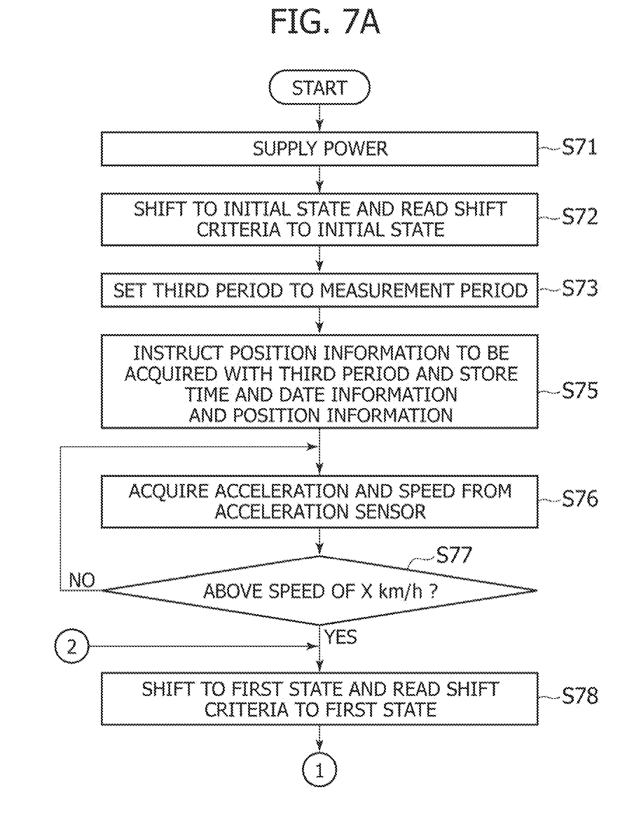

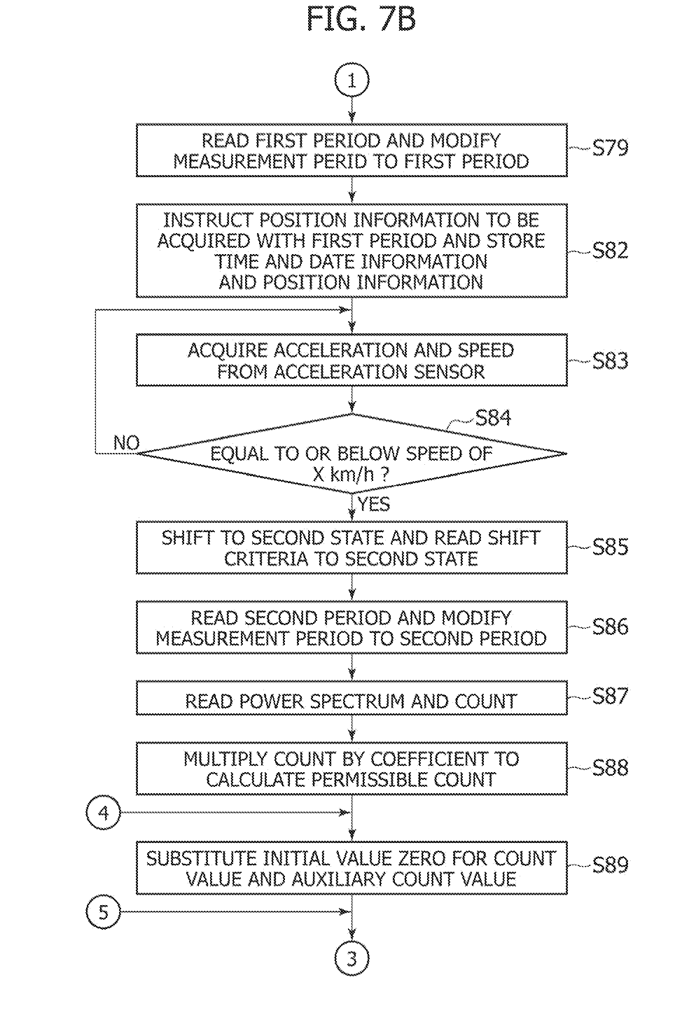

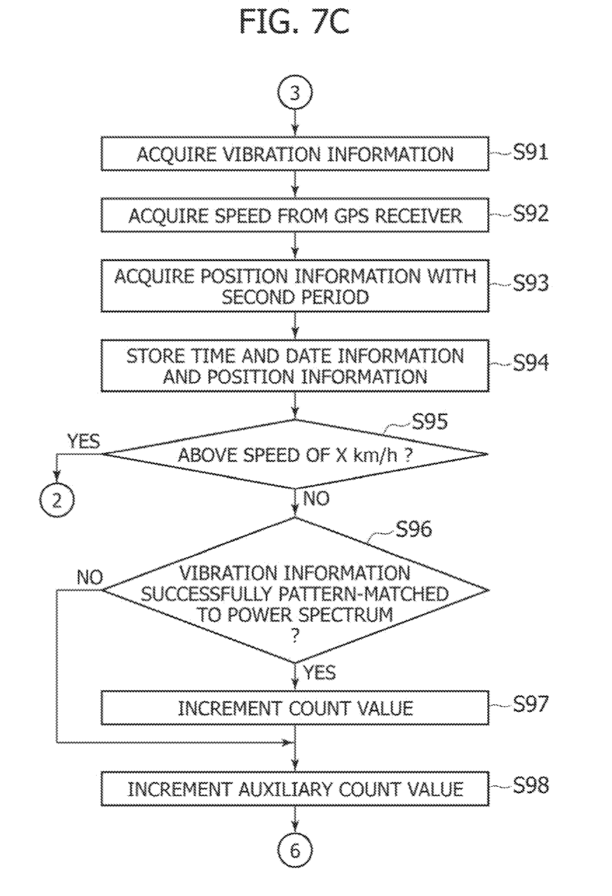

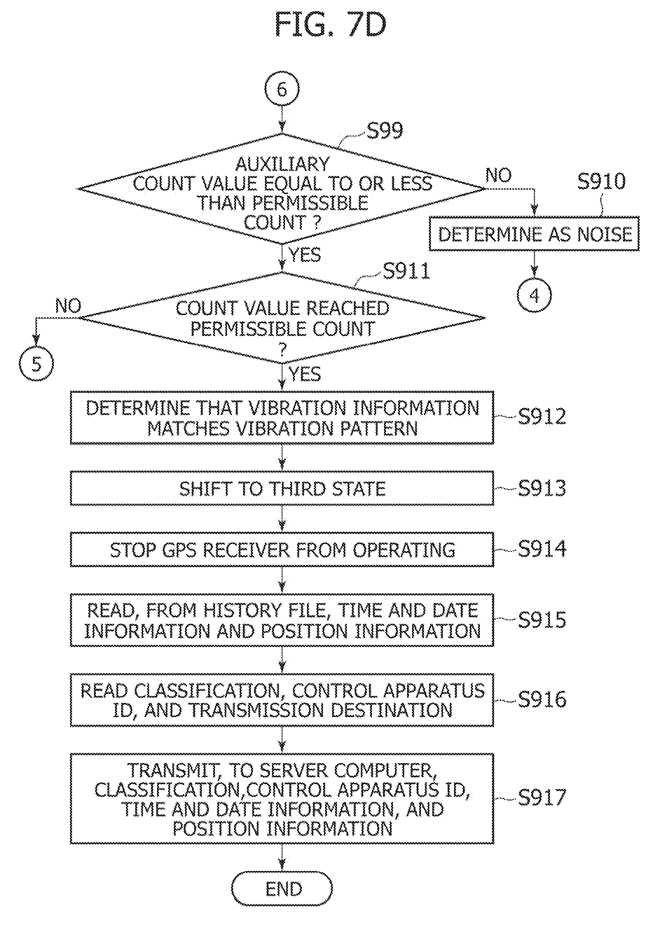

The functions of the control apparatus 2 are described below with reference to a flowchart of FIGS. 7A-7D. FIGS. 7A-7D is a flowchart illustrating first example of a shift process. The control apparatus 2 is switched on in response to an instruction input on the input unit 23 by the user or a setting on the input unit 23 by the user. The power supply 29 starts supplying power from the battery 290 (S71). With power supplied to the control apparatus 2, the control apparatus 2 determines that the state of the control apparatus 2 has shifted into the initial state. The control apparatus 2 reads from the state table 251 the shift criteria corresponding to the initial state as a pre-shift state (S72). As illustrated in FIG. 4, the shift criterion in the initial state is “above speed of X km/h.” The control apparatus 2 reads from the period table 252 the third period corresponding to the initial state, and sets the third period to the measurement period of position fixing of the GPS receiver 212 (S73). The GPS receiver 212 thereafter fixes position with the third period. The control apparatus 2 stores time and date output from the clock 28 and the position information acquired from the GPS receiver 212 in a mapped state in the history file 254 (S75).

The control apparatus 2 acquires the acceleration from the acceleration sensor 210 and determines the speed by integrating the acceleration (S76). The control apparatus 2 determines whether the acquired speed is above speed of X km/h as the shift criteria of the initial state (S77). If the control apparatus 2 determines that the acquired speed is not above a speed of X km/h (no from S77), processing returns to S76. The above-described process is repeated.

If it is determined that the acquired speed is above speed of X km/h (yes from S77), the control apparatus 2 determines that the state of the control apparatus 2 has shifted from the initial state to the first state, and reads from the state table 251 the shift criteria corresponding to the first state as a pre-shift state (S78). As illustrated in FIG. 4, the shift criterion to the first state is “equal to or below speed of X km/h.” The control apparatus 2 reads from the period table 252 the first period of the first state, and modifies the measurement period of position fixing of the GPS receiver 212 to the first period (S79). The GPS receiver 212 fixes position with the first period. The control apparatus 2 acquires the position information with the first period, and stores in the history file 254 the acquired position information with time and date output from the clock 28 mapped thereto (S82). In the above example, the machine tool 3 is being transported on the truck 5, and the control apparatus 2 modifies the measurement period to a power saving mode having a 30-minute length. The control apparatus 2 acquires the acceleration from the acceleration sensor 210, and determines the speed resulting from the acceleration (S83).

The control apparatus 2 determines whether the acquired speed is equal to or below a speed of X km/h as the shift criteria to the first state (S84). If the control apparatus 2 determines that the acquired speed fails to satisfy the shift criteria of being equal to or below speed of X km/h to the first state (no from S84), processing returns to S83. If the control apparatus 2 determines that the acquired speed is equal to or below a speed of X km/h as the shift criteria to the first state (yes from S84), processing proceeds to S85. The control apparatus 2 determines that the state of the control apparatus 2 has shifted from the first state to the second state and then reads from the state table 251 the shift criteria corresponding to the second state as a pre-shift state (S85). As illustrated in FIG. 4, the shift criteria of the second state is “above X km/h” or “vibration pattern match.”

The control apparatus 2 reads the second period of the second state from the period table 252, and modifies the measurement period of position fixing of the GPS receiver 212 to the second period (S86). Since approaching of the machine tool 3 to the destination thereof, namely, the installation location thereof, may cause the speed to be equal to or below speed of X km/h, position fixing is performed with a period shorter than the period with which the speed is higher than speed of X km/h. The measurement period of position fixing of the GPS receiver 212 is as short as 1 minute. Latitude and longitude are densely collected in an area where the destination is likely present. The control apparatus 2 reads from the pattern file 253 a power spectrum and a count, serving as a template (S87). The control apparatus 2 multiplies the count by a coefficient stored on the storage 25 to calculate a permissible count (S88).

The control apparatus 2 substitutes an initial value zero for a count value and an auxiliary count value, which are integer variables (S89). The control apparatus 2 acquires the vibration information from the acceleration sensor 210 (S91). Since the measurement period of position fixing of the GPS receiver 212 becomes shorter, the control apparatus 2 switches the speed acquisition source from the acceleration sensor 210 to the GPS receiver 212. The control apparatus 2 calculates a distance per unit time from the position information acquired with the period obtained via the interface 213 and then calculates the speed. The control apparatus 2 thus acquires the speed from the GPS receiver 212 (S92). In S92, the speed is acquired from the GPS receiver 212. The speed acquisition method is not limited to this method. For example, the speed may be acquired from the acceleration sensor 210 as in the same manner as in S76. In the initial state and the first state, the speed may be acquired from the GPS receiver 212.

The control apparatus 2 acquires the position information with the second period from the GPS receiver 212 (S93). The control apparatus 2 stores time and date output from the clock 28 and the position information in the history file 254 (S94). The control apparatus 2 determines whether the acquired speed is above speed of X km/h (S95). If the control apparatus 2 determines that the acquired speed is above speed of X km/h (yes from S95), the control apparatus 2 also determines that the machine tool 3 has temporarily reduced the speed thereof and is not yet close to the destination. Processing returns to S78. Position fixing is performed again with the first period.

If the control apparatus 2 determines that the acquired speed is not above speed of X km/h (no from S95), the control apparatus 2 also determines whether the vibration information acquired in S91 has successfully matched the power spectrum read in S87 (S96). If the control apparatus 2 determines that the pattern matching has been successfully completed (yes from S96), the control apparatus 2 increments the count value (S97). If the control apparatus 2 determines that the pattern matching has not been successfully completed (no from S96), S97 is skipped. The control apparatus 2 increments the auxiliary count value (S98).

The control apparatus 2 determines whether the auxiliary count value is equal to or below the permissible count calculated in S88 (S99). Upon determining that the auxiliary count value is equal to or below the permissible count (yes from S99), the control apparatus 2 determines whether the count value has reached the count read in S87 (S911). Upon determining that the count value has yet to reach the count (no from S911), the control apparatus 2 returns to S91 to repeat the pattern-matching operation. Upon determining that the auxiliary count value is not equal to or below the permissible count in S99, the control apparatus 2 determines that the vibration information is noise (S910). Processing returns to S89. The control apparatus 2 substitutes an initial value zero for the count value and the auxiliary count value, which are integer variables and repeats the above-described process.

If the control apparatus 2 determines that the count value has reached the count (yes from S911), the control apparatus 2 determines that the vibration information matches the vibration pattern (S912). The control apparatus 2 references the state table 251, and then determines that the state of the control apparatus 2 has shifted into the third state (S913). The control apparatus 2 reads from the period table 252 “stop” for the third state. The control apparatus 2 stops the GPS receiver 212 from operating (S914). For example, the control apparatus 2 controls the power supply 29, thereby stopping supplying power to the GPS receiver 212. The control apparatus 2 reads time and date information and the position information from the history file 254 (S915). The control apparatus 2 reads classification from the pattern file 253 (the dolly 4 in this example), and a control apparatus ID and a transmission destination of the server computer 1 (address represented by Internet protocol (IP) address or uniform resource locator (URL)) from the storage 25 (S916). The control apparatus ID is unique identification information identifying each of a plurality of control apparatuses 2.

The control apparatus 2 references the transmission destination, and transmits to the server computer 1 the classification, the control apparatus ID, the time and date information and the position information via the communication unit 26, a wireless LAN access point arranged in the plant 6, and the communication network N (S917). In one embodiment, only last information of the position information in time series may be transmitted.

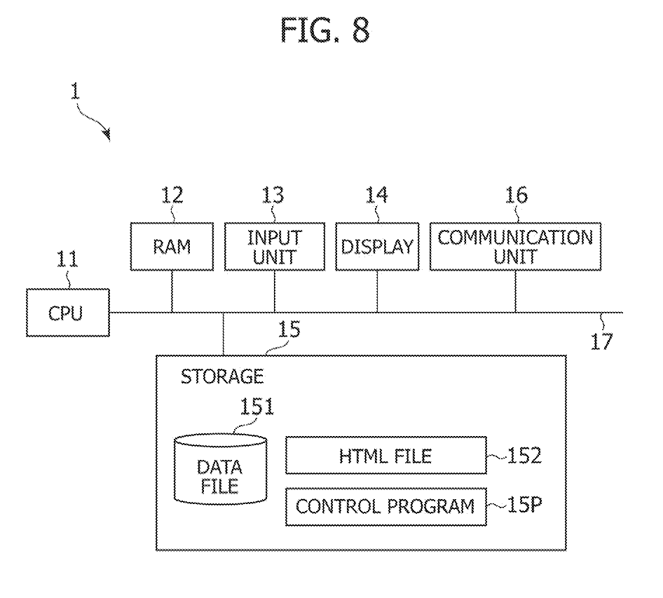

FIG. 8 illustrates a hardware example of the server computer 1. The server computer 1 includes CPU 11 as a controller, RAM 12, input unit 13, display 14, storage 15 and communication unit 16. The CPU 11 is connected to each hardware element in the server computer 1 via the bus 17. The CPU 11 controls the hardware elements and executes a variety of software functions in accordance with a control program 15P stored on the storage 15.

The communication unit 16 serves as a gateway and a firewall, and exchanges information with the cellular phone 10 and the control apparatus 2 through hypertext transfer protocol (HTTP). The storage 15 includes a hard disk or a large-capacity memory, and stores, in addition to the control program 15P, data file 151, and hypertext markup language (HTML) file 152. The data file 151 and the HTML file 152 may be stored on an external database server (not illustrated), and may be read therefrom or written thereto as necessary.

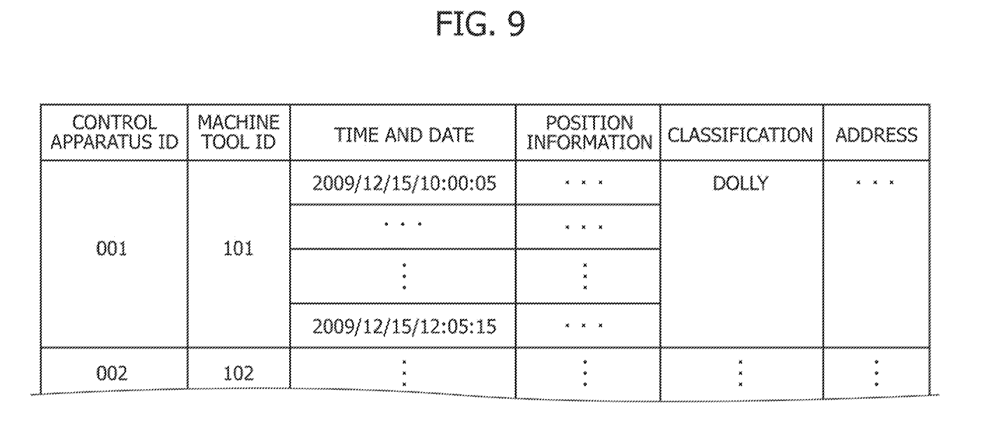

The input unit 13 includes a keyboard and a mouse. Operation information input via the input unit 13 is output to the CPU 11. The display 14 may be a liquid-crystal display, an organic electroluminescence (EL) display, or the like. The display 14 displays specific information in response to an instruction from the CPU 11. FIG. 9 illustrates an example of the record layout of the data file 151. The data file 151 stores information of a plurality of control apparatuses 2. The data file 151 includes control apparatus ID field, machine tool ID field, time and date field, position information field, classification field, and address field.

The control apparatus ID field lists the control apparatus ID transmitted from the control apparatus 2 in S917. The machine tool ID is a unique ID identifying the machine tool 3 having the control apparatus 2 attached thereto. The machine tool ID is pre-stored on the storage 15 with the control apparatus ID mapped thereto. Upon receiving the control apparatus ID, the CPU 11 stores the corresponding machine tool ID in the machine tool ID field. As illustrated in FIG. 9, a machine tool ID “101” corresponding to a control apparatus ID “001” is stored. Alternatively, the machine tool ID and the control apparatus ID may be pre-stored on the storage 25 in the control apparatus 2. In such a case, the control apparatus 2 transmits to the server computer 1 the machine tool ID together with the control apparatus ID.

The time and date field lists, in time series order, time and date data at position fixing transmitted in S917. The position information field stores the position information corresponding to the time and date transmitted in S917. The position information is represented by latitude, longitude, altitude, and probable measurement error information. For example, latitude, longitude, and altitude are respectively 35° 58.238 north latitude, 139° 64.244 east longitude, and 0 m altitude. The probable measurement error information is represented by a major axis length, a minor axis length, an altitude error, and a major axis inclination. For example, the major axis length, the minor axis length, the altitude error, and the major axis inclination are 119 m, 70 m, 0 m, and 145°. The classification field lists the classification transmitted in S917 (the dolly 4 in this example). The CPU 11 references an address database (not illustrated), and searches for an address corresponding to the position information of last time and date in time series. As illustrated in FIG. 9, the CPU 11 searches for the address corresponding to the position information at 12:05:15, Dec. 15, 2009 (2009/12/15/12:05:15). The CPU 11 stores the hit address with the control apparatus ID mapped thereto. Each time information is transmitted from each of the control apparatuses 2, the CPU 11 in the server computer 1 updates the content of the data file 151.

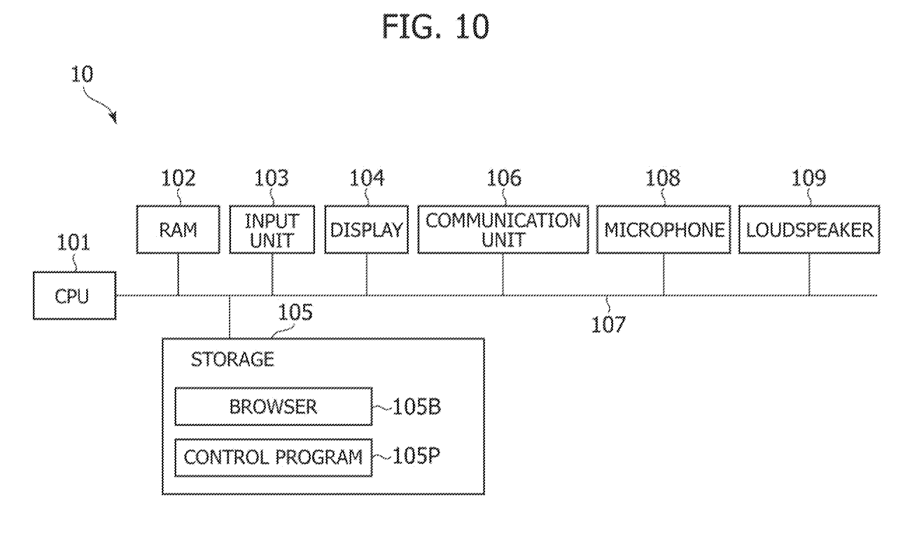

FIG. 10 illustrates a hardware example of the cellular phone 10. The cellular phone 10 includes CPU 101, RAM 102, input unit 103, display 104, communication unit 106, microphone 108, loudspeaker 109, and storage 105. The CPU 101 is connected to each hardware element in the cellular phone 10. The CPU 101 controls the hardware elements and executes a variety of software functions in accordance with a control program 105P stored on the storage 105.

The display 104 may be a liquid-crystal display, an organic electroluminescence (EL) display, or the like. The input unit 103 includes a push button. The display 104 and the input unit 103 may be integrated into a unitary body like a touch panel. The loudspeaker 109 amplifies and outputs voice data, talk data, and a voice signal of a voice input via the microphone 108. The microphone 108 converts a voice signal input from the outside into an electrical signal. The converted electrical signal is converted into digital data through an analog-to-digital converter (not illustrated), and then output to the CPU 101. The communication unit 106 includes a high-frequency transmitter, an antenna, and the like, and transmits and receives a variety of data including voice data, and character data.

The storage 105 stores the control program 105P and browser 105B. The browser 105B analyzes HTML files exchanged via the communication unit 106 through HTTP, and then displays the HTML files on the display 104. The user starts the browser 105B using the input unit 103 in the cellular phone 10, thereby accessing the server computer 1. The user also inputs the control apparatus ID and the machine tool ID using the input unit 103. In the discussion that follows, the control apparatus ID is used. The CPU 101 transmits the input control apparatus ID to the server computer 1.

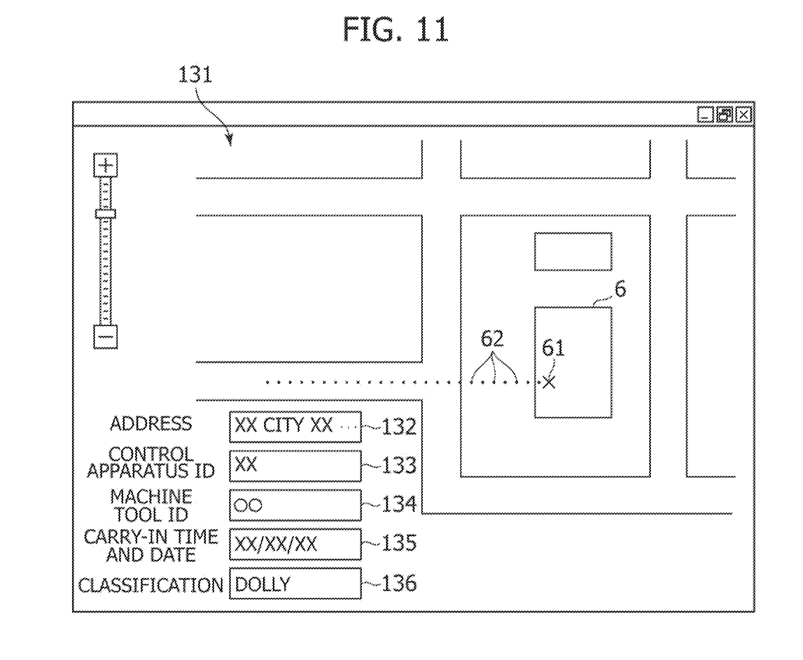

Upon receiving the control apparatus ID, the CPU 11 in the server computer 1 transmits the position information of the corresponding control apparatus 2 to the cellular phone 10. FIG. 11 illustrates a display image presented on the display 104 in the cellular phone 10. The server computer 1 receives an HTML document serving as a base from the HTML file 152. The CPU 11 reads an address corresponding to the control apparatus ID. The CPU 11 receives chart data corresponding to the address from a chart database server (not illustrated). The CPU 11 writes, in the HTML document, the chart data, machine tool ID, control apparatus ID, carry-in time and date, classification, and position information. The CPU 11 transmits the HTML document thus constructed to the cellular phone 10.

Displayed in the HTML document as illustrated in FIG. 11 are address box 132, control apparatus ID box 133, machine tool ID box 134, carry-in time and date box 135, and classification box 136. The CPU 11 writes in the address box 132 the address stored on the data file 151. The CPU 11 writes the control apparatus ID as a search target in the control apparatus ID box 133. The CPU 11 reads from the data file 151 the machine tool ID corresponding to the control apparatus ID and writes the read machine tool ID in the machine tool ID box 134.

The CPU 11 writes in the carry-in time and date box 135 time and date latest in time series out of time and date corresponding to the control apparatus ID. The CPU 11 reads from the data file 151 the classification corresponding to the control apparatus ID as information representing the transport type and then writes the read classification in the classification box 136. The CPU 101 in the cellular phone 10 analyzes the transmitted HTML document and then displays information respectively responsive to the address box 132, the control apparatus ID box 133, the machine tool ID box 134, the carry-in time and date box 135, and the classification box 136.

The CPU 11 in the server computer 1 may write a carry-in map 131 as illustrated in FIG. 11. The CPU 11 reads the position information corresponding to the acquired time and date. The number of readings may be last 10 readings in time series. The CPU 11 references last position information in time series (latitude and longitude), and writes a delivery location 61 labeled X on the chart data. The CPU 11 references a plurality of pieces of position information other than last position information, and then writes a travel track 62 denoted by a broken line on the chart data. The CPU 11 transmits to the cellular phone 10 the carry-in map 131 in which the delivery location 61 and the travel track 62 are written on the chart data. The carry-in map 131 is displayed on the display 104 on the cellular phone 10. According to the first embodiment, the travel track 62 is also displayed. Alternatively, only the delivery location 61 may be displayed.

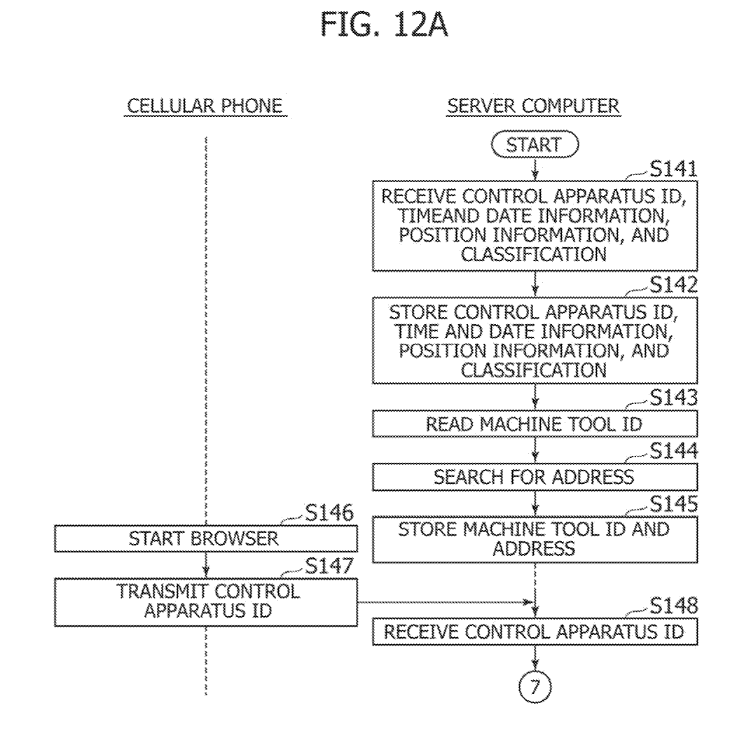

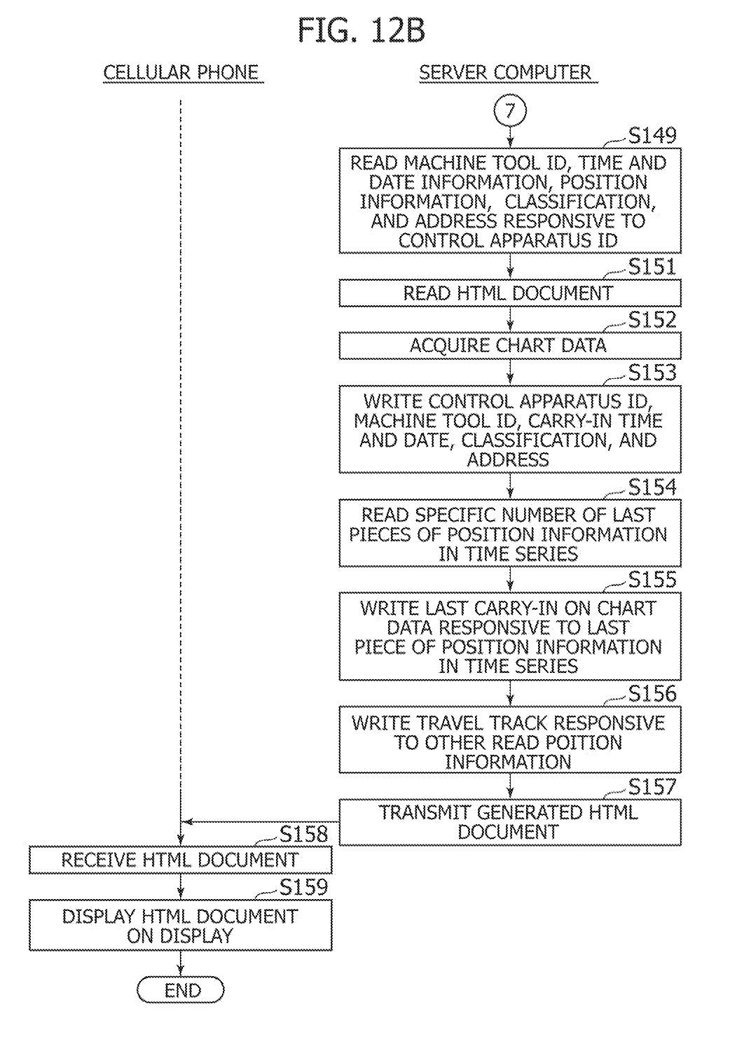

FIGS. 12A and 12B are a flowchart illustrating a collection and display process of position fixing results. The CPU 11 in the server computer 1 receives the control apparatus ID, the time and date information, the position information, and the classification transmitted from the control apparatus 2 (S141). The CPU 11 stores in the data file 151 the received control apparatus ID, time and date information, position information, and classification (S142). The CPU 11 reads from the storage 15 the machine tool ID corresponding to the control apparatus ID (S143). The CPU 11 references the received position information, and searches for the address (S144). The CPU 11 stores in the data file 151 the read machine tool ID and the hit address with the control apparatus ID mapped thereto (S145).

The CPU 101 in the cellular phone 10 starts up the browser 105B (S146). After establishing communication with the server computer 1, the cellular phone 10 transmits to the server computer 1 the control apparatus ID that the user desires to browse (S147). The CPU 11 in the server computer 1 receives the transmitted control apparatus ID (S148). The CPU 11 reads from the data file 151 the machine tool ID, time and date, position information, classification, and address corresponding to the control apparatus ID (S149). The CPU 11 reads the HTML document serving as a base (S151).

The CPU 11 acquires the chart data corresponding to the read address from a server computer (not illustrated) (S152). The CPU 11 writes the control apparatus ID in the control apparatus ID box 133, the machine tool ID in the machine tool ID box 134, last time and date in time series in the carry-in time and date box 135, the classification in the classification box 136, and the address in the address box 132 (S153). The CPU 11 reads last specific number of pieces of position information in time series (S154). The CPU 11 writes the delivery location 61 on the chart data of last piece of position information in time series (S155). The delivery location 61 is labeled the letter X in the first embodiment. Alternatively, the delivery location 61 may be indicated by the phrase “delivery location” or may be indicated any other symbol.

The CPU 11 writes on the chart data the travel track 62 corresponding to the read information other than last piece of position information (S156). The CPU 11 transmits the HTML document thus generated in the above-described process to the cellular phone 10 (S157). The CPU 101 in the cellular phone 10 receives the HTML document (S158). The CPU 101 analyzes the HTML document through the browser 105B. The CPU 101 displays the HTML document including the carry-in map 131 on the display 104 as illustrated in FIG. 11 (S159).

Furthermore, the control apparatus 2 may change a fashion in which the delivery location 61 and the travel track 62 are displayed. For example, part of the travel track 62, if working with the first period, may be displayed in blue. Part of the travel track 62, if working with the second period, may be displayed in a different color, for example, red. The control apparatus 2 may use different colors for different fashions. Alternatively, the control apparatus 2 may use lines of different type (solid line, broken line, and wavy line, for example), sounds of different type, marks of different type (square, circle, and number, for example). Even if the delivery location is not identified, the period may be lengthened to save power. The measurement period of position fixing of the GPS receiver 212 may be shortened in an area assumed to be close to the destination to estimate the destination at a high accuracy. Even if the machine tool 3 is carried into the plant 6 where the reception of the radio wave seems difficult, a terminal device such as the cellular phone 10 may track an approximate location of the machine tool 3.

### Second Embodiment

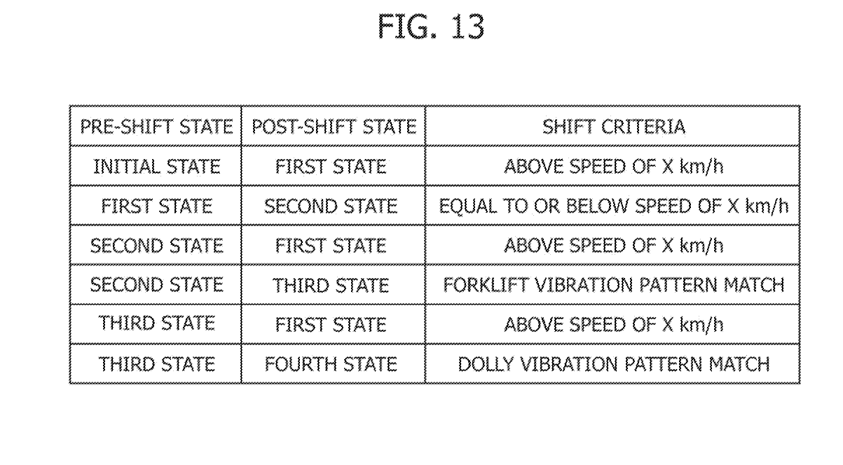

A second embodiment relates to a technique in which the control apparatus 2 determines that the state of the control apparatus 2 is shifted into a fourth state. FIG. 13 illustrates a second example of the record layout of the state table 251 of the second embodiment. The storage content of the state table 251 with the pre-shift state being the second state is different from the storage content in the first embodiment. If the pre-shift state is the second state, the first state and the third state are stored as a post-shift state. “Above speed of X km/h” is stored as a criterion for the determination that the state of the control apparatus 2 has shifted from the second state to the first state. Forklift vibration pattern match is stored as a criterion for the determination that the state of the control apparatus 2 has shifted from the second state to the third state.

With the pre-shift state being the third state, the first state and the fourth state are stored as a the post-shift state. “Above speed of X km/h” is stored as a shift criterion from the third state to the first state. Dolly vibration pattern match, described with reference to the first embodiment, is stored as a criterion for the determination that the state of the control apparatus 2 has shifted from the third state to the fourth state. The shift criteria from the second state to the third state and the shift criteria from the third state to the fourth state in the state table 251 are not limited to those listed in FIG. 13 as long as the transport types are different. For example, the shift criteria from the second state to the third state may be “vibration pattern match of the dolly 4” and the shift criteria from the third state to the fourth state may be “forklift vibration pattern match.” Furthermore, vibration pattern match of manual transport by human may be substituted for the forklift vibration pattern match. The state shifting discussed with reference to the second embodiment is an example only. Optionally, a fifth state may be further added.

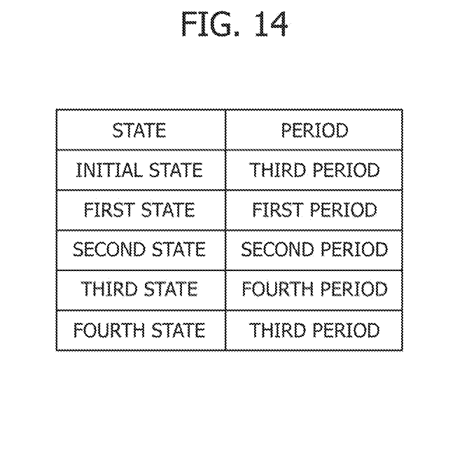

FIG. 14 illustrates a second example of the record layout of the period table 252 of the second embodiment. A fourth period is stored to be mapped to the third state. The fourth period may be set to be equal to or shorter than the second period. The third period is stored to be mapped to the fourth state. The third period may be set to be equal to or longer than the first period. The GPS receiver 212 may be stopped in the last state, i.e., the fourth state as in the first embodiment. In accordance with the second embodiment, the fourth period, the second period, the first period, and the third period have time lengths in the order of from short to long periods.

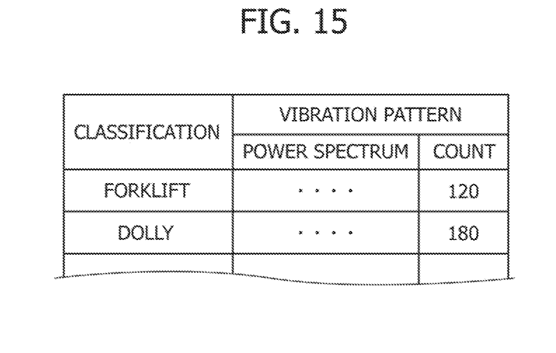

FIG. 15 illustrates a second example of the record layout of the pattern file 253 of the second embodiment. The classification field lists a forklift. The power spectrum responsive to the operation of the forklift is listed in a vibration pattern field in accordance with the classification forklift. A count of 120 is listed in accordance with the classification forklift.

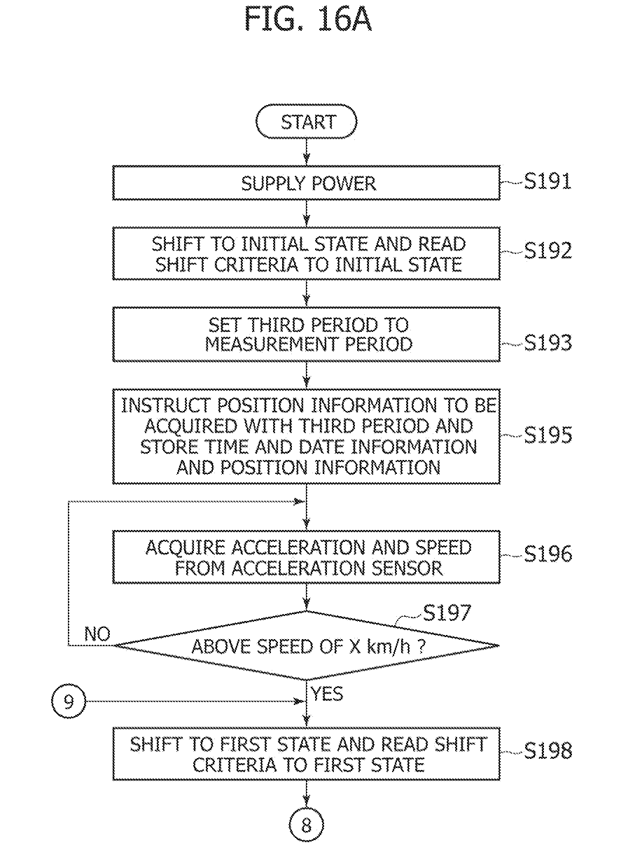

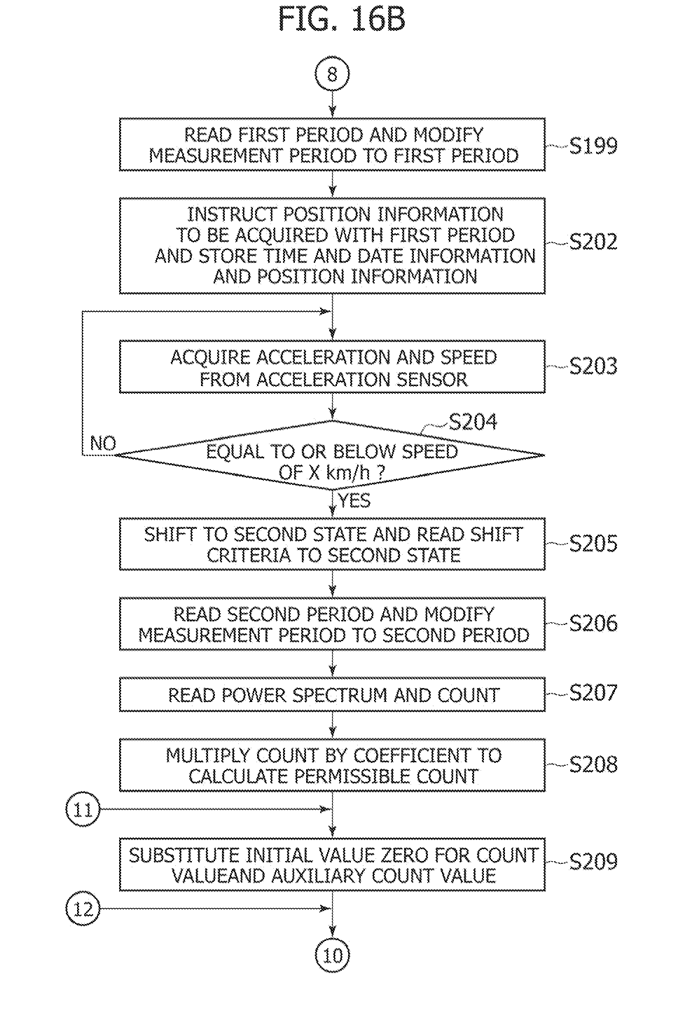

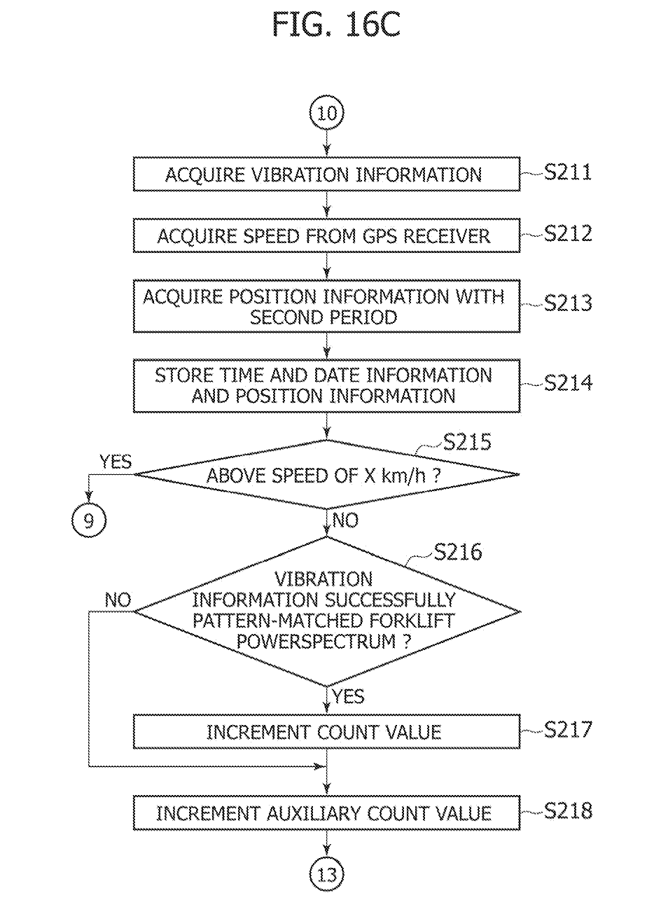

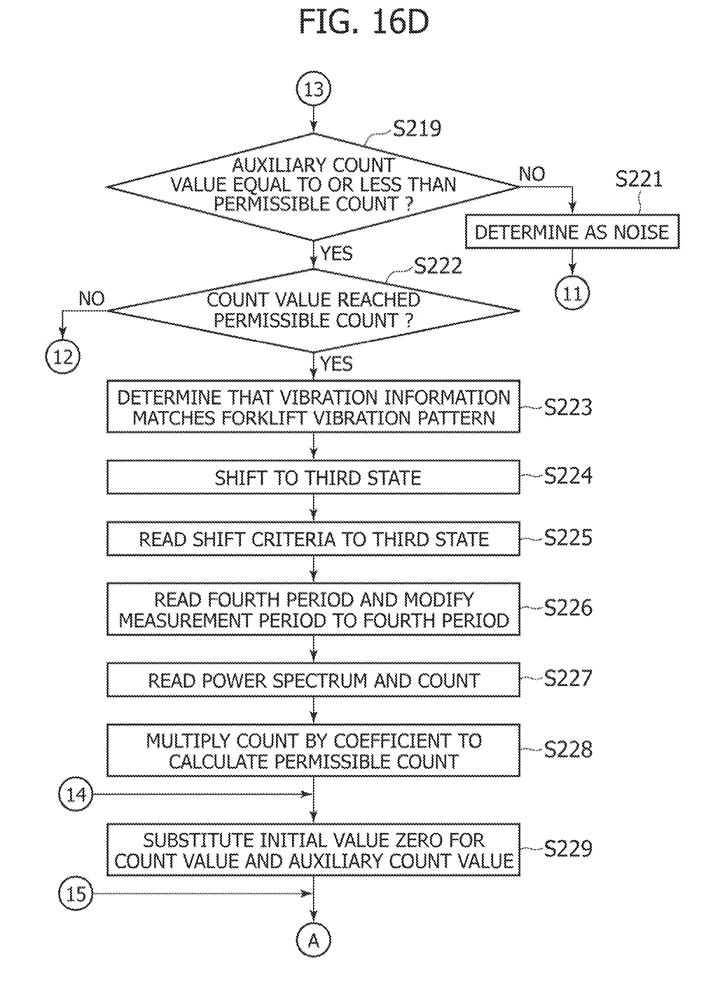

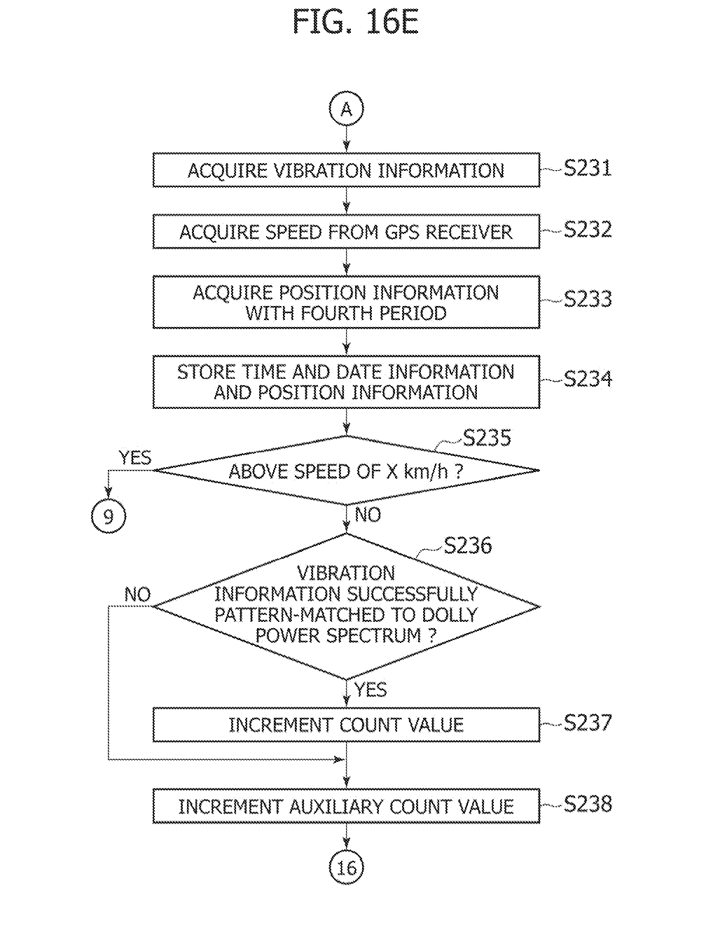

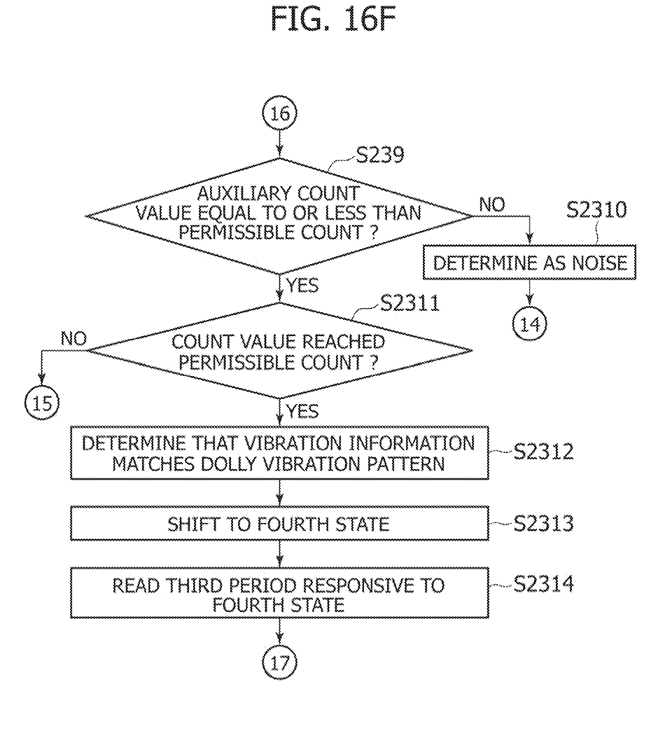

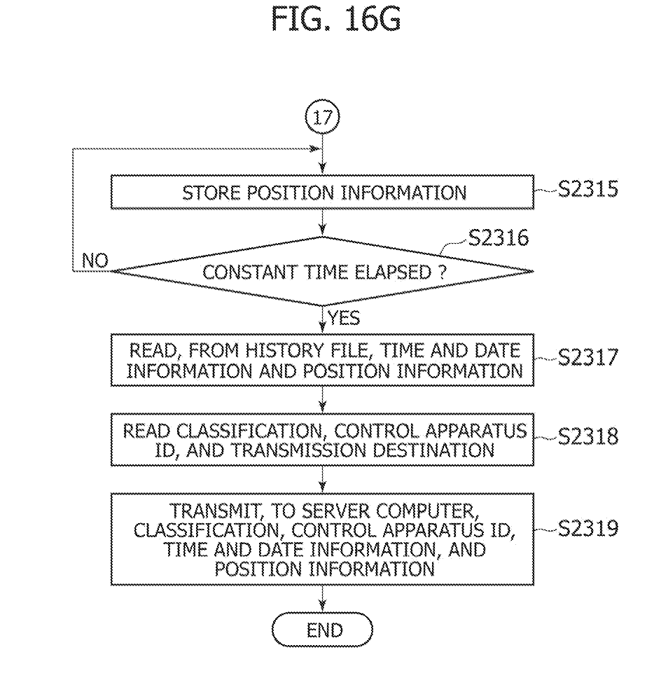

FIGS. 16A-16G are a flowchart of an example of control process. The control apparatus 2 is switched on in response to an instruction entered on the input unit 23 by the user or a setting on the input unit 23 by the user. The power supply 29 starts supplying power from the battery 290 (S191). With power supplied to the control apparatus 2, the control apparatus 2 determines that the state of the control apparatus 2 has shifted into the initial state. The control apparatus 2 reads from the state table 251 the shift criteria corresponding to the initial state as a pre-shift state (S192). The control apparatus 2 reads from the period table 252 the third period as the initial state. The control apparatus 2 sets the third period to the measurement period of position fixing of the GPS receiver 212 (S193). The GPS receiver 212 thereafter fixes position with the third period. Through the interface 213, the control apparatus 2 instructs the position information to be acquired. The control apparatus 2 stores time and date output from the clock 28 and the acquired position information in a mapped state in the history file 254 (S195).

The control apparatus 2 acquires the acceleration from the acceleration sensor 210 and determines the speed by integrating the acceleration (S196). The control apparatus 2 determines whether the acquired speed is above speed of X km/h as the shift criteria of the initial state (S197). If the control apparatus 2 determines that the acquired speed is not above a speed of X km/h (no from S197), processing returns to S196. The above-described process is repeated.

If it is determined that the acquired speed is above a speed of X km/h (yes from S197), the control apparatus 2 determines that the state of the control apparatus 2 has shifted from the initial state to the first state, and reads from the state table 251 the shift criteria corresponding to the first state as a pre-shift state (S198). The shift criteria to the first state is “equal to or below speed of X km/h.” The control apparatus 2 reads from the period table 252 the first period of the first state, and modifies the measurement period of position fixing of the GPS receiver 212 to the first period (S199). The GPS receiver 212 thereafter fixes position with the first period. The control apparatus 2 instructs the position information to be acquired with the first period, and stores in the history file 254 the acquired position information with time and date output from the clock 28 mapped thereto (S202). The control apparatus 2 acquires the acceleration from the acceleration sensor 210, and determines the speed resulting from the acceleration (S203).

The control apparatus 2 determines whether the acquired speed is equal to or below speed of X km/h as the shift criteria to the first state (S204). If the control apparatus 2 determines that the acquired speed is above a speed of X km/h as the shift criteria to the first state (no from S204), processing returns to S203. If the control apparatus 2 determines that the acquired speed is equal to or below speed of X km/h as the shift criteria to the first state (yes from S204), the control apparatus 2 determines that there is a possibility that the machine tool 3 is close to the destination. Processing proceeds to S205. The control apparatus 2 determines that the state of the control apparatus 2 has shifted from the first state to the second state and then reads from the state table 251 the shift criteria corresponding to the second state as a pre-shift state (S205). As illustrated in FIG. 13, the shift criteria of the second state is “above X km/h” or “forklift vibration pattern match.”

The control apparatus 2 reads the second period of the second state from the period table 252, and modifies the measurement period of position fixing of the GPS receiver 212 to the second period (S206). The control apparatus 2 reads from the pattern file 253 a power spectrum and a count, serving as a template (S207). In this case, the control apparatus 2 reads the power spectrum and the count of the classification forklift corresponding to the “forklift vibration pattern match” as the shift criteria to the second state. The control apparatus 2 multiplies the count by a coefficient stored on the storage 25 to calculate a permissible count (S208).

The control apparatus 2 substitutes an initial value zero for a count value and an auxiliary count value, which are integer variables (S209). The control apparatus 2 acquires the vibration information from the acceleration sensor 210 (S211). Since the measurement period of position fixing of the GPS receiver 212 becomes shorter, the control apparatus 2 switches the speed acquisition source from the acceleration sensor 210 to the GPS receiver 212. The control apparatus 2 calculates a distance per unit time from the position information acquired with the period obtained via the interface 213 and then calculates the speed. The control apparatus 2 thus acquires the speed from the GPS receiver 212 (S212).

The control apparatus 2 acquires the position information with the second period from the GPS receiver 212 (S213). The control apparatus 2 stores time and date output from the clock 28 and the position information in the history file 254 (S214). The control apparatus 2 determines whether the acquired speed is above speed of X km/h (S215). If the control apparatus 2 determines that the acquired speed is above speed of X km/h (yes from S215), the control apparatus 2 also determines that the machine tool 3 has temporarily reduced the speed thereof and is not yet close to the destination. Processing returns to S198. Position fixing is performed again with the first period.

If the control apparatus 2 determines that the acquired speed is not above speed of X km/h (no from S215), the control apparatus 2 also determines whether the vibration information acquired in S211 has successfully matched the power spectrum read in S207 (S216). If the control apparatus 2 determines that the pattern matching has been successfully completed (yes from S216), the control apparatus 2 increments the count value (S217). If the control apparatus 2 determines that the pattern matching has not been successfully completed (no from S216), operation S217 is skipped. The control apparatus 2 increments the auxiliary count value (S218).

The control apparatus 2 determines whether the auxiliary count value is equal to or below the permissible count calculated in S208 (S219). Upon determining that the auxiliary count value is equal to or below the permissible count (yes from S219), the control apparatus 2 determines whether the count value has reached the count read in S207 (S222). Upon determining that the count value has yet to reach the count (no from S222), the control apparatus 2 returns to S211 to repeat the pattern-matching operation. Upon determining that the auxiliary count value is above the permissible count (no from S219), the control apparatus 2 determines that the vibration information is noise (S221). Processing returns to S209. The control apparatus 2 substitutes an initial value zero for the count value and the auxiliary count value, and repeats the above-described process.

If the control apparatus 2 determines that the count value has reached the count (yes from S222), the control apparatus 2 determines that the vibration information matches the vibration pattern of the forklift (S223). The control apparatus 2 references the state table 251, and then determines that the state of the control apparatus 2 has shifted into the third state (S224). The control apparatus 2 reads from the state table 251 the shift criteria corresponding to the third state as a pre-shift state (S225). As illustrated in FIG. 13, the shift criteria is either “above speed of X km/h” or “dolly vibration pattern match.”

The control apparatus 2 reads the fourth period of the third state from the period table 252, and modifies the measurement period of position fixing of the GPS receiver 212 to the fourth period (S226). The control apparatus 2 reads from the pattern file 253 a power spectrum and a count, serving as a template (S227). The control apparatus 2 multiplies the count by a coefficient stored on the storage 25 to calculate a permissible count (S228). The coefficient in S228 may be different from the coefficient in S208.

The control apparatus 2 substitutes an initial value zero for a count value and an auxiliary count value, which are integer variables (S229). The control apparatus 2 acquires the vibration information from the acceleration sensor 210 (S231). The control apparatus 2 acquires the speed from the GPS receiver 212 (S232).

The control apparatus 2 acquires the position information with the fourth period from the GPS receiver 212 (S233). The control apparatus 2 stores time and date output from the clock 28 and the position information in the history file 254 (S234). The control apparatus 2 determines whether the acquired speed is above speed of X km/h (S235). If the control apparatus 2 determines that the acquired speed is above speed of X km/h (yes from S235), the control apparatus 2 also determines that the machine tool 3 has temporarily reduced the speed thereof and is not yet close to the destination. Processing returns to S198. Position fixing is performed again with the first period.

If the control apparatus 2 determines that the acquired speed is not above speed of X km/h (no from S235), the control apparatus 2 also determines whether the vibration information acquired in S231 has successfully matched the power spectrum of the dolly 4 read in S227 (S236). If the control apparatus 2 determines that the pattern matching has been successfully completed (yes from S236), the control apparatus 2 increments the count value (S237). If the control apparatus 2 determines that the pattern matching has not been successfully completed (no from S236), operation S237 is skipped. The control apparatus 2 increments the auxiliary count value (S238).

The control apparatus 2 determines whether the auxiliary count value is equal to or below the permissible count calculated in S228 (S239). Upon determining that the auxiliary count value is equal to or below the permissible count (yes from S239), the control apparatus 2 determines whether the count value has reached the count read in S227 (S2311). Upon determining that the count value has yet to reach the count (no from S2311), the control apparatus 2 returns to S231 to repeat the pattern-matching operation. Upon determining that the auxiliary count value is above the permissible count (no from S239), the control apparatus 2 determines that the vibration information is noise (S2310). Processing returns to S229. The control apparatus 2 substitutes an initial value zero for the count value and the auxiliary count value, and repeats the above-described process.

If the control apparatus 2 determines that the count value has reached the count (yes from S2311), the control apparatus 2 determines that the vibration information matches the vibration pattern of the dolly 4 (S2312). The control apparatus 2 references the state table 251, and then determines that the state of the control apparatus 2 has shifted from the third state into the fourth state (S2313). The control apparatus 2 reads from the period table 252 the third period corresponding to the fourth state (S2314). The control apparatus 2 outputs to the GPS receiver 212 an instruction to fix position with the third period. The control apparatus 2 stores in the history file 254 the position information acquired with the third period with time and date mapped thereto (S2315).

The control apparatus 2 determines whether a constant period of time has elapsed since the state shifting of the control apparatus 2 to the fourth state (S2316). If it is determined that the constant period of time has not elapsed (no from S2316), processing returns to S2315. Position fixing thus resumes. If the control apparatus 2 determines that the constant period of time has elapsed (yes from S2316), the control apparatus 2 reads from the history file 254 the time and date information and the position information stored after the supplying of power (S2317). The control apparatus 2 reads from the pattern file 253 a plurality of classifications (the forklift and the dolly 4 in the example here), and the control apparatus ID and the transmission destination of the server computer 1 from the storage 25 (S2318).

The control apparatus 2 references the transmission destination, and transmits to the server computer 1 the plurality of classifications, the control apparatus ID, the time and date information and the position information via the communication unit 26, a wireless LAN access point arranged in the plant 6, and the communication network N (S2319). In one embodiment, only last information of the position information in time series may be transmitted. In another embodiment, the time and date information and the position information during last specific period of time (10 minutes) may be transmitted. The position information of a position estimated to be in the vicinity of the destination is acquired at a high accuracy.

The second embodiment has been discussed. The rest of the second embodiment remains unchanged from the first embodiment. Like elements are designated with like reference numerals and the detailed discussion thereof is omitted here.

### Third Embodiment

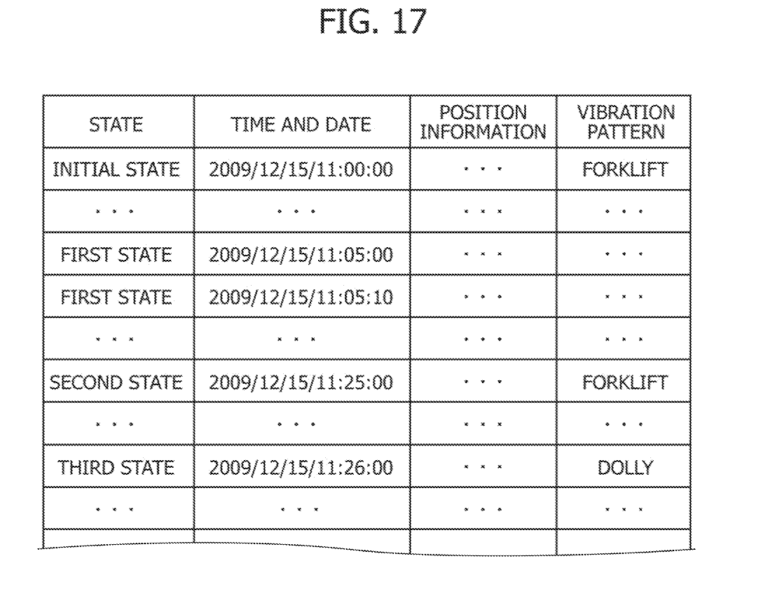

A third embodiment relates to a technique in which a vibration pattern is used in the initial state. The third embodiment is based on the premise that a high possibility that a loading operation and an unloading operation of the machine tool 3 take a similar transport type is used as a shift criteria. FIG. 17 illustrates an example of the record layout of the history file 254. The control apparatus 2 stores in the history file 254 a history of the fixed position information, time and date, state, and vibration pattern. The history file 254 includes state field, time and date field, position information field, and vibration pattern field. The position information field lists, in time series, the position information of positions fixed with the period. The time and date field lists the time and date with the position information mapped thereto. The state field lists the state during position fixing. The vibration pattern field lists the vibration patterns (classification).

The control apparatus 2 stores the position information acquired from the GPS receiver 212, and the time and date output from the clock 28 in the history file 254. The control apparatus 2 stores the vibration pattern matching the vibration information acquired from the acceleration sensor 210. The control apparatus 2 stores the state that satisfies the shift criteria. For example, the control apparatus 2 stores the initial state and the vibration pattern “forklift” together with the position information at 11:00, Dec. 15, 2009 immediately subsequent to the start of the transport. The control apparatus 2 also stores the third state and the vibration pattern “dolly” together with the position information at the end of the transport, at 11:26, Dec. 15, 2009.

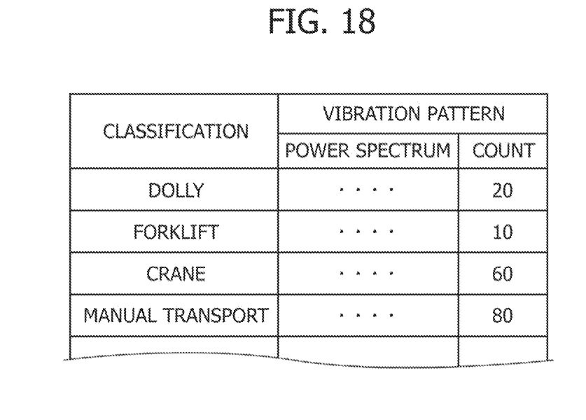

FIG. 18 illustrates a third example of the record layout of the pattern file 253. The pattern file 253 stores vibration patterns of a plurality of classifications. The classification field lists a plurality of types of transport. According to the third embodiment, the control apparatus 2 stores four types (dolly, forklift, crane, and manual transport by human). The classification is listed for exemplary purposes only and is not limited to these four types. The vibration pattern field lists a power spectrum and a count in a mapped state. For example, the classification “forklift” is mapped to data of power spectrum in a specific time (1 second, for example), and a count at which the pattern matching with the power spectrum has been successful. Alternatively, a change in the acceleration with time may be used in place of the power spectrum.

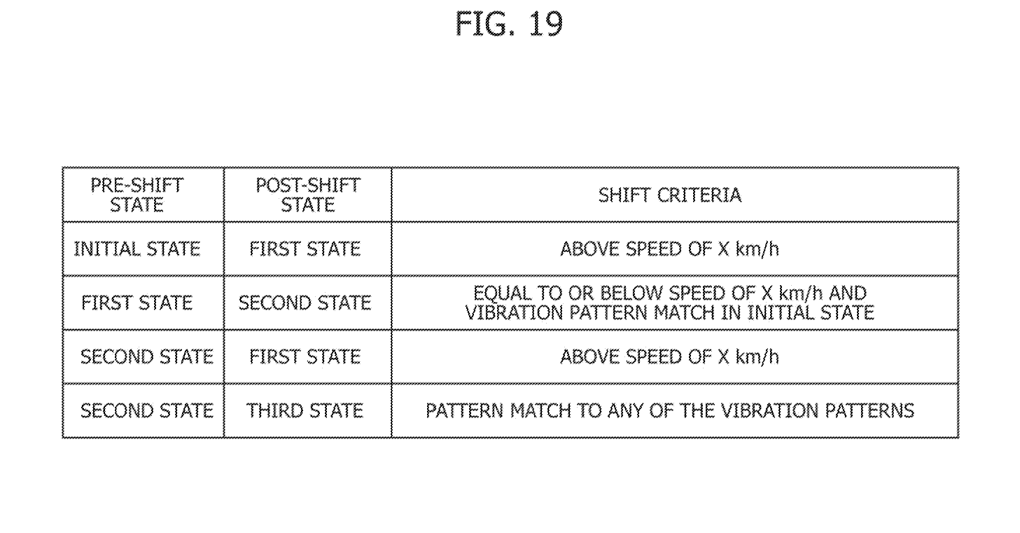

FIG. 19 illustrates a third example of the record layout of the state table 251 of the third embodiment. The shifting to the first state remains unchanged from that in the first embodiment, and the discussion thereof is omitted here. The shift criteria for the determination that the state of the control apparatus 2 has shifted from the first state to the second state is stored as “equal to or below speed of X km/h and vibration pattern match in the initial state.” The control apparatus 2 thus determines that the state of the control apparatus 2 has shifted from the first state to the second state if the acquired speed is equal to or below speed of X km/h and if the vibration pattern of the acquired vibration information has successfully matched the vibration pattern in the initial state. For example, if the control apparatus 2 determines that the vibration pattern in the initial state is that of the forklift and that the vibration pattern in the first state is that of the forklift as illustrated in FIG. 17, the control apparatus 2 determines that the state of the control apparatus 2 has shifted from the first state to the second state. If the vibration pattern in the initial state matches that of the forklift in the pattern file 253 storing a plurality of vibration patterns, the control apparatus 2 determines that the state of the control apparatus 2 has shifted from the first state to the second state. Upon determining that the state of the control apparatus 2 has shifted from the first state to the second state, the control apparatus 2 modifies the measurement period to the second period. The period table 252 of FIG. 5 discussed with reference to the first embodiment is used in the third embodiment.

“Above speed of X km/h” is stored as a shift criterion for the determination that the state of the control apparatus 2 has shifted from the second state to the first state. If a speed above speed of X km/h is acquired again subsequent to a temporary speed reduction that has caused the control apparatus 2 to determine that the state of the control apparatus 2 has shifted from the first state to the second state, the control apparatus 2 determines again that the state of the control apparatus 2 shifts into the first state. “Pattern matching to any vibration pattern” is stored as a shift criterion for the determination that the state of the control apparatus 2 has shifted from the second state to the third state. A first transport type during unloading is likely to be the same as a transport type during loading. Subsequent to the loading operation, a different transport type is likely to be used. If a vibration pattern matches any of the vibration patterns stored in the pattern file 253, the control apparatus 2 determines that the state of the control apparatus 2 has shifted into the third state.

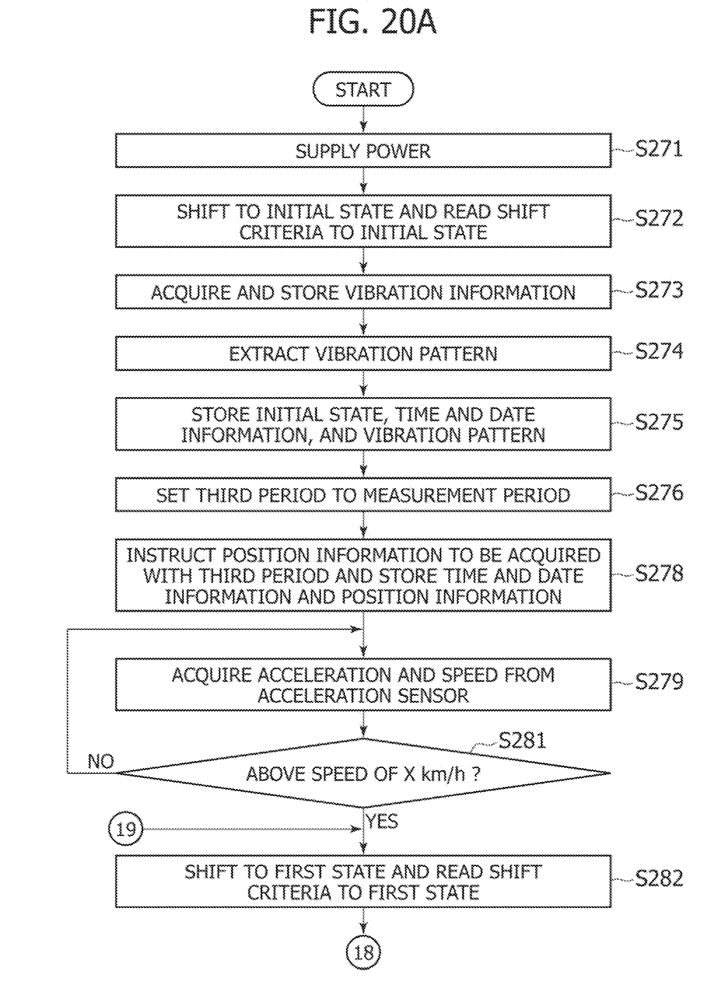

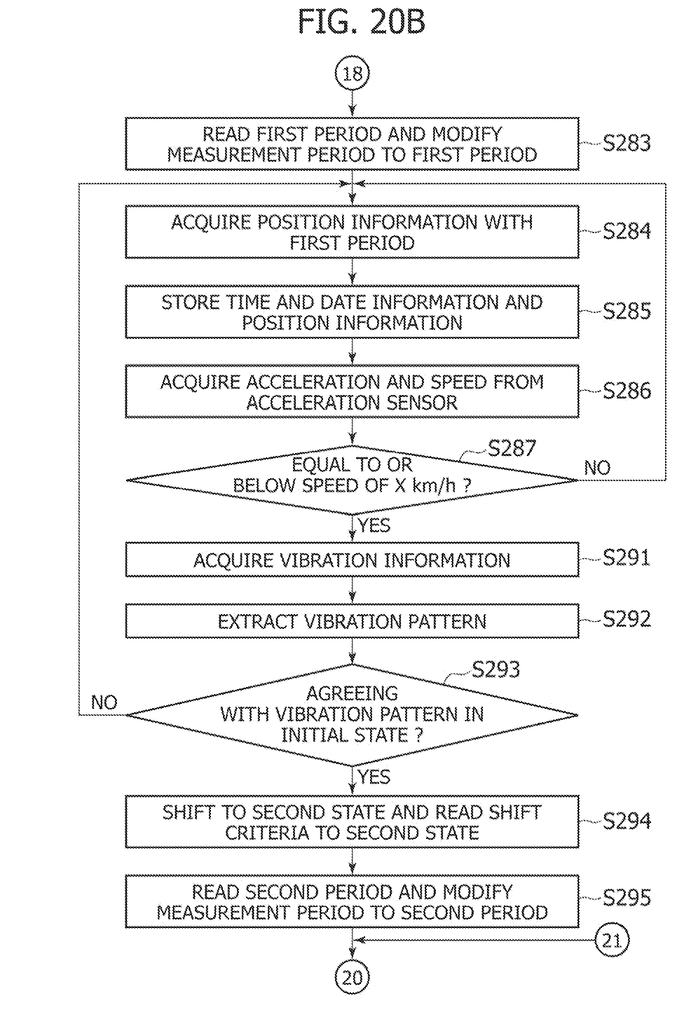

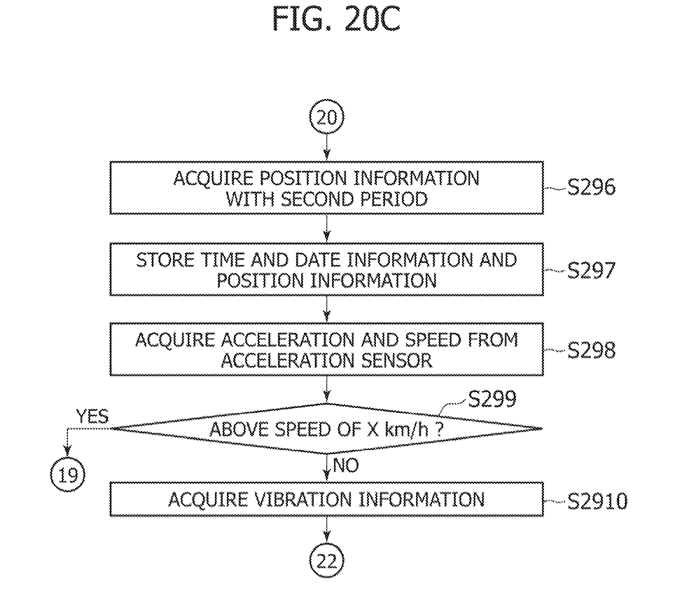

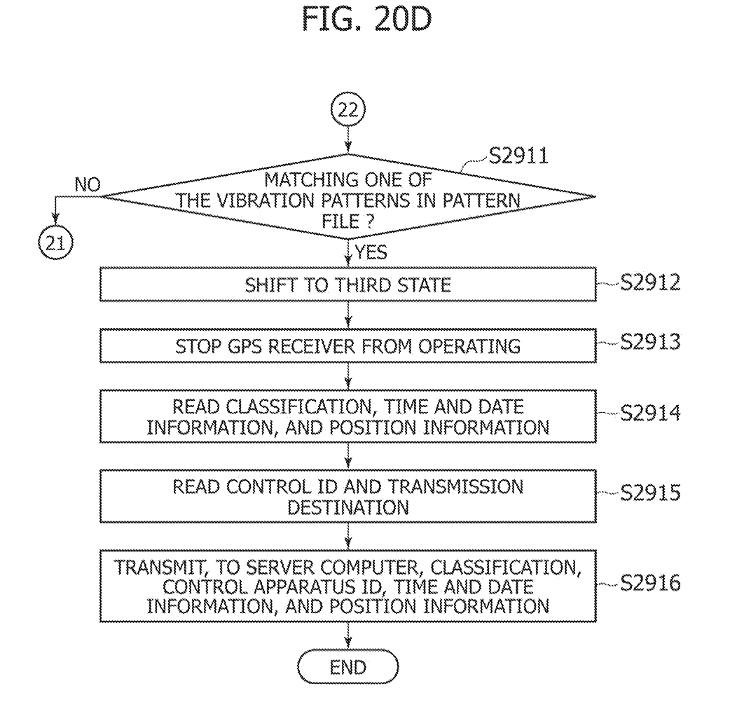

FIGS. 20A-20D are a flowchart of second example of a shift process. The power supply 29 supplies power to the control apparatus 2 (S271). The control apparatus 2 determines that the state of the control apparatus 2 has shifted into the initial state. The control apparatus 2 reads from the state table 251 the shift criteria corresponding to the initial state as a pre-shift state (S272). The control apparatus 2 acquires the vibration information from the acceleration sensor 210 and stores the vibration information on the storage 25 (S273). According to the procedure described with reference to the embodiments, the control apparatus 2 extracts a vibration pattern matching the vibration information stored in S273 from the plurality of vibration patterns stored in the pattern file 253 (S274). The vibration pattern in the initial state during the loading operation is thus determined. The vibration pattern matching operation has been discussed in detail with reference to the above embodiments, and not discussed herein.

The control apparatus 2 stores in the history file 254 the initial state, the time and date output from the clock 28, and the extracted vibration pattern (S275). The control apparatus 2 references the period table 252 and reads the third period of the initial state. The control apparatus 2 sets the third period to the measurement period of position fixing of the GPS receiver 212 (S276). The GPS receiver 212 thereafter fixes position with the third period. The control apparatus 2 stores the time and date information and the acquired position information in a mapped state in the history file 254 (S278).

The control apparatus 2 acquires the speed resulting from the acceleration from the acceleration sensor 210 (S279). The control apparatus 2 determines whether the acquired speed is above speed of X km/h (S281). If the control apparatus 2 determines that the acquired speed is not above a speed of X km/h (no from S281), processing returns to S279. The position information is repeatedly acquired. If it is determined that the acquired speed is above speed of X km/h (yes from S281), the control apparatus 2 determines that the state of the control apparatus 2 has shifted from the initial state to the first state, and reads from the state table 251 the shift criteria corresponding to the first state as a pre-shift state (S282). The shift criterion to the first state is “equal to or below speed of X km/h” and “vibration pattern match in the initial state.”

The control apparatus 2 references the period table 252 and reads the first period of the first state, and modifies the measurement period of position fixing of the GPS receiver 212 to the first period (S283). The GPS receiver 212 fixes position with the first period (S284). The control apparatus 2 stores in the history file 254 the time and date information and the position information (S285). The control apparatus 2 acquires the speed resulting from the acceleration from the acceleration sensor 210 (S286). The control apparatus 2 determines whether the acquired speed is equal to or below speed of X km/h (S287).

If the control apparatus 2 determines that the acquired speed is above speed of X km/h (no from S287), processing returns to S284. Upon determining that the acquired speed is equal to or below speed of X km/h (yes from S287), the control apparatus 2 acquires the vibration information from the acceleration sensor 210 and stores the acquired vibration information onto the storage 25 (S291).

The control apparatus 2 compares the acquired vibration information with the vibration pattern stored in the pattern file 253 to extract a matched vibration pattern (S292). The control apparatus 2 determines whether the vibration pattern extracted in S292 agrees with the vibration pattern in the initial state stored in the history file 254 in S275 (S293). Upon determining that the two vibration patterns agree with each other (yes from S293), the control apparatus 2 determines that the unloading operation has completed and then proceeds to S294. The control apparatus 2 determines that the state of the control apparatus 2 has shifted from the first state to the second state, and reads from the state table 251 the shift criteria for the second state as a pre-shift state (S294). The control apparatus 2 reads from the period table 252 the second period of the second state, and modifies the measurement period of position fixing of the GPS receiver 212 to the second period (S295).

If the control apparatus 2 determines that the two vibration patterns fail to agree with each other (no from S293), or if the corresponding vibration pattern is not extracted in S292, processing returns to S284. Position fixing is thus repeated with the first state. Subsequent to S295, the control apparatus 2 acquires the position information with the second period (S296). The control apparatus 2 stores the time and date information and the position information in the history file 254 (S297). The control apparatus 2 acquires the speed resulting from the acceleration output from the acceleration sensor 210 (S298).

The control apparatus 2 determines whether the acquired speed is above speed of X km/h (S299). If the control apparatus 2 determines that the acquired speed is above speed of X km/h (yes from S299), processing returns to S282. The control apparatus 2 thus determines that the state of the control apparatus 2 has shifted back from the second state to the first state. If the control apparatus 2 determines that the acquired speed is not above speed of X km/h (no from S299), the control apparatus 2 acquires the vibration information from the acceleration sensor 210 (S2910). The control apparatus 2 determines whether the acquired vibration information matches one of the vibration patterns stored in the pattern file 253 (S2911).

If the control apparatus 2 determines that the vibration information fails to match one of the vibration patterns (no from S2911), process returns to S296. In this case, position fixing is repeated with the second period. If the control apparatus 2 determines that the vibration information matches one of the vibration patterns (yes from S2911), the control apparatus 2 determines that the state of the control apparatus 2 has shifted from the second state to the third state (S2912). The control apparatus 2 reads from the period table 252 the period of the third state. According to the third embodiment, “stop” is stored in the period table 252. The control apparatus 2 stops the GPS receiver 212 from operating (S2913).

The control apparatus 2 reads, from one of the history file 254 and the storage 25, the classification (a vibration pattern of the forklift in the example here), the time and date information and the position information within last specific period of time in time series (S2914). The control apparatus 2 reads from the storage 25 the control apparatus ID and the transmission destination of the server computer 1 (S2915). The control apparatus 2 references the transmission destination, and transmits to the server computer 1 via the communication network N the classification, the control apparatus ID, the time and date information and the position information (S2916). The state determination is thus carried out at a high accuracy based on the advantage of a high possibility that the loading operation and the unloading operation of the machine tool 3 are similar to each other in vibration pattern.

The third embodiment has been discussed. The rest of the third embodiment remains unchanged from the first and second embodiments. Like elements are designated with like reference numerals, and the detailed discussion thereof is omitted here.

### Fourth Embodiment

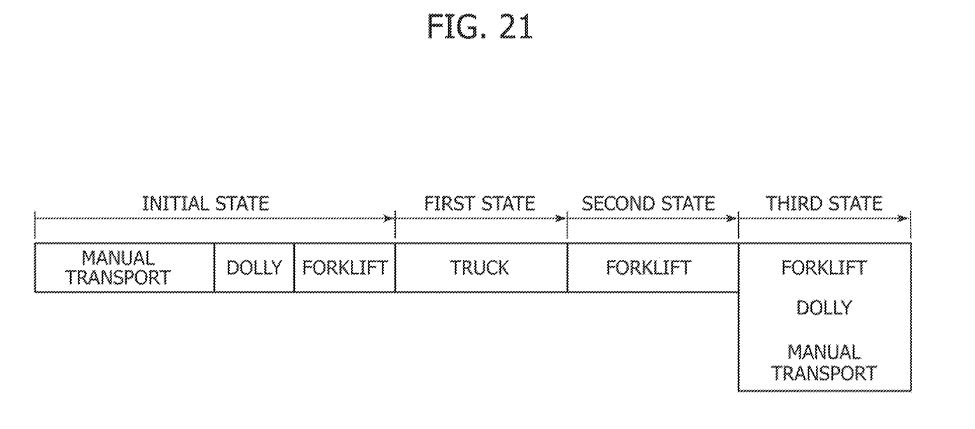

A fourth embodiment relates to a technique in which a plurality of vibration patterns are used in the loading operation. FIG. 21 illustrates an example of a state shift related to the fourth embodiment. A plurality of transport types may be used to transport the machine tool 3 in the initial state. Referring to FIG. 21, the machine tool 3 is loaded on the truck 5 through manual transport by humans, the dolly 4 and the forklift. The control apparatus 2 extracts the vibration patterns of manual transport, dolly, and forklift from the vibration information output from the acceleration sensor 210. When the truck 5 runs, the control apparatus 2 determines that the state of the control apparatus 2 has shifted from the initial state to the first state. The control apparatus 2 sorts the vibration patterns in the initial state in terms of the time series order.

In this transport example, the machine tool 3 is transported by using the manual transport, the dolly, and the forklift in that order. In the first state, the control apparatus 2 extracts the vibration pattern matching the vibration information. If the travel speed is equal to or below speed of X km/h, and if last vibration pattern in the initial state in time series agrees with the vibration pattern in the first state, the control apparatus 2 determines that the state of the control apparatus 2 has shifted from the first state to the second state. If the forklift is detected at last time series in the fourth embodiment, the control apparatus 2 determines that the state of the control apparatus 2 has shifted from the first state to the second state. Even if the vibration information in the first state matches another vibration pattern of the initial state (manual transport and dolly), the control apparatus 2 does not determine that the state of the control apparatus 2 has shifted from the first state to the second state. If the vibration information in the second state matches one of the vibration patterns of the manual transport, the dolly, and the forklift stored in the initial state, the control apparatus 2 determines that the state of the control apparatus 2 has shifted from the second state to the third state. Even if the vibration information matches another vibration pattern stored in the pattern file 253 (such as of a crane), the vibration information still does not match the vibration pattern in the initial state. The control apparatus 2 does not determine that the state of the control apparatus 2 has shifted from the second state to the third state.

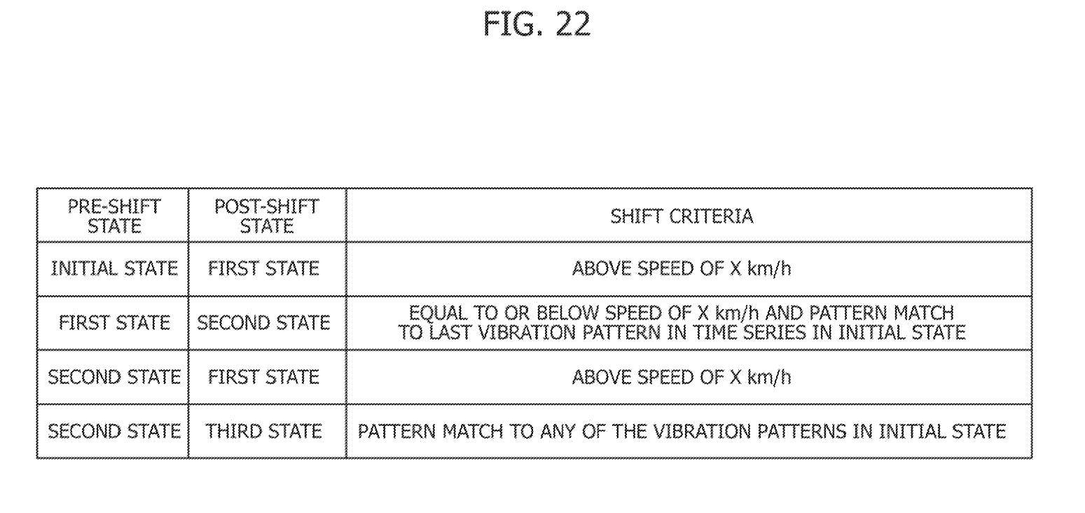

FIG. 22 is an example of the record layout of the state table 251. The shift criteria for the determination that the state of the control apparatus 2 has shifted from the first state to the second state is stored as “equal to or below speed of X km/h and pattern match to the last vibration pattern in time series in the initial state.” Pattern match to any of the vibration patterns in the initial state” is stored as the shift criteria for the determination that the state of the control apparatus 2 has shifted from the second state to the third state. The rest of the state table 251 remains unchanged from the state table 251 of the third embodiment, and the detailed discussion is omitted here.

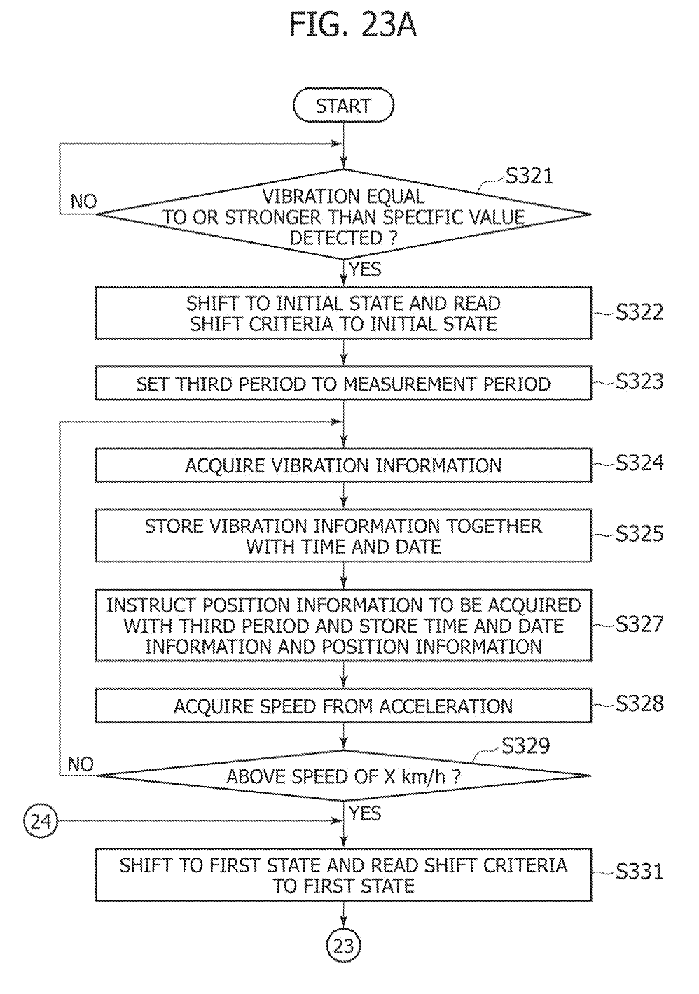

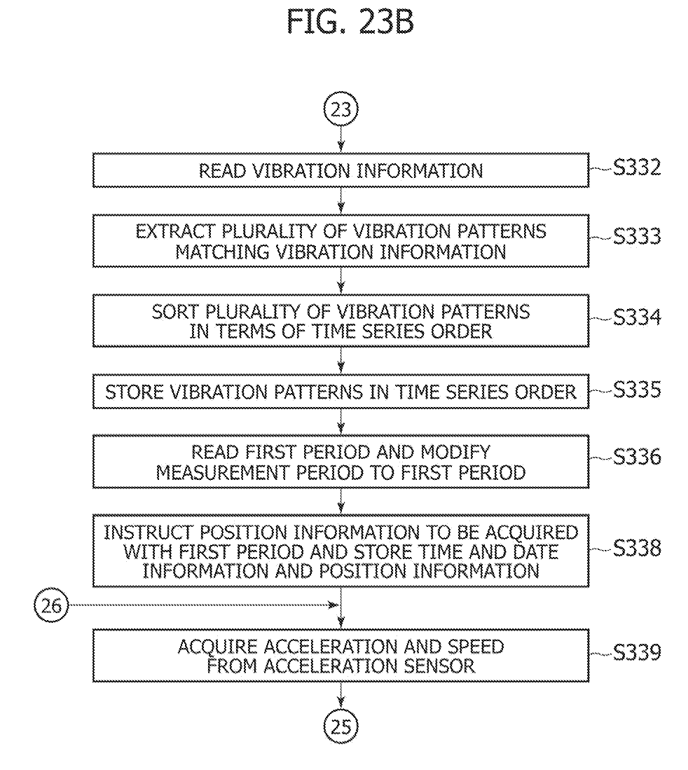

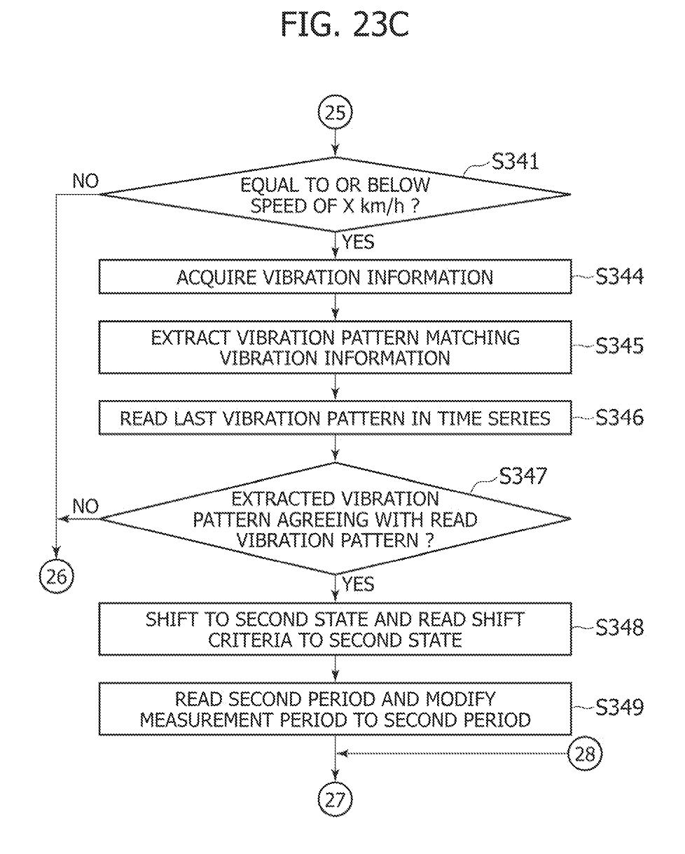

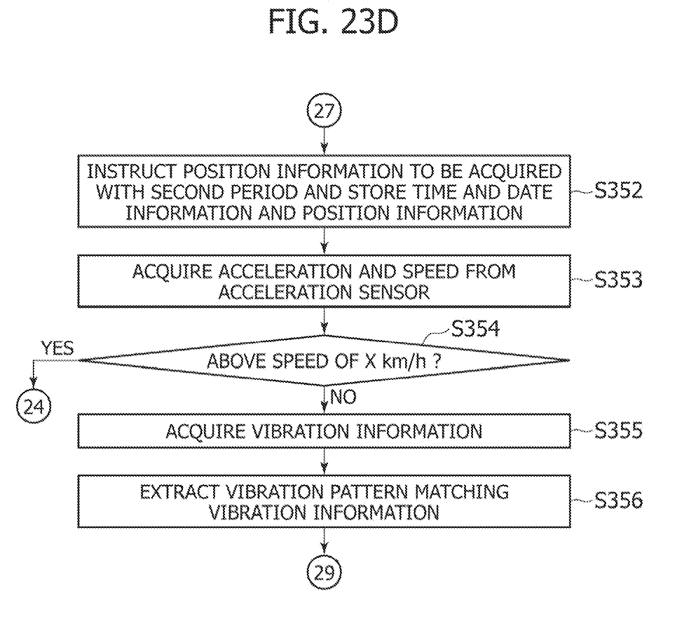

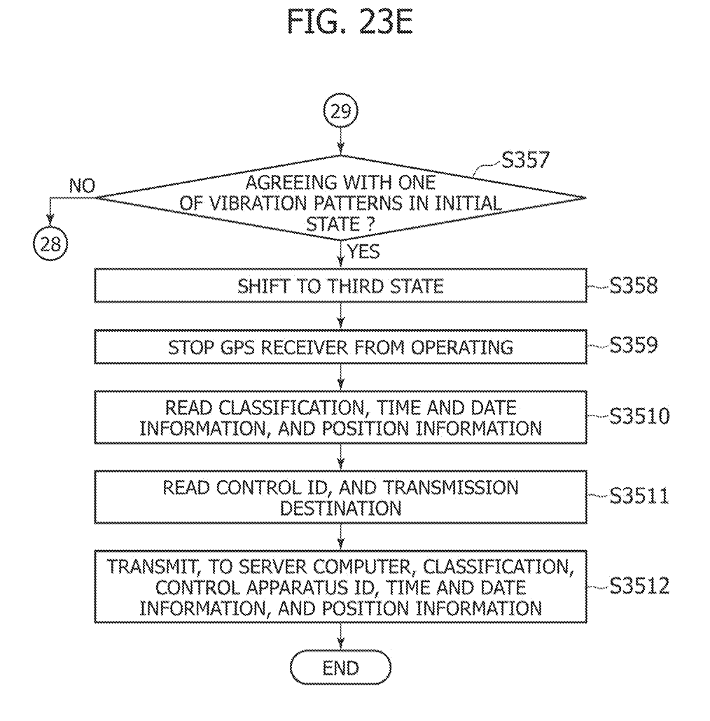

FIGS. 23A-23E are a flowchart illustrating third example of a shift process. According to the above embodiments, the control apparatus 2 determines in response to power supplying that the state of the control apparatus 2 has shifted into the initial state. The determination of the control apparatus 2 may be initiated not only by power supplying but also by another trigger. For example, upon detecting an impact stronger than a specific value, the control apparatus 2 may determine that the state of the control apparatus 2 has shifted into the initial state. The control apparatus 2 reads a threshold value of impact detection. The threshold value may be stored as a specific acceleration or a specific power spectral value. The control apparatus 2 acquires the acceleration output from the acceleration sensor 210. Based on the acquired acceleration and threshold value, the control apparatus 2 then determines whether a vibration stronger than a specific value has been detected (S321).

If a vibration stronger than a specific value has not been detected (no from S321), the control apparatus 2 repeats S321. If a vibration stronger than a specific value has been detected (yes from S321), the control apparatus 2 determines that the state of the control apparatus 2 has shifted into the initial state. The control apparatus 2 reads from the state table 251 the shift criteria corresponding to the initial state as a pre-shift state (S322). The control apparatus 2 references the period table 252 and reads the third period of the initial state. The control apparatus 2 sets the third period to the measurement period of position fixing of the GPS receiver 212 (S323). The control apparatus 2 acquires the vibration information from the acceleration sensor 210 (S324). The control apparatus 2 stores on the storage 25 the vibration information together with the time and date information output from the clock 28 (S325). The control apparatus 2 fixes position with the third period, and successively stores the position information with the time date mapped thereto in the history file 254 (S327).

The control apparatus 2 acquires the speed resulting from the acceleration from the acceleration sensor 210 (S328). The control apparatus 2 determines whether the acquired speed is above speed of X km/h (S329). If the control apparatus 2 determines that the acquired speed is not above a speed of X km/h (no from S329), processing returns to S324. The above-described process is repeated. If it is determined that the acquired speed is above a speed of X km/h (yes from S329), the control apparatus 2 determines that the state of the control apparatus 2 has shifted from the initial state to the first state, and reads the shift criteria corresponding to the first state as a pre-shift state (S331).

The control apparatus 2 reads the vibration information in the initial state stored in S324 (S332). The control apparatus 2 extracts a plurality of vibration patterns matching the vibration information in accordance with the vibration information and the vibration patterns in the pattern file 253 (S333). The control apparatus 2 references the time and date stored together with the vibration information and sorts the plurality of extracted vibration patterns in the time series order (S334). The control apparatus 2 stores the vibration patterns in the time series order (S325). Operations S332-S335 may be carried out prior to operation S329.

The control apparatus 2 references the period table 252 to read the first period of the first state, and modifies the measurement period of position fixing of the GPS receiver 212 to the first period (S336). The control apparatus 2 instructs the position information to be acquired with the first period and stores the time and date information and the position information in the history file 254 (S338). The control apparatus 2 acquires the speed resulting from the acceleration output from the acceleration sensor 210 (S339). The control apparatus 2 determines whether the acquired speed is equal to or below speed of X km/h (S341).

If the control apparatus 2 determines that the acquired speed is above speed of X km/h (no from S341), the control apparatus 2 proceeds to S339 to repeat operation S339 and subsequent operations.

If the control apparatus 2 determines that the acquired speed is equal to or below speed of X km/h (yes from S341), the control apparatus 2 acquires the vibration information from the acceleration sensor 210 (S344). The control apparatus 2 compares the acquired vibration information with the vibration pattern stored in the pattern file 253 and then extracts a matched vibration pattern (S345). The control apparatus 2 reads last vibration pattern in time series stored on the storage 25 (S346). The control apparatus 2 determines whether the last vibration pattern read agrees with the vibration pattern extracted in S345 (S347). Upon determining that the two patterns agree with each other (yes from S347), the control apparatus 2 determines that the unloading operation of the same transport type as that at the end of the loading operation has started, and then proceeds to S348. The control apparatus 2 then determines that the state of the control apparatus 2 has shifted from the first state to the second state and reads from the state table 251 the shift criteria for the second state as a pre-shift state (S348). The control apparatus 2 reads the second period of the second state from the period table 252 and modifies the measurement period of position fixing of the GPS receiver 212 to the second period (S349).

If the control apparatus 2 determines that the two patterns fail to agree with each other (no from S347), or if the corresponding vibration pattern has not been extracted from the pattern file 253 in S345, processing returns to S339. Subsequent to S349, the control apparatus 2 instructs the position information to be acquired with the second period and stores the time and date information and the position information in the history file 254 (S352). The control apparatus 2 acquires the speed resulting from the acceleration output from the acceleration sensor 210 (S353).

The control apparatus 2 determines whether the acquired speed is above speed of X km/h (S354). Upon determining that the acquired speed is above speed of X km/h (yes from S354), the control apparatus 2 returns S331. Upon determining that the acquired speed is not above speed of X km/h (no from S354), the control apparatus 2 acquires the vibration information from the acceleration sensor 210 (S355). In response to the acquired vibration information, the control apparatus 2 extracts one of the vibration patterns stored in the pattern file 253 (S356).

The control apparatus 2 reads the vibration pattern in the initial state stored on the storage 25. The control apparatus 2 determines whether the read vibration pattern in the initial state agrees with the vibration pattern extracted in S356 (S357). If the control apparatus 2 determines that the two vibration patterns fail to agree with each other (no from S357), or if it is determined in S356 that no vibration pattern matching the vibration information is present, the control apparatus 2 returns to S352. Position fixing is thus repeated with the second period. If the control apparatus 2 determines that the two vibration patterns agree with each other (yes from S357), the control apparatus 2 determines that the state of the control apparatus 2 has shifted from the second state to the third state (S358). The control apparatus 2 reads the period of the second state from the period table 252. According to the fourth embodiment, “stop” is stored in the period table 252. The control apparatus 2 stops the GPS receiver 212 from operating (S359).

The control apparatus 2 reads, from one of the history file 254 and the storage 25, the classification (a vibration pattern of the forklift in the example here), the time and date information and the position information within last specific period of time in time series (S3510). The control apparatus 2 reads from the storage 25 the control apparatus ID and the transmission destination of the server computer 1 (S3511). The control apparatus 2 references the transmission destination, and transmits to the server computer 1 via the communication network N the classification, the control apparatus ID, the time and date information and the position information (S3512). The state determination is thus carried out at a high accuracy base on the advantage of a high possibility that the vibration pattern at the end of the loading operation agrees with the vibration pattern at the start of the unloading operation of the machine tool 3. The state determination is carried out at a high accuracy by using any of the vibration patterns in the loading operation as the shift criteria from the second state to the third state.

The fourth embodiment has been discussed. The rest of the fourth embodiment remains unchanged from the first through third embodiments. Like elements are designated with like reference numerals, and the detailed discussion thereof is omitted here.

### Fifth Embodiment

A fifth embodiment relates to a technique in which different shift criteria to the first state are used. The acquired speed is used as the shift criteria from the initial state to the first state, the shift criteria from the first state to the second state, or the shift criteria from the second state to the first state in the preceding embodiments. Shift criteria free from the speed may be used. In the fifth embodiment, the acquired speed is used as a supplemental factor.

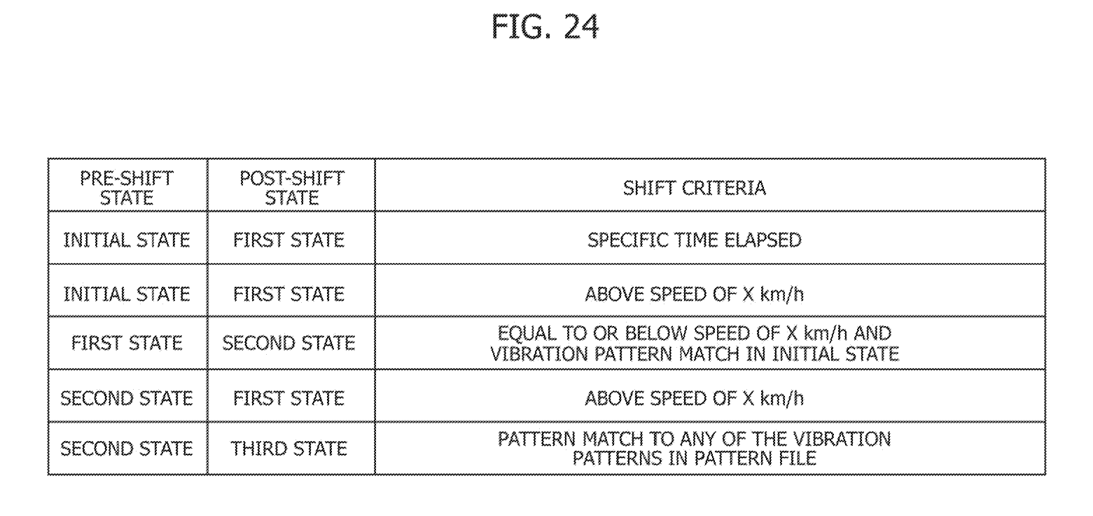

FIG. 24 illustrates a fifth example of the record layout of the state table 251. The shifting to the first state remains unchanged from that in the first embodiment, and the discussion thereof is omitted here. Stored as the shift criteria from the initial state to the first state is “specific time elapsed” or “above speed of X km/h.” The specific time elapse from a specific event may be the shift criteria from the initial state to the first state as described below. If a specific time has elapsed since operation information indicating a transport start was received from the input unit 23 or if a specific time has elapsed since power supplying by the power supply 29, the control apparatus 2 determines that the state of the control apparatus 2 is in the first state. Alternatively, the control apparatus 2 may determine that the state of the control apparatus 2 is in the first state if a specific time has elapsed since an acceleration or an angular speed, stronger than a specific value, was received from the acceleration sensor 210 or the angular speed sensor 211. The specific time may be 30 minutes, for example, and the user may input the specific time using the input unit 23. The control apparatus 2 may store the input specific time on the storage 25.

Based on the vibration information output from one of the acceleration sensor 210 and the angular speed sensor 211 and the pattern file 253, the control apparatus 2 may determine that the state of the control apparatus 2 is in the first state after a specific time from the detection of the vibration pattern of the dolly 4 or the forklift. Accessing to an wireless LAN access point used by the communication unit 26 may be difficult, or the communication unit 26 may start communications with a different wireless LAN access point. In such a case, the control apparatus 2 may determine that the state of the control apparatus 2 has shifted from the initial state to the first state. If the communication unit 26 changes the cellular phone basestation from one basestation to another, the control apparatus 2 may determine that the state of the control apparatus 2 has shifted from the initial state to the first state.

The control apparatus 2 stores the position information output from the GPS receiver 212 as an initial position on the storage 25. If the position information is changed, the control apparatus 2 calculates a distance based on the stored position information at the initial position and newly acquired position information. If a calculated travel distance is longer than a specific distance (5 km or longer, for example), the control apparatus 2 determines that the state of the control apparatus 2 has shifted from the initial state to the first state. A variety of shift criteria to shift from the initial state to the first state is present. The above-described criteria may be used alone or in combination. If the above-described criteria are used in combination, they may be AND gated or OR gated. For example, 20 minutes has elapsed since an acceleration of a specific value or stronger was acquired from the acceleration sensor 210 and if a wireless LAN access point, used by the communication unit 26 when the acceleration of the specific value was acquired from the acceleration sensor 210, becomes unusable, the control apparatus 2 determines that the state of the control apparatus 2 has shifted from the initial state to the first state. According to the fourth embodiment, for simplicity of explanation, if a specific time period has elapsed since power supplying, the control apparatus 2 determines that the state of the control apparatus 2 has shifted from the initial state to the first state.

Stored as the shift criteria for the state shifting of the control apparatus 2 from the first state to the second state is “equal to or below speed of X km/h and pattern match to the vibration pattern in the initial state.” According to the fifth embodiment, the transport classification type in the initial state is “forklift.” Stored as the shift criteria from the second state to the third state is “vibration pattern match to any of the vibration patterns in the pattern file 253.” If the vibration information acquired subsequent to the shifting to the second state matches one of the vibration patterns stored in the pattern file 253, the control apparatus 2 determines that the state of the control apparatus 2 has shifted from the second state to the third state.

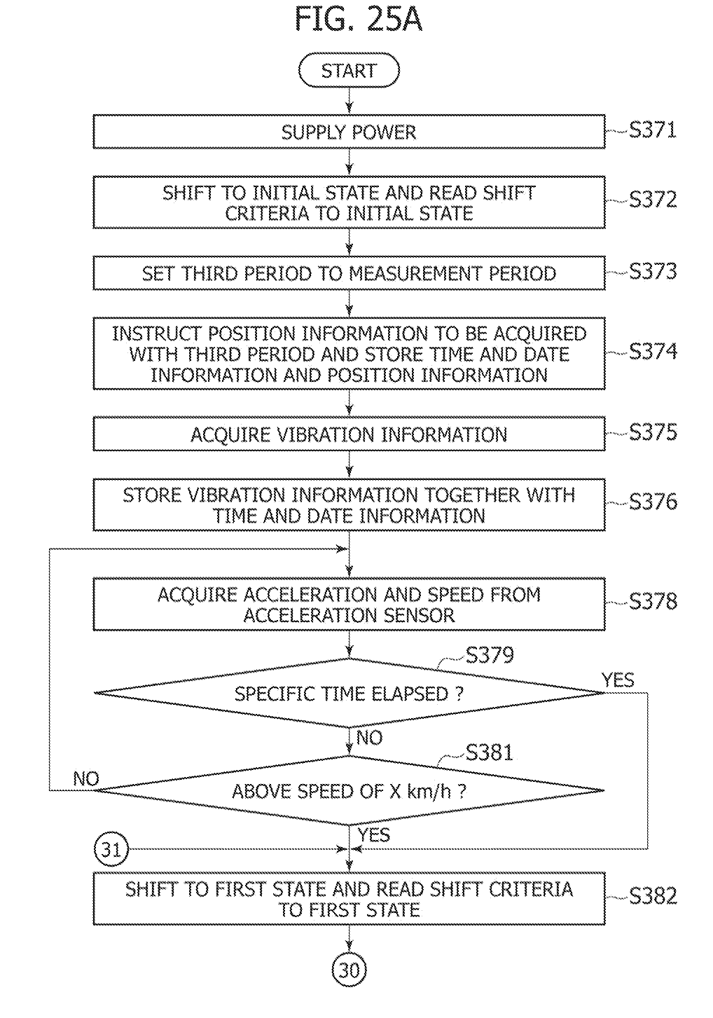

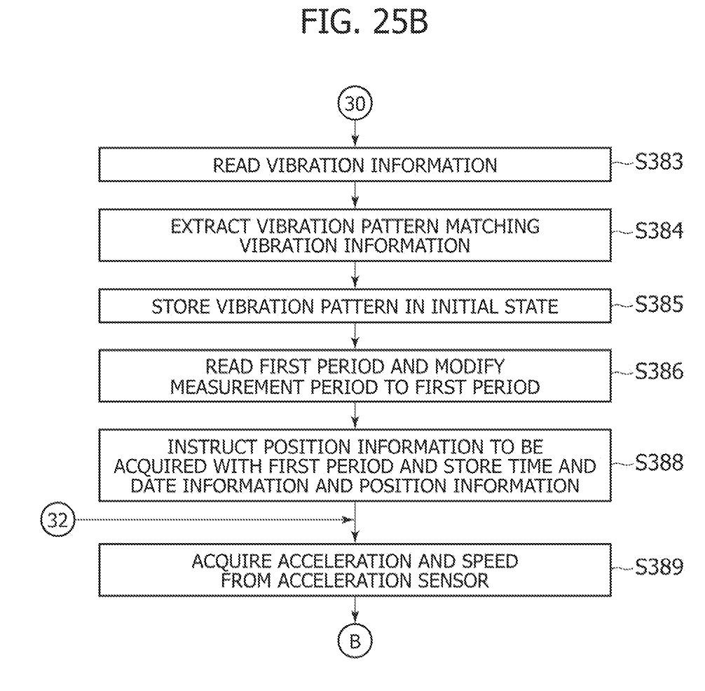

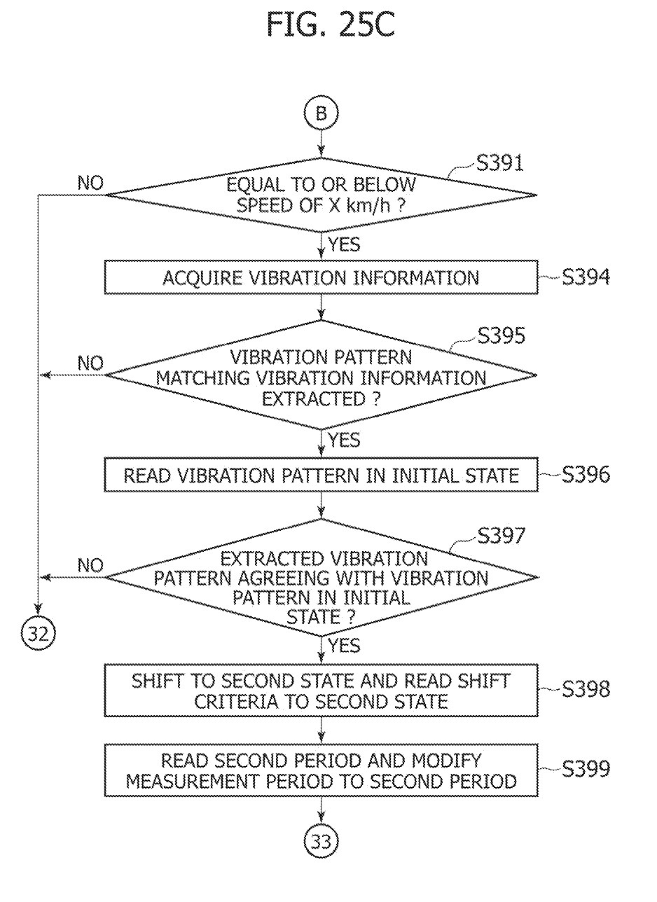

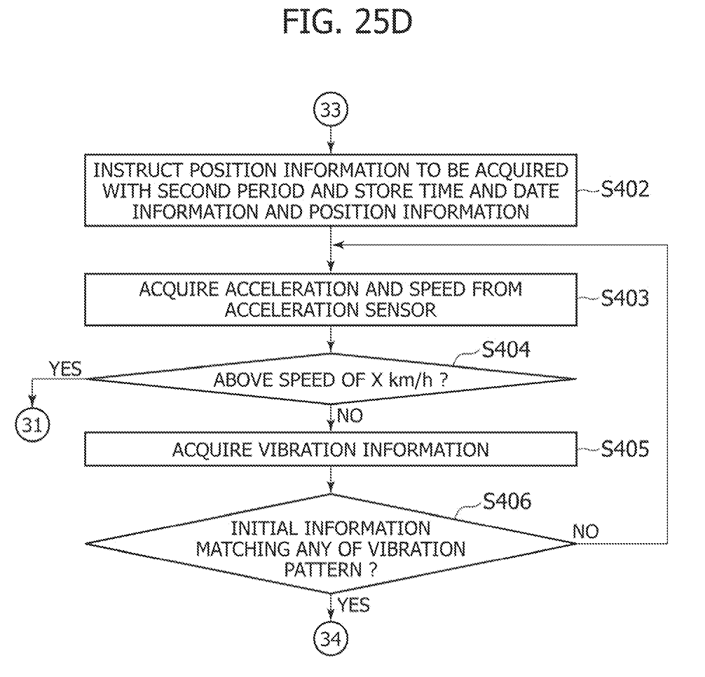

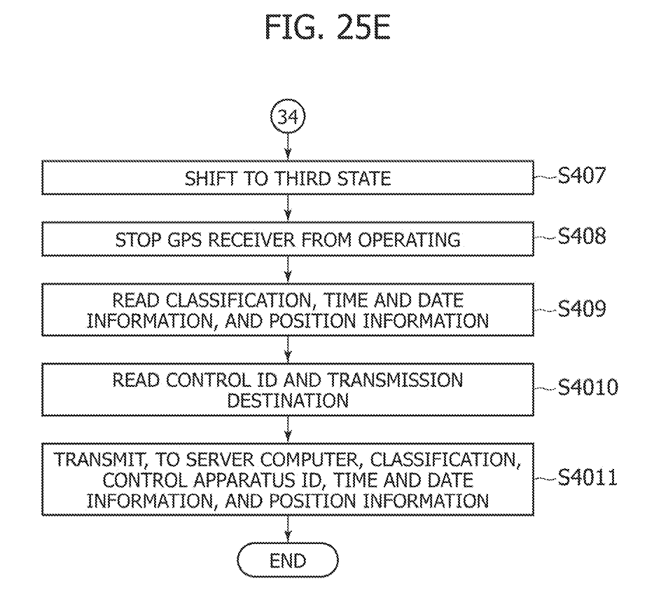

FIGS. 25A-25E is a flowchart illustrating fourth example of a shift process. The power supply 29 starts supplying power from the battery 290 (S371). The clock 28 in the control apparatus 2 starts clocking. The control apparatus 2 determines that the state of the control apparatus 2 has shifted into the initial state. The control apparatus 2 reads from the state table 251 the shift criteria corresponding to the initial state as a pre-shift state (S372). The control apparatus 2 references the period table 252 and reads the third period of the initial state, and sets the third period to the measurement period of position fixing of the GPS receiver 212 (S373). The control apparatus 2 instructs the position information to be acquired with the third period. The control apparatus 2 successively stores the position information with the time and date information mapped thereto in the history file 254 (S374). The control apparatus 2 acquires the vibration information from the acceleration sensor 210 (S375). The control apparatus 2 stores on the storage 25 the vibration information together with the time and date information output from the clock 28 (S376).

The control apparatus 2 acquires the speed resulting from the acceleration from the acceleration sensor 210 (S378). The control apparatus 2 determines whether a specific time has elapsed since the start of power supplying (S379). If the control apparatus 2 determines whether a specific time has not elapsed since the start of power supplying (no from S379), the control apparatus 2 determines whether the acquired speed is above speed of X km/h (S381). If the control apparatus 2 determines that the acquired speed is not above a speed of X km/h (no from S381), processing returns to S378 to repeat S378 and subsequent operations. The above-described process is repeated. If the control apparatus 2 determines that the acquired speed is above a speed of X km/h (yes from S381), the control apparatus 2 determines that the state of the control apparatus 2 has shifted from the initial state to the first state. The control apparatus 2 then reads from the state table 251 the shift criteria to the first state as a pre-shift state (S382).

The control apparatus 2 reads the vibration information in the initial state stored in S374 (S383). The control apparatus 2 extracts a vibration pattern matching the vibration information in accordance with the vibration information and the vibration patterns in the pattern file 253 (S384). The control apparatus 2 stores the extracted vibration pattern on the storage 25 (S385).

The control apparatus 2 references the period table 252 to read the first period of the first state, and modifies the measurement period of position fixing of the GPS receiver 212 to the first period (S386). The control apparatus 2 instructs the position information to be acquired with the first period and stores the time and date information and the position information in the history file 254 (S388). The control apparatus 2 acquires the speed resulting from the acceleration output from the acceleration sensor 210 (S389). The control apparatus 2 determines whether the acquired speed is equal to or below speed of X km/h (S391).

If the acquired speed is equal to or below speed of X km/h (yes from S391), the control apparatus 2 acquires the vibration information from the acceleration sensor 210 (S394). If it is determined in S391 that the acquired speed is above speed of X km/h (no from S391), the control apparatus 2 returns to S389.

The control apparatus 2 compares the vibration information acquired in S394 with the vibration pattern stored in the pattern file 253 to determine whether a matched vibration pattern is extracted (S395). If no matched pattern is extracted (no in S395), processing returns to S389. If a matched vibration pattern is extracted (yes from S395), the control apparatus 2 reads the vibration pattern in the initial state stored in S395 (S396). The control apparatus 2 determines whether the vibration pattern in the initial state agrees with the extracted vibration pattern (S397).

If the control apparatus 2 determines that the two vibration patterns agrees with each other (yes from S397), the control apparatus 2 determines that the unloading operation of the same transport type as that at the end of the loading operation has started, and then proceeds to S398. The control apparatus 2 determines that the state of the control apparatus 2 has shifted from the first state to the second state, and reads from the state table 251 the shift criteria to the second state as a pre-shift state (S398). The control apparatus 2 modifies the measurement period of position fixing of the GPS receiver 212 to the second period (S399).

If the control apparatus 2 determines that the two vibration patterns fail to agree with each other (no from S397), processing returns to S389. Subsequent to S399, the control apparatus 2 instructs the position information to be acquired with the second period and stores the time and date information and the position information in the history file 254 (S402). The control apparatus 2 acquires the speed resulting from the acceleration output from the acceleration sensor 210 (S403).

The control apparatus 2 determines whether the acquired speed is above speed of X km/h (S404). Upon determining that the acquired speed is above speed of X km/h (yes from S404), the control apparatus 2 returns S382. Upon determining that the acquired speed is not above speed of X km/h (no from S404), the control apparatus 2 acquires the vibration information from the acceleration sensor 210 (S405). The control apparatus 2 determines whether the acquired vibration information matches one of the vibration patterns stored in the pattern file 253 (S406).

If the vibration information fails to match one of the vibration patterns (no from S406), the control apparatus 2 returns to S403. If the control apparatus 2 determines the vibration information matches one of the vibration patterns (yes from S406), the control apparatus 2 determines that the state of the control apparatus 2 has shifted from the second state to the third state (S407). The control apparatus 2 reads the period of the third state from the period table 252. According to the fifth embodiment, “stop” is stored in the period table 252. The control apparatus 2 stops the GPS receiver 212 from operating (S408). The control apparatus 2 may modify the measurement period of position fixing to the third period equal to or longer than the first period.

The control apparatus 2 reads, from one of the history file 254 and the storage 25, the classification (a vibration pattern of the forklift in the example here), the time and date information and the position information in the initial state (S409). The control apparatus 2 reads from the storage 25 the control apparatus ID and the transmission destination of the server computer 1 (S4010). The control apparatus 2 references the transmission destination, and transmits to the server computer 1 via the communication network N the classification, the control apparatus ID, the time and date information and the position information (S4011). As described above, the process related to the speed (S381, S391, and S404, for example) is not necessarily performed. The state is determined at a high accuracy base on the advantage that the transport type common is to the loading operation and the unloading operation.

The fifth embodiment has been discussed. The rest of the fifth embodiment remains unchanged from the first through fourth embodiments. Like elements are designated with like reference numerals, and the detailed discussion thereof is omitted here.

### Sixth Embodiment

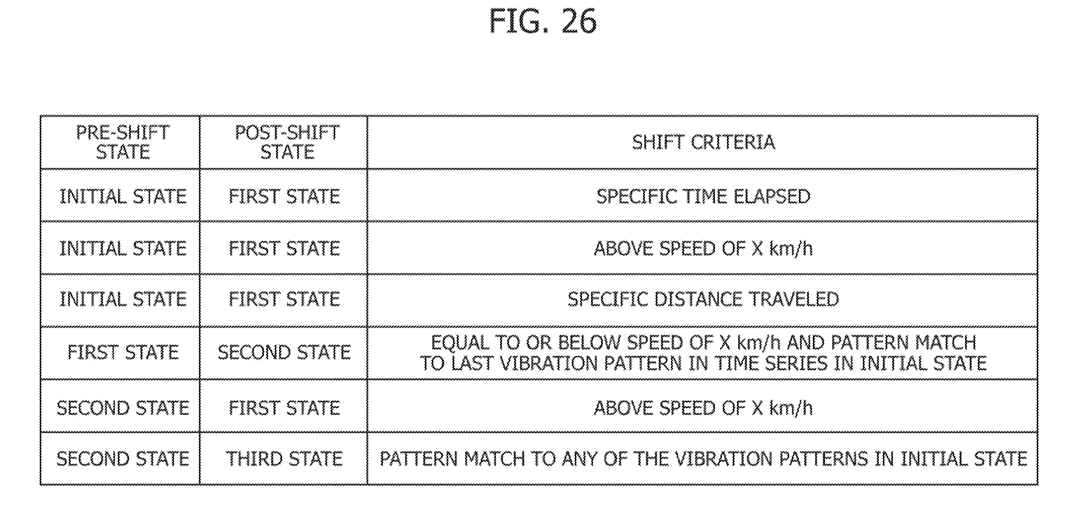

A sixth embodiment relates to a technique in which the shift criteria from the initial state to the first state is different. FIG. 26 illustrates a sixth example of the record layout of the state table 251. Stored as the shift criteria from the initial state to the first state is “specific distance traveled.” If at least one of the three criteria from the initial state to the first state is satisfied, the control apparatus 2 determines that the state of the control apparatus 2 has shifted from the initial state to the first state. According to the sixth embodiment, one of the three criteria, if satisfied, causes the control apparatus 2 to determine that the state of the control apparatus 2 has shifted from the initial state to the first state. Such an operation example is described below. Stored as a shift criteria from the first state to the second state is “equal to or below speed of X km/h and pattern match to last vibration pattern in time series in the initial state.” Stored as another shift criterion from the second state to the third state is “pattern match to any of the vibration patterns in the initial state.”

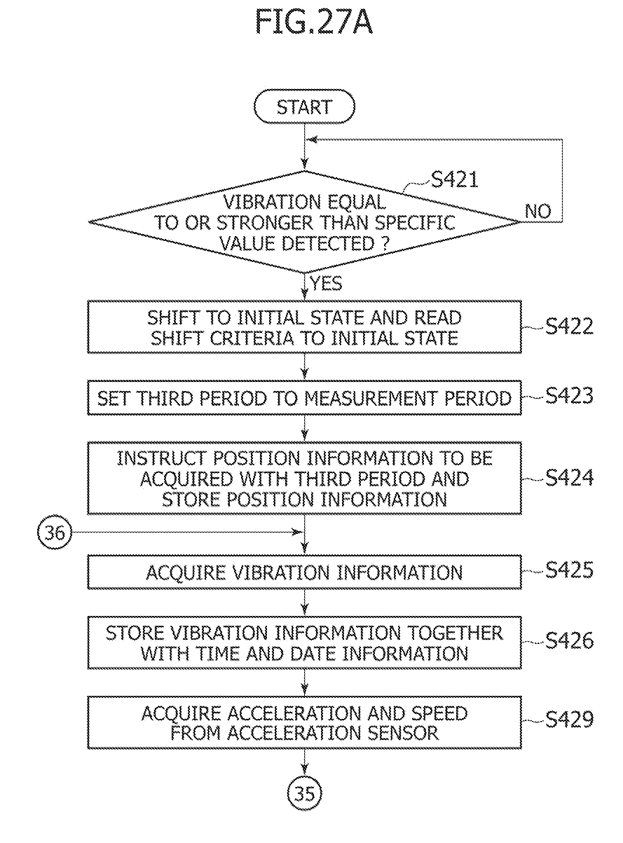

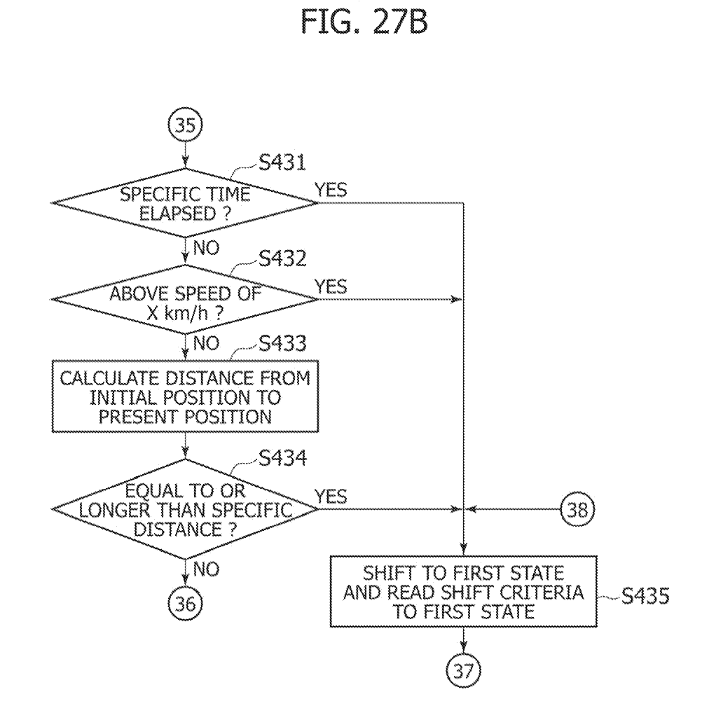

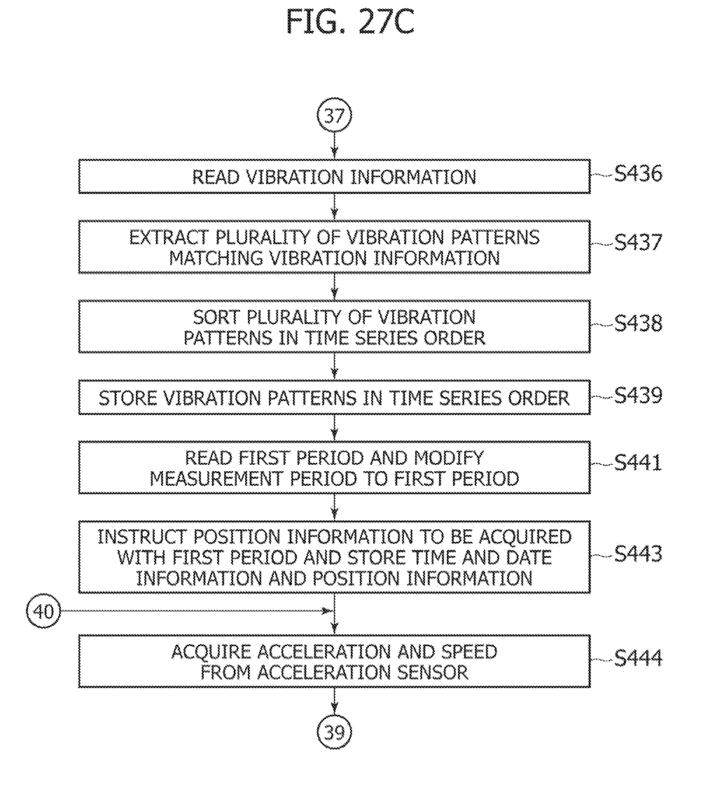

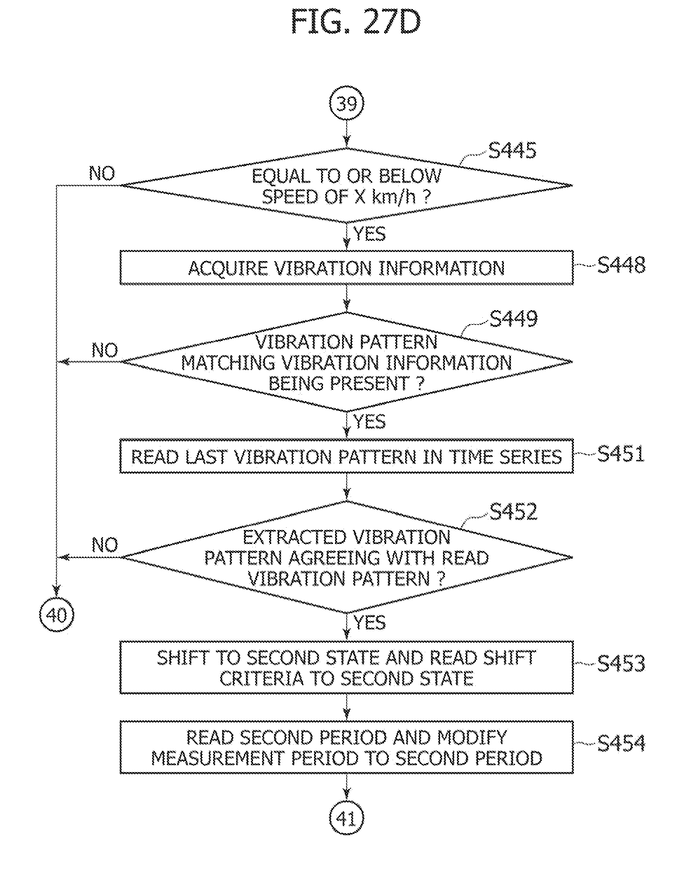

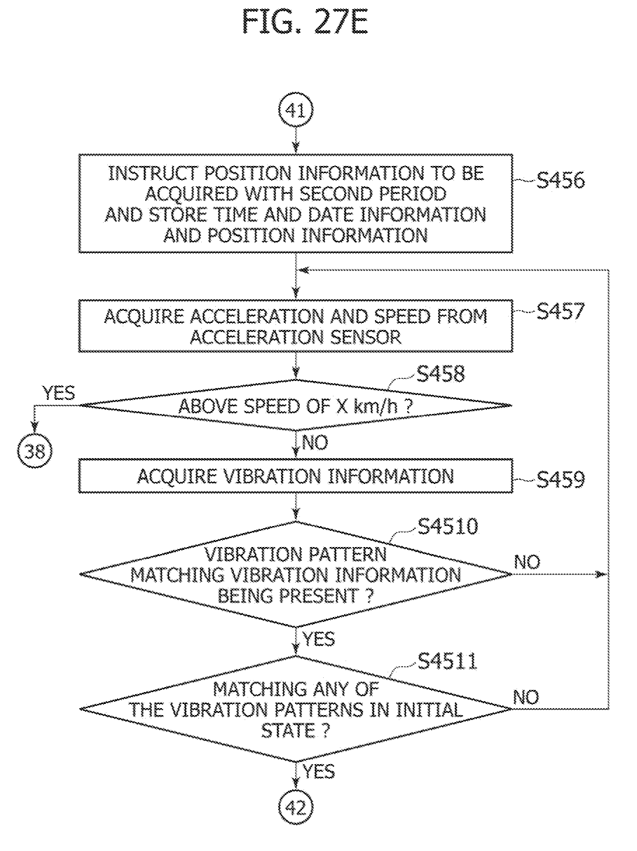

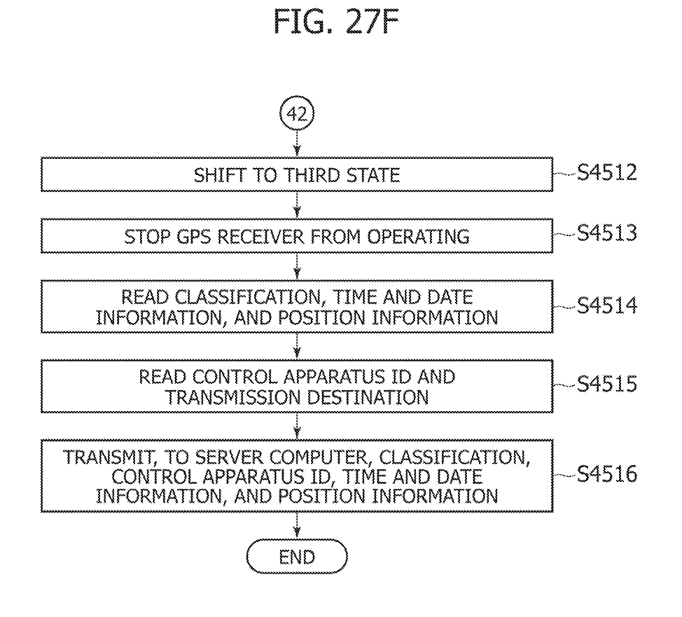

FIGS. 27A-27F are a flowchart illustrating fifth example of a shift process. The control apparatus 2 reads a threshold value of impact detection from the storage 25. The control apparatus 2 acquires an acceleration from the acceleration sensor 210 or an angular speed from the angular speed sensor 211. Based on the acquired acceleration or angular speed, and the threshold value, the control apparatus 2 determines whether a vibration having a specific value or stronger has been detected (S421).

If the control apparatus 2 determines that a vibration having a specific value or stronger has not been detected (no from S421), the control apparatus 2 repeats step S421. If a vibration having a specific value or stronger has been detected (yes from S421), the control apparatus 2 determines that the state of the control apparatus 2 has shifted into the initial state. The control apparatus 2 reads from the state table 251 the shift criteria to the initial state as a pre-shift state (S422). The clock 28 in the control apparatus 2 starts clocking. The control apparatus 2 reads from the period table 252 the third period of the initial state, and sets the third period to the measurement period of position fixing of the GPS receiver 212 (S423). The control apparatus 2 instructs the position information to be acquired with the third period. The control apparatus 2 stores the position information output from the GPS receiver 212 as initial position information on the storage 25 (S424). The control apparatus 2 then successively stores in the history file 254 the position information with the time and date information mapped thereto with the period different from the period with which the vibration information is acquired from the acceleration sensor 210. The control apparatus 2 acquires the vibration information from the acceleration sensor 210 (S425). The control apparatus 2 stores on the storage 25 the vibration information together with the time and date output from the clock 28 (S426).

The control apparatus 2 acquires the speed resulting from the acceleration output from the acceleration sensor 210 (S429). The control apparatus 2 determines whether a specific time has elapsed since the detection of the vibration in S421 (S431). If the control apparatus 2 determines that the specific time has not elapsed (no from S431), the control apparatus 2 determines whether the acquired speed is above speed of X km/h (S432). If the control apparatus 2 determines that the acquired speed is not above speed of X km/h (no from S432), processing proceeds to S433. The control apparatus 2 references the latest position information acquired and recorded every third period from the GPS receiver 212, and then sets the latest position information as a present position. The control apparatus 2 calculates a distance between the initial position stored in S424 and the present position (S433). The control apparatus 2 reads a specific distance serving as a threshold value from the storage 25.

The control apparatus 2 determines whether the calculated distance is equal to or longer than the specific distance (S434). If the control apparatus 2 determines that the calculated distance is equal to or longer than the specific distance (yes from S434), the control apparatus 2 determines that the state of the control apparatus 2 has shifted from the initial state to the first state. The control apparatus 2 reads from the state table 251 the shift criteria to the first state as a pre-shift state (S435). If the control apparatus 2 determines that the specific time has elapsed since the detection of the vibration in S421 (yes from S431), or if the control apparatus 2 determines that the acquired speed is above speed of X km/h (yes from S432), processing proceeds to S435. If the control apparatus 2 determines that the calculated distance is shorter than the specific distance (no from S434), processing returns to S425. The specific distance may be input by the user or the manufacturer using the input unit 23 and may be 100 m, for example.

The control apparatus 2 acquires the vibration information in the initial state stored in S424 (S436). The control apparatus 2 extracts a plurality of vibration patterns matching the vibration information in accordance with the vibration information and the vibration patterns in the pattern file 253 (S437). If one vibration pattern only is extracted, processing returns to S385. The control apparatus 2 references the time and date stored together with the vibration information and sorts the plurality of extracted vibration patterns in the time series order (S438). The control apparatus 2 stores the vibration patterns in the time series order on the storage 25 (S439). In one embodiment, operations S436-S439 may be carried out prior to operation S431.

The control apparatus 2 references the period table 252 to read the first period of the first state, and modifies the measurement period of position fixing of the GPS receiver 212 to the first period (S441). The control apparatus 2 instructs the position information to be acquired with the first period and stores the time and date information and the position information in the history file 254 (S443). The control apparatus 2 acquires the speed resulting from the acceleration output from the acceleration sensor 210 (S444). The control apparatus 2 determines whether the acquired speed is equal to or below speed of X km/h (S445).

If the control apparatus 2 determines that the acquired speed is equal to or below speed of X km/h (yes from S445), the control apparatus 2 acquires the vibration information from the acceleration sensor 210 (S448). If the control apparatus 2 determines that the acquired speed is above speed of X km/h (no from S445), processing returns to S444.

The control apparatus 2 compares the acquired vibration information with the vibration patterns stored in the pattern file 253 to determine whether a matched vibration pattern is present (S449). If the control apparatus 2 determines that no matched vibration pattern is present (no from S449), processing returns to S444. If the control apparatus 2 determines that a matched vibration pattern is present (yes from S449), the control apparatus 2 reads last vibration pattern in time series from among the vibration patterns stored in S439 (S451). The control apparatus 2 determines whether the last vibration pattern read agrees with the vibration pattern matched in S449 (S452). Upon determining that the two patterns agree with each other (yes from S452), the control apparatus 2 determines that the unloading operation of the same transport type as that at the end of the loading operation has started, and then proceeds to S453. The control apparatus 2 then determines that the state of the control apparatus 2 has shifted from the first state to the second state and reads from the state table 251 the shift criteria for the second state as a pre-shift state (S453). The control apparatus 2 reads the second period of the second state from the period table 252 and modifies the measurement period of position fixing of the GPS receiver 212 to the second period (S454).

Upon determining that the two patterns fail to agree with each other (no from S452), processing returns to S444. Subsequent to S454, the control apparatus 2 instructs the position information to be acquired with the second period and stores the time and date information and the position information in the history file 254 (S456). The control apparatus 2 acquires the speed resulting from the acceleration output from the acceleration sensor 210 (S457).

The control apparatus 2 determines whether the acquired speed is above speed of X km/h (S458). Upon determining that the acquired speed is above speed of X km/h (yes from S458), the control apparatus 2 returns S435. Upon determining that the acquired speed is not above speed of X km/h (no from S458), the control apparatus 2 acquires the vibration information from the acceleration sensor 210 (S459). The control apparatus 2 compares the acquired vibration information with the vibration patterns stored in the pattern file 253 to determine whether a matched vibration pattern is present (S4510).

If the control apparatus 2 determines that no matched vibration pattern is present (no from S4510), processing returns to S457. If the control apparatus 2 determines that a matched vibration pattern is present (yes from S4510), processing proceeds to S4511. The control apparatus 2 reads a plurality of vibration patterns in the initial state stored on the storage 25. The control apparatus 2 determines whether the vibration pattern matched in S4510 agrees with any of the read vibration patterns in the initial state (S4511). If the control apparatus 2 determines that none of the vibration patterns agrees with the matched vibration pattern (no from S4511), processing returns to S457. If the control apparatus 2 determines that one of the vibration patterns agrees with the matched vibration pattern (yes from S4511), the control apparatus 2 determines that the state of the control apparatus 2 has shifted from the second state to the third state (S4512). The control apparatus 2 reads the period of the third state from the period table 252. According to the sixth embodiment, “stop” is stored in the period table 252. The control apparatus 2 stops the GPS receiver 212 from operating (S4513).

The control apparatus 2 reads, from one of the history file 254 and the storage 25, the classification, the time and date information and the position information within last specific period of time in time series (S4514). The control apparatus 2 reads from the storage 25 the control apparatus ID and the transmission destination of the server computer 1 (S4515). The control apparatus 2 references the transmission destination, and transmits to the server computer 1 via the communication network N the classification, the control apparatus ID, the time and date information and the position information (S4516). The state shifting is thus appropriately carried out by setting the plurality of shift criteria from the initial state to the first state.

The sixth embodiment has been discussed. The rest of the six embodiment remains unchanged from the first through fifth embodiments. Like elements are designated with like reference numerals, and the detailed discussion thereof is omitted here.

### Seventh Embodiment

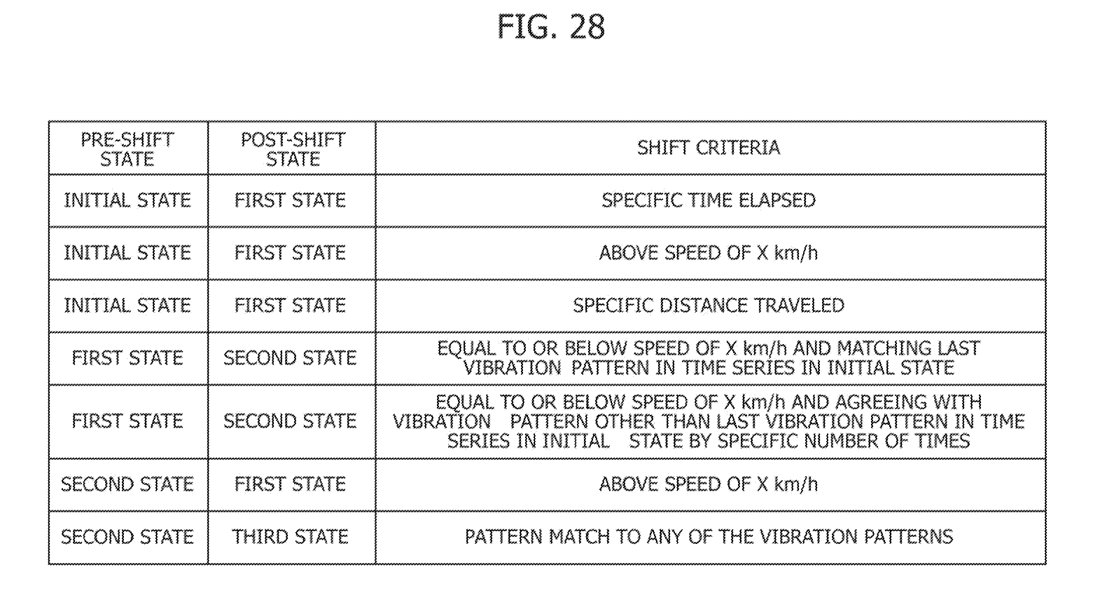

A seventh embodiment relates to a technique in which in response to a vibration pattern different from the vibration pattern sorted last in time series, the control apparatus 2 determines under a given criteria that the state of the control apparatus 2 has shifted from the first state to the second state. FIG. 28 illustrates a seventh example of the record layout of the state table 251 of the seventh embodiment. Stored as the shift criteria from the first state to the second state is “equal to or below speed of X km/h and agreeing with a vibration pattern other than last vibration pattern in time series in initial state by a specific number of times.” The transport type used during the loading operation might be different from the transport type during the unloading operation. The control apparatus 2 determines that the state of the control apparatus 2 has shifted from the first state to the second state on condition that the vibration pattern agrees by the specific number of times at speed of X km/h or below. The state table 251 has been discussed as exemplary purposes only with reference to each of the embodiments, and the state table is not limited to the state table 251. For example, the shift criteria from the first state to the second state may be equal to or below speed of X km/h or agreeing a vibration pattern other than last vibration pattern in time series in initial state by a specific number of times.”

The specific number of times as a criterion is three times, for example. The user or manufacturer may enter an appropriate number of times using the input unit 23. Specific time may be entered in place of the specific number of times. For example, if 1 cycle of vibration pattern recognition of a crane takes 20 seconds (one-second power spectrum by 20 times), 3 cycles take 60 seconds. The control apparatus 2 may pre-store an equation converting the time into the number of times. In response to the input time, the control apparatus 2 converts the input time into the number of times. Stored in the pattern file 253 as the shift criteria from the second state to the third state is “pattern match to any vibration pattern stored in the pattern file 253.” If the vibration information acquired with the state of the control apparatus 2 being the second state matches any of the vibration patterns stored in the pattern file 253, the control apparatus 2 determines that the state of the control apparatus 2 has shifted from the second state to the third state.

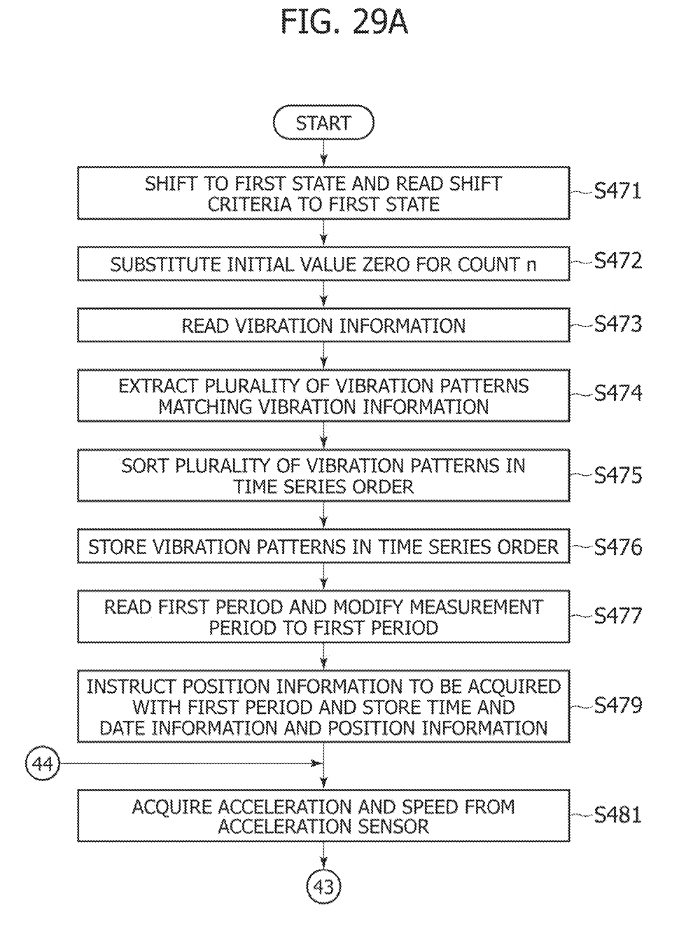

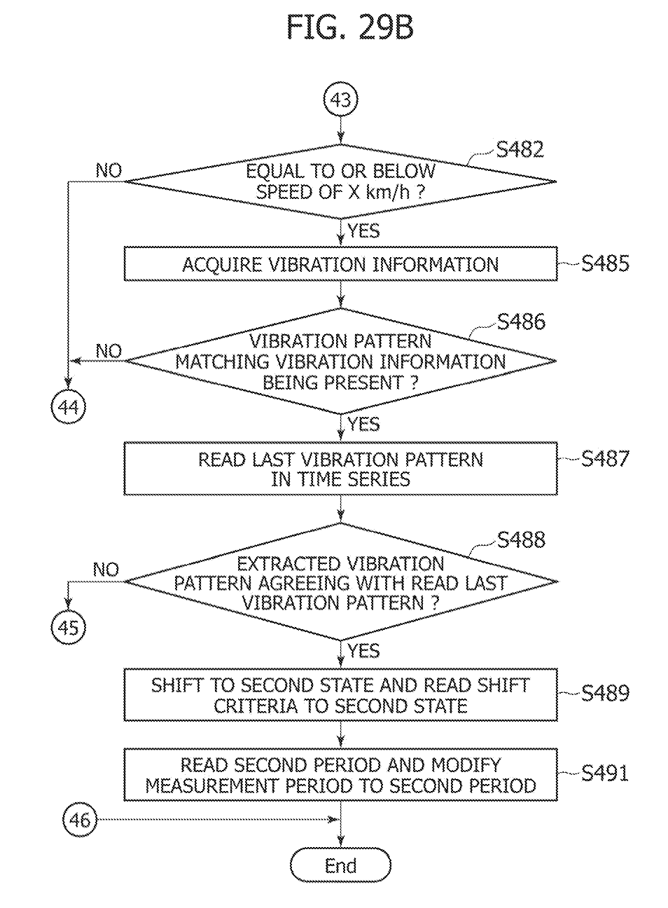

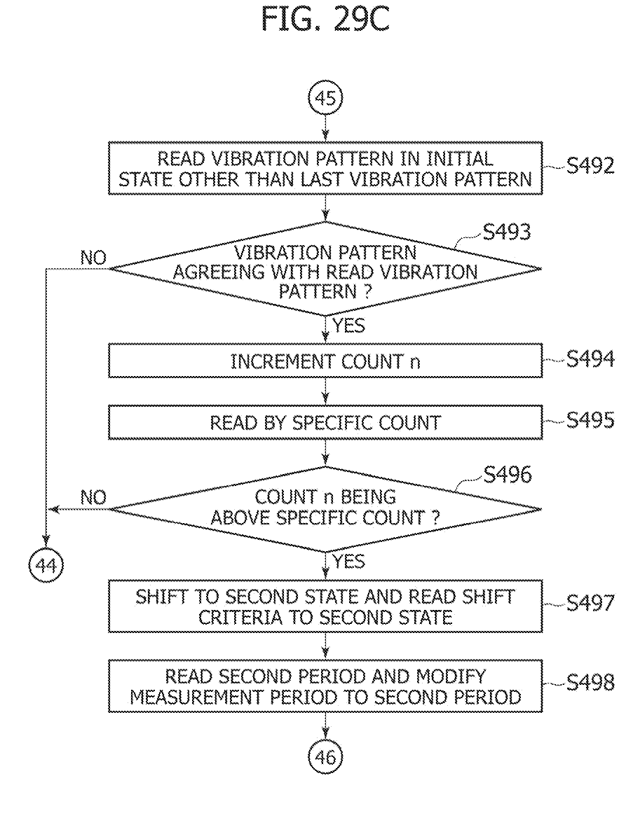

FIGS. 29A-29C are a flowchart illustrating sixth example of a shift process. Operations S421-S435 remain unchanged from those in the sixth embodiment, and the detailed discussion thereof is omitted herein. The process subsequent to the shifting to the first state is described in detail below. The control apparatus 2 determines that the state of the control apparatus 2 has shifted from the initial state to the first state and then reads from the state table 251 the shift criteria to determine whether the state of the control apparatus 2 has shifted from the first state to the second state (S471). The control apparatus 2 substitutes an initial value zero for the count n as an integer variable (S472). The control apparatus 2 reads the vibration information in the initial state stored in S424 (S473). The control apparatus 2 extracts a plurality of vibration patterns matching the vibration information in accordance with the vibration information and the vibration patterns in the pattern file 253 (S474). If only one vibration pattern is extracted, processing returns to S385. The control apparatus 2 references the time and date stored together with the vibration information and sorts the plurality of extracted vibration patterns in the time series order (S475). The control apparatus 2 stores the vibration patterns in the time series order (S476). In one embodiment, operations S473-S476 may be carried out prior to the shifting to the first state in operation S471.

The control apparatus 2 references the period table 252 to read the first period to the first state, and modifies the measurement period of position fixing of the GPS receiver 212 to the first period (S477). The control apparatus 2 instructs the position information to be acquired with the first period and stores the time and date information and the position information in the history file 254 (S479). The control apparatus 2 acquires the speed resulting from the acceleration output from the acceleration sensor 210 (S481). The control apparatus 2 determines whether the acquired speed is equal to or below speed of X km/h (S482).

If the control apparatus 2 determines that the acquired speed is equal to or below speed of X km/h (yes from S482), the control apparatus 2 acquires the vibration information from the acceleration sensor 210 (S485). If the control apparatus 2 determines that the acquired speed is above speed of X km/h (no from S482), processing returns to S481.

The control apparatus 2 compares the acquired vibration information with the vibration patterns stored in the pattern file 253 to determine whether a matched vibration pattern is present (S486). If the control apparatus 2 determines that no matched vibration pattern is present (no from S486), processing returns to S481. If the control apparatus 2 determines that a matched vibration pattern is present (yes from S486), the control apparatus 2 reads last vibration pattern in time series from among the vibration patterns stored in S476 (S487). The control apparatus 2 determines whether the last vibration pattern read agrees with the vibration pattern matched in S486 (S488). Upon determining that the two patterns agree with each other (yes from S488), the control apparatus 2 determines that the unloading operation of the same transport type as that at the end of the loading operation has started, and then proceeds to S489. The control apparatus 2 then determines that the state of the control apparatus 2 has shifted from the first state to the second state and reads from the state table 251 the shift criteria to the second state as a pre-shift state (S489). The control apparatus 2 reads the second period to the second state from the period table 252 and modifies the measurement period of position fixing of the GPS receiver 212 to the second period (S491).

Upon determining that the two patterns fail to agree with each other (no from S488), processing proceeds to S492. The control apparatus 2 reads a vibration pattern in the initial state other than last vibration pattern, from among the plurality of vibration patterns stored in S476 (S492). The control apparatus 2 determines whether the read vibration pattern agrees with the vibration pattern matched in S486 (S493). If the control apparatus 2 determines that the two vibration patterns fail to agree with each other (no from S493), processing returns to S481 to repeat operation S481 and subsequent operations.

If the control apparatus 2 determines that the two vibration patterns agree with each other (yes from S493), the control apparatus 2 increments the count n (S494). The control apparatus 2 reads a specific count serving as a threshold value pre-stored on the storage 25 (S494). The control apparatus 2 determines whether the count n exceeds a specific count (S496). If the control apparatus 2 determines that the count n does not exceed the specific count (no from S496), processing returns to S481 to repeat operation S481 and subsequent operations. In this way, the count n increases. For example, if the machine tool 3 is loaded by human, a crane, and the dolly 4 in that order, the control apparatus 2 detects the vibration pattern of the crane in the first state. If the detection count of the crane exceeds the specific count, the control apparatus 2 determines that the state of the control apparatus 2 has shifted from the first state to the second state.

If the control apparatus 2 determines that the count n exceeds the specific count (yes from S496), processing proceeds to S497. The control apparatus 2 determines that the state of the control apparatus 2 has shifted from the first state to the second state, and then reads from the state table 251 the shift criteria to the second state as a pre-shift state (S497). The control apparatus 2 reads from the period table 252 the second period to the second state and modifies the measurement period of position fixing of the GPS receiver 212 to the second period (S498). Subsequent to one of S491 and S498, the control apparatus 2 acquires the position information with the second period. The subsequent process remains unchanged from operation S456 and subsequent operations, and the discussion thereof is omitted here. In response a vibration pattern different from last vibration pattern, the control apparatus 2 determines, based on the specific number of patterning matching operations, that the state of the control apparatus 2 has shifted from the first state to the second state. Possible errors are thus reduced. The seventh embodiment is thus applicable to a variety of transport types.

The seventh embodiment has been discussed. The rest of the seventh embodiment remains unchanged from the first through sixth embodiments. Like elements are designated with like reference numerals, and the detailed discussion thereof is omitted here.

### Eighth Embodiment

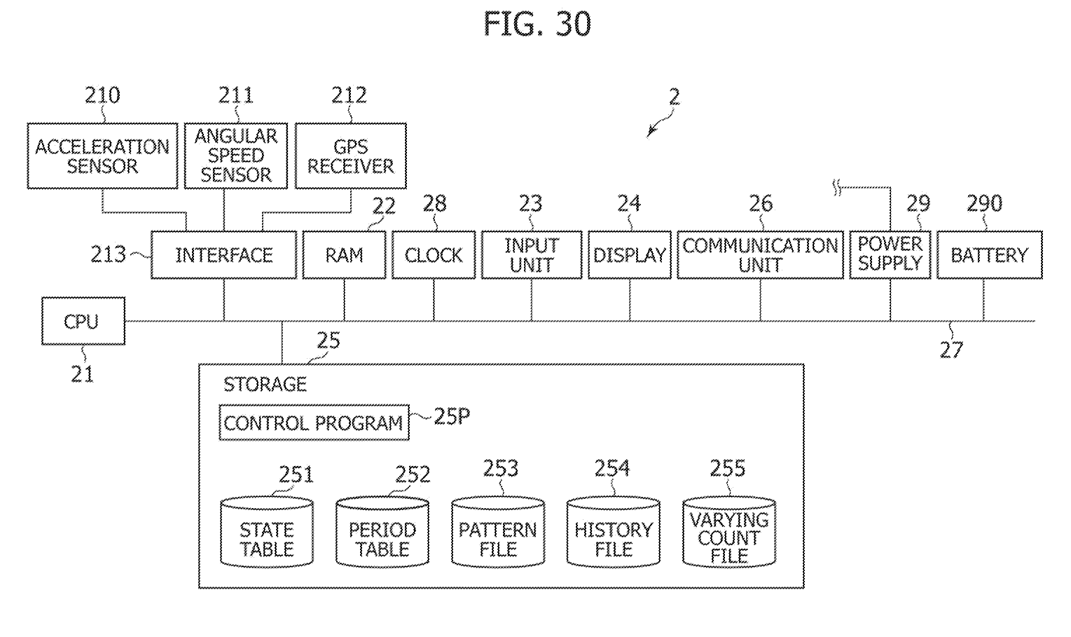

An eighth embodiment relates to a technique in which the count is varied in response to the order of the transport types in the initial state. If the machine tool 3 is loaded using human, crane, and the dolly 4 in that order, it is likely that the unloading operation is carried out in the reverse order, i.e., by using the dolly 4, the crane, and the human in that order. In the first state, the crane as a second transport type from the last order has a count 2 and the manual transport by humans as a third transport type from the last has a count 3 in the seventh embodiment. In other words, the count as the criteria increases reverse to the order of the vibration patterns recognized in the first state. FIG. 30 illustrates a second hardware example of the control apparatus 2 of the eighth embodiment. A varying count file 255 is stored on the storage 25.

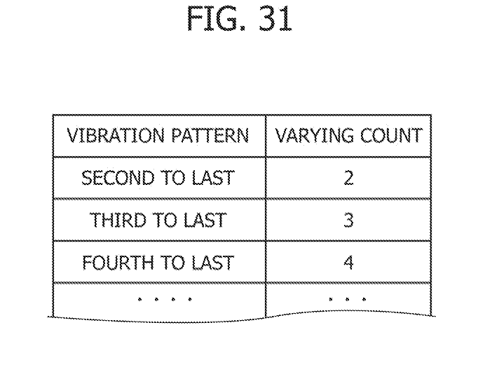

FIG. 31 illustrates an example of the record layout of the varying count file 255. The varying count file 255 includes a vibration pattern field and a varying count field. The vibration pattern field lists information related to the order of the vibration patterns matching the initial state. For example, second last information and third last information in time series are stored. The varying count field lists a varying count with information related to the order mapped thereto. For example, a varying count “2” is stored with “second last” mapped thereto, and a varying count “3” is stored with “third last” mapped thereto.

The varying count stored increases as the order to last in time series increases. The user may input an appropriate count as the varying count using the input unit 23. If any count is input with an order mapped thereto, the control apparatus 2 sets a later order in time series to have a smaller varying count, and then store the count and the order in the varying count file 255. For example, if a count 5 is input with third last information mapped thereto, a count 2 may be input with second last information mapped thereto, and a count 7 may be input with fourth last information mapped thereto. The count may be converted into time and then the time may be input. If the count corresponding to the order to last information in time series is input, the control apparatus 2 may calculate (set) a count for another order. For example, the control apparatus 2 may add to an input count a value that increases with time traced back. The control apparatus 2 may multiply the input count by the value that that increases with time traced back. The control apparatus 2 may subtract from the input count a value that increases with time advancing. The control apparatus 2 may multiply the input count by a value that that decreases with time advancing.

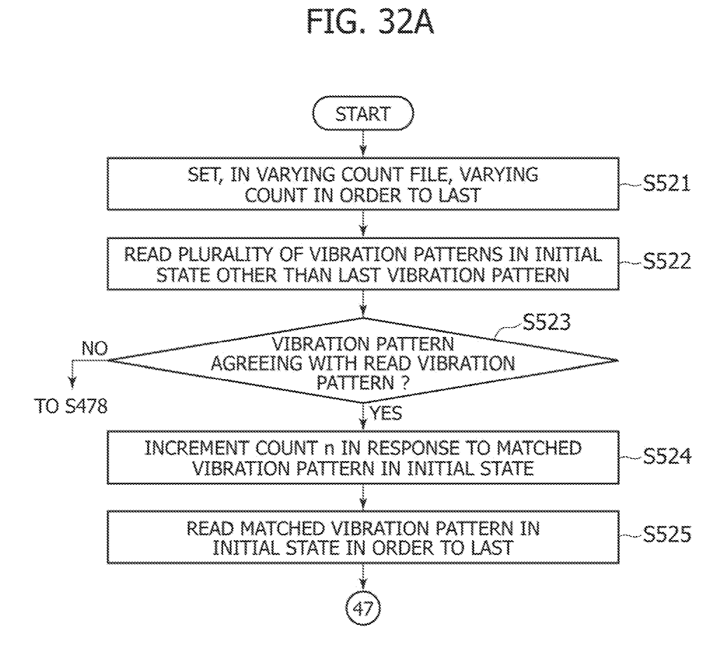

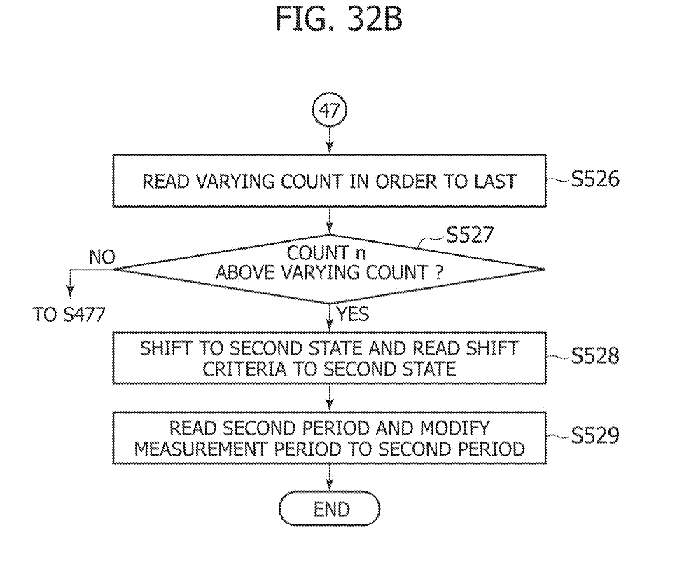

FIGS. 32A and 32B are a flowchart illustrating seventh example of a shift process. The control apparatus 2 receives a varying count responsive to the order to the last. The control apparatus 2 sets (stores) the varying count responsive to the order to the last in the varying count file 255 (S521). Subsequent to no branch from S488, the following process is then performed. The control apparatus 2 reads a plurality of vibration patterns in the initial state other than last vibration pattern from among the plurality of vibration patterns stored in S476 (S522). The control apparatus 2 determines whether the read vibration pattern agrees with the vibration pattern matched in S486 (S523). If the control apparatus 2 determines that the vibration patterns fail to agree with each other (no from S523), the control apparatus 2 returns to S478 to repeat operation S478 and subsequent operations.

If the control apparatus 2 determines that the vibration patterns agree with each other (yes from S523), the control apparatus 2 increments the count n in response to the vibration pattern matched in the initial state (S524). The count n other than last vibration pattern in the initial state increases, for example, a count 2 for the crane, and a count 3 for manual transport by human, and so on. The control apparatus 2 reads the order of the vibration pattern, agreed in step S523 in the initial state, to the last (S525). In this case, the control apparatus 2 reads the order by referencing the vibration patterns stored in time series on the storage 25 in S476. The control apparatus 2 references the varying count file 255 and reads the varying count corresponding to the read order to the last (S526). If the order is a third to the last, a varying count 3 may be read.

The control apparatus 2 determines whether the count n of the vibration pattern incremented in S524 exceeds the varying count corresponding to the vibration pattern (S527). If the control apparatus 2 determines that the count is the varying count or below (no from S527), the control apparatus 2 returns to S477 to repeat S477 and subsequent operations.

If the control apparatus 2 determines that the count n is above the varying count (yes from S527), processing proceeds to S528. If the vibration pattern of the manual transport exceeds a count 3, or if the vibration pattern of the crane exceeds a count 2, the control apparatus 2 determines that the state of the control apparatus 2 has shifted from the first state to the second state. Upon determining that the state of the control apparatus 2 has shifted into the second state, the control apparatus 2 reads from the state table 251 the shift criteria to the second state (S528). The control apparatus 2 thus reads the second period of the second state and modifies the measurement period of position fixing of the GPS receiver 212 to the second period (S529). The process subsequent to S529 remains unchanged from the process in S499, and the detailed discussion thereof is omitted here. The count is varied in accordance with the order of loading. Upon detecting a likely vibration pattern, the control apparatus 2 may determine that the state of the control apparatus 2 has shifted to the second state.

The eighth embodiment has been discussed. The rest of the eighth embodiment remains unchanged from the first through seventh embodiments. Like elements are designated with like reference numerals, and the detailed discussion thereof is omitted here.

### Ninth Embodiment

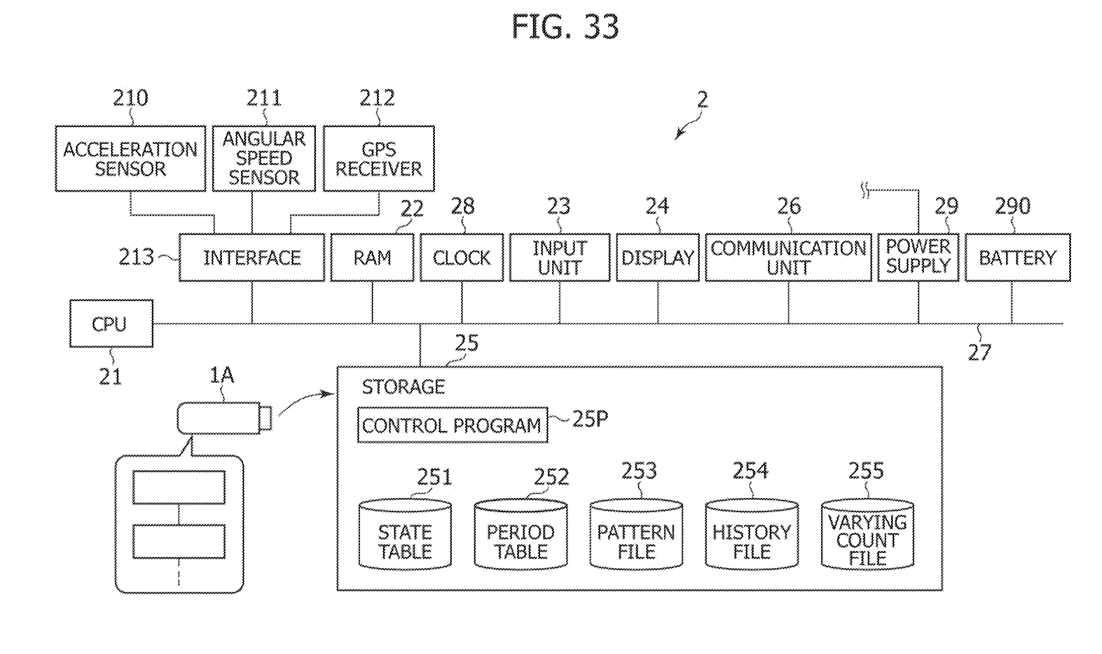

FIG. 33 illustrates a fourth hardware example of the control apparatus 2 of a ninth embodiment. A program for causing the control apparatus 2 of each of the first through eighth embodiments to operate may be read from a removable recording medium 1A, such as a USB memory or a CD-ROM, and then stored on a storage 15 using a reader (not illustrated) in accordance with the ninth embodiment. The program may be downloaded from another server computer (not illustrated) via the communication network N such as the Internet. The method of downloading is described below.

The control apparatus 2 illustrated in FIG. 33 downloads the program executing the above-described software process from the removable recording medium 1A or the other computer (not illustrated) via the communication network N. The program may be installed as the control program 25P and then loaded onto the RAM 12 to be executed. In this way, the control apparatus 2 operates as described above.

The ninth embodiment has been discussed. The rest of the ninth embodiment remains unchanged from the first through eighth embodiments. Like elements are designated with like reference numerals, and the detailed discussion thereof is omitted here.

What is claimed is:

1. A position-fixing control apparatus, comprising:
a position-fixing device that fixes a position of the position-fixing control apparatus;
an acquisition unit that acquires a travel speed and vibration information of the position-fixing control apparatus;
a first modifier that modifies a measurement period of position fixing of the position-fixing device to a first period when the speed exceeds a specific speed;
a second modifier that modifies the measurement period of position fixing of the position-fixing device to a second period shorter than the first period when the speed is equal to or below the specific speed;
a storage unit that stores a vibration pattern; and
a third modifier that modifies the measurement period of position fixing of the position-fixing device to a third period equal to or longer than the first period when the vibration information acquired subsequent to the modification of the measurement period to the second period matches the vibration pattern.

2. The position-fixing control apparatus according to claim 1, wherein the storage unit further stores a second vibration pattern different from the vibration pattern, and
wherein the position-fixing control apparatus further comprises:
a stopper that stops supplying power to the position-fixing device when the vibration information acquired subsequent to the modification of the measurement period to the third period matches the second vibration pattern.

3. The position-fixing control apparatus according to claim 1, further comprising a second storage unit for storing a first vibration pattern and a second vibration pattern different from the first vibration pattern,
wherein the position-fixing control apparatus further comprises:
a third modifier that modifies the measurement period of position fixing of the position-fixing device to a fourth period equal to or shorter than the second period when the vibration information acquired subsequent to the modification of the measurement period to the second period matches the first vibration pattern; and
a fourth modifier that modifies the measurement period of position fixing of the position-fixing device to the third period equal to or longer than the first period when the vibration information acquired subsequent to the modification of the measurement period to the fourth period matches the second vibration pattern.

4. The position-fixing control apparatus according to claim 1, further comprising an acceleration sensor,
wherein the acquisition unit acquires the speed from the acceleration sensor subsequent to the modification to the first period and acquires the speed from the position-fixing device subsequent to the modification to the second period.

5. The position-fixing control apparatus according to claim 1, further comprising:
a storage unit that stores a plurality of vibration patterns; and
an extractor that extracts a vibration pattern matching the vibration information immediately prior to the speed exceeding the specific speed, from among the plurality of vibration patterns,
wherein the modifier modifies the measurement period of position fixing of the position-fixing device to the second period when the speed is equal to or below the specific speed and when the vibration information matches the extracted vibration pattern.

6. A position-fixing control apparatus, comprising:
a position-fixing device that fixes a position of the position-fixing control apparatus;
an acquisition unit for acquiring vibration information of the position-fixing control apparatus;
a storage unit that stores a plurality of vibration patterns;
an extractor that extracts a vibration pattern matching the vibration information acquired within a particular period of time elapsed from a particular event, from among the plurality of vibration patterns; and
a modifier that modifies a measurement period of position fixing of the position-fixing device to a first period when the particular period has elapsed, and modifies the measurement period of position fixing of the position-fixing device to a second period shorter than the first period when the vibration information acquired subsequent to the modification to the first period matches the vibration pattern extracted by the extractor.

7. The position-fixing control apparatus according to claim 6, further comprising a stopper that stops supplying power to the position-fixing device when the vibration information acquired subsequent to the modification to the second period matches one of the vibration patterns.

8. The position-fixing control apparatus according to claim 6, wherein the modifier modifies the measurement period of the position fixing of the position-fixing device to a third period equal to or longer than the first period when the vibration information acquired subsequent to the modification to the second period matches one of the vibration patterns.

9. The position-fixing control apparatus according to claim 6, wherein the extractor extracts a vibration pattern matching the vibration information acquired immediately prior to the modification to the first period from among the plurality of patterns, and
wherein the modifier modifies the measurement period of the position fixing of the position-fixing device to the second period when the vibration information acquired subsequent to the modification to the first period matches the extracted vibration pattern.

10. The position-fixing control apparatus according to claim 9, wherein the modifier modifies the measurement period of the position fixing of the position-fixing device to the second period when the number of times by which the vibration information acquired subsequent to the modification to the first period has matched any of the vibration patterns exceeds a specific count.

11. A computer readable recording medium storing a position-fixing control program causing a computer to perform a process, the process comprising:
acquiring a travel speed of the computer;
modifying a measurement period of position fixing of a position-fixing device position-fixing the position of the computer to a first period when the acquired speed exceeds a specific speed; and
modifying the measurement period of position fixing of the position-fixing device to a second period shorter than the first period when the acquired speed is equal to or below the specific speed.

12. The computer readable recording medium according to claim 11, wherein the process further comprises stopping supplying power to the position-fixing device when the vibration information acquired subsequent to the modification of the measurement period of position fixing of the position-fixing device to the second period matches a specific vibration pattern stored on a storage unit storing the vibration pattern.

13. The computer readable recording medium according to claim 11, wherein the process further comprises modifying the measurement period of position fixing of the position-fixing device to a third period equal to or longer than the first period when the vibration information acquired subsequent to the modification of the measurement period of position fixing of the position-fixing device to the second period matches a specific vibration pattern stored on a storage unit storing at least one vibration pattern.

14. The computer readable recording medium according to claim 13, wherein the process further comprises stopping supplying power to the position-fixing device when the vibration information acquired subsequent to the modification of the measurement period of position fixing of the position-fixing device to the third period matches a second vibration pattern different from the specific vibration pattern stored on the storage unit.

15. The computer readable recording medium according to claim 11, wherein the process further comprises modifying the measurement period of position fixing of the position-fixing device to a fourth period equal to or shorter than the second period when the vibration information acquired subsequent to the modification of the measurement period of position fixing of the position-fixing device to the second period matches a first vibration pattern stored on a storage unit storing the first vibration pattern and a second vibration pattern; and
modifying the measurement period of position fixing of the position-fixing device to a third period equal to or longer than the first period when the vibration information acquired subsequent to the modification of the measurement period of position fixing of the position-fixing device to the fourth period matches the second vibration pattern.

16. The computer readable recording medium according to claim 11, wherein the acquiring comprises acquiring the speed from an acceleration sensor when the speed exceeds the specific speed, and acquiring the speed from the position-fixing device when the speed is equal to or below the specific speed.

17. The computer readable recording medium according to claim 11, wherein the process further comprises:
extracting a vibration pattern matching the vibration information immediately prior to the speed exceeding the specific speed from among a plurality of vibration patterns stored on a storage unit storing the plurality of vibration patterns; and
modifying the measurement period of position fixing of the position-fixing device to the second period when the speed is equal to or blow the specific speed and when the vibration information matches the extracted vibration pattern.

18. The computer readable recording medium according to claim 17, wherein the process further comprises stopping supplying power to the position-fixing device when the vibration information acquired subsequent to the modification of the measurement period to the second period matches one of the vibration patterns.
